(19) United States
(12) Patent Application Publication
(10) Pub. No.: US 2007/0030417 A1
(43) Pub. Date: Feb. 8, 2007

(54) Cellulose ester film, polarizing plate and liquid crystal display

(76) Inventors: Nobuo Kubo, Tokyo (JP); Masataka Takimoto, Tokyo (JP); Shinichiro Suzuki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/411,823

(22) Filed: Apr. 27, 2006

(30) Foreign Application Priority Data
Apr. 28, 2005 (JP) JP2005-131513
May 12, 2005 (JP) JP2005-139590
May 12, 2005 (JP) JP2005-139591

(51) Int. Cl. G02F 1/1335; G02F 1/1343

(52) U.S. Cl. 349/96; 349/141

(57) ABSTRACT

An optical film manufactured by stretching a cellulose ester comprising needle-shaped particles and an additive selected from the group consisting of a polyester, a polyalcohol ester, a polycarboxylic acid ester and a polymer obtained by polymerizing an ethylenically unsaturated monomer, wherein the needle-shaped particles exhibit negative birefringency in a stretching direction of the optical film.

This application is based on Japanese Patent Application Nos. 2005-131513 filed on Apr. 28, 2005, 2005-139590 filed on May 12, 2005 and 2005-139591 filed on May 12, 2005 in Japanese Patent Office, the entire content of which is hereby incorporated by reference.

### FIELD OF THE INVENTION

The present invention relates to an optical film provided with a birefringent property, a polarizing plate and a liquid crystal display which utilize said optical film.

### BACKGROUND OF THE INVENTION

Requirements to displaying quality of a flat panel display have been increasing and various liquid crystal display modes such as IPS, VA and OCB have been proposed, resulting in increasing needs for a retardation film. As a means to provide film with retardation, proposed has been a method, in which a film of polycarbonate or cycloolefin, or a resin film of cellulose acetate is stretched. In the case of utilizing a polycarbonate film of or a cycloolefin film, it is necessary to paste a retardation plate on a polarizing plate, while in the case of utilizing cellulose acetate film, a polarizing plate protective film can play a role of retardation film to enable reduction of part materials, simplification of production processes and cost down. However, it has been difficult for cellulose ester resin film to answer various liquid crystal displaying methods because the resin film exhibits only a limited range of a retardation value.

A method to improve physical properties by addition of particles in a cellulose ester film has been proposed heretofore. For example, in WO 2002/05192, incorporation of 1-99 volume % of metal oxide having a mean particle diameter of 1-400 nm has been proposed to prepare a cellulose acylate film provided with a high surface hardness. Herein, the incorporated particles have been spherical or irregular.

As an example of a resin film in which needle-shaped particles having a birefringent property have been introduced, reported has been a resin film of which birefringent property is controlled such as to reduce retardation by incorporating birefringent particles in the resin (for example, refer to Patent Documents 1 and 2).

Retardation is more easily and effectively obtained when needle-shaped particles are utilized compared to when spherical particles are used, however, a cutting behavior (a slitting behavior) of film becomes poor depending on the state of particles, which may cause a rupture of the film at the time of film preparation. Specifically, in the case of particle diameter of not more than 500 nm, an interaction between resin and the surface of particles increases and the physical properties of the film tends to vary with addition of the particles, resulting in a poor cutting behavior (a slitting behavior). Further, in the case of needle-shaped particles (having a longer diameter of 500-100 nm and a ratio of longer diameter to shorter diameter of not less than 2), a cutting behavior tends to be deteriorated due to influence of such as the particle direction against the cutting direction and orientation of resin itself.

Further, cutting powder tends to be generated at the time of cutting in such as a slitting process when the orientation state of particles is poor. This cutting powder will be a cause of defect when it is not completely removed and stays adhering on the film. Further, since this cutting powder contains particles having a birefringent property which causes retardation, there has been a problem of causing a serious defect such as light leakage (bright spots) when the cutting powder is incorporated in the preparation of a polarizing plate. Further, in optical compensation film in which optical isotropy is controlled by a combination of birefringent particles and resin, it has been found that a variation of retardation becomes large, and the improvement has been desired. Further, development of a method to reduce variation of retardation under an environment of high temperature and high humidity has been required.

Patent Document 1 WO 01/025364 pamphlet

Patent Document 2 JP-A (hereinafter, JP-A refers to Japanese Patent Publication Open to Public Inspection) No. 2004-109355

### SUMMARY OF THE INVENTION

Therefore, an object of the present invention is to provide an optical film of which a birefringent property is controlled and variation in retardation is reduced, and to provide a polarizing plate and a liquid crystal display, which exhibit excellent visibility, an excellent viewing angle property and stability of retardation against an environmental change. Further, another object of the present invention is to overcome a problem of easy rupture of the film at the time of slitting as well as a problem of variation of retardation, and to provide a liquid crystal display exhibiting improved luminance evenness and reduced light leakage.

One of the embodiments of the present invention to achieve the above-described objects is an optical film manufactured by stretching a cellulose ester comprising needle-shaped particles and an additive selected from the group consisting of a polyester, a polyalcohol ester, a polycarboxylic acid ester and a polymer obtained by polymerizing an ethylenically unsaturated monomer, wherein the needle-shaped particles exhibit negative birefringency in a stretching direction of the optical film.

Further, another embodiment of the present invention to achieve the above-described objects is an optical film comprising a cellulose ester film manufactured as a roll film, wherein the optical film comprises needle-shaped particles; a mean particle diameter of the needle-shaped particles is 10-500 nm; a content of the needle-shaped particles is 1-30% by weight; a mean azimuth angle of the needle-shaped particles is perpendicular or parallel to a film forming direction of the roll film; H is not more than 30°, H being a mean value of each absolute value of angles between the direction of the mean azimuth angle and directions of needle-shaped particles; Ds/D is not more than 1.5, wherein D represents an inter-particle distance and Ds represents a standard deviation of the inter-particle distances; and a needle-shape ratio represented by the equation represented below is 2-200.
(needle-shape ratio)=(absolute maximum length)/(diagonal width)

### BRIEF DESCRIPTION OF THE DRAWINGS

FIG. 1 is a drawing to show azimuth angles of needle-shaped particles.

FIG. 2 is a drawing to show an angle of each needle-shaped particle against a mean azimuth angle.

FIG. 3 is a drawing to show distances between weight centers of each needle-shaped particle.

FIG. 4 is a schematic drawing to show a dope preparation process, a casting process and a drying process of a solution casting method according to the present invention.

FIG. 5 is a schematic drawing to show an apparatus to measure an absolute filtering precision.

FIG. 6 (a) and FIG. 6 (b) are drawings to show examples of a die in which plural number of nozzles are arranged along the width direction.

FIG. 7 (a) and FIG. 7 (b) are drawings to show examples of a die in which a liquid supply portion and a liquid ejection portion in the die are arranged along the direction not parallel to the transport direction of a casting support.

FIG. 8 (a) and FIG. 8 (b) are drawings to show examples of a die in which grooves are arranged in the interior of the die along the direction not parallel to the transport direction of a casting support.

FIG. 9 is a drawing to show an example of a method to utilize a diagonally grooved gravure roll.

FIG. 10 (a), FIG. 10 (b), FIG. 10 (c) and FIG. 10 (d) are drawings to show examples of a method utilizing an orientation belt.

FIG. 11 is a drawing to show an example of a die having a long slit length to generate a laminar flow.

FIG. 12 is a drawing to show an example of a method which performs practical stretching during casting by pulling a dope by belt transportation.

FIG. 13 is a schematic drawing to show an example of a tenter process utilized in the present invention.

FIG. 14 is a drawing to illustrate a stretching angle in a stretching process.

FIG. 15 is a schematic drawing to show a constitution of an IPS mode liquid crystal display preferable for the present invention.

FIG. 16 is a schematic drawing to show optical films, polarizers, and the directions of absorption axis/transmission axes of a liquid crystal cell in an IPS mode liquid crystal display preferable for the present invention.

### DESCRIPTION OF THE PREFERRED EMBODIMENTS

The above-described objects of the present invention will be achieved by the following constitutions.

(1) An optical film manufactured by stretching a cellulose ester comprising needle-shaped particles and an additive selected from the group consisting of a polyester, a polyalcohol ester, a polycarboxylic acid ester and a polymer obtained by polymerizing an ethylenically unsaturated monomer,

wherein the needle-shaped particles exhibit negative birefringency in a stretching direction of the optical film.

(2) The optical film of Item (1) having the following optical values:
nx(a)>nz(a)>ny(a)
105 nm≦Ro(a)≦350 nm
0.2<Nz<0.7
wherein, Ro(a) and Nz are defined as follows:
Ro(a)=(nx(a)−ny(a))×d Equation (i)
Nz=(nx(a)−nz(a))/(nx(a)−ny(a)) Equation (ii)

wherein, y represents a stretching direction of the optical film, ny(a) represents a refractive index in the stretching direction, nx(a) represents an in-plane refractive index in a direction perpendicular to y, nz(a) represents a refractive index in a thickness direction of the optical film and d represents a thickness (nm) of the optical film.

(3) The optical film of Item (1) or (2), wherein a mean particle diameter of the needle-shaped particles is 10-500 nm and a needle-shape ratio represented by the following equation is 2-200:
(needle-shape ratio)=(absolute maximum length)/(diagonal width) Equation (1)
wherein, the absolute maximum length is a maximum length of the needle-shaped particle, and the diagonal width is a minimum distance between two straight-lines parallel to a direction of the absolute maximum length, the parallel lines sandwiching an image of the particle when the image of the particle is projected on an image forming material.
(4) The optical film of any one of Items (1) to (3), wherein a surface of the needle-shaped particle is subjected to a hydrophobic treatment.
(5) The optical film of any one of Items (1) to (4), wherein the polymer obtained by polymerizing the ethylenically unsaturated monomer has an ester bond in a monomer unit.
(6) The optical film of any one of Items (1) to (5), wherein

a direction of a mean azimuth angle of the needle-shaped particles is perpendicular or parallel to a casting direction of the optical film;

H is not more than 30°, H being a mean value of absolute values of angles between the direction of the mean azimuth angle and directions of needle-shaped particles;

and

Ds/D is not more than 1.5,

wherein D represents an inter-particle distance and Ds represents a standard deviation of the inter-particle distances.

(7) A polarizing plate having the optical film of any one of Items (1) to (6) on one surface of the polarizing plate.

(8) An in-plane switching mode liquid crystal display having two polarizing plates sandwiching an in-plane switching mode liquid crystal cell, wherein one of the polarizing plates is the polarizing plate of Item (7).

(9) An in-plane switching mode liquid crystal display comprising an in-plane switching mode liquid crystal cell and two polarizing plates sandwiching the liquid crystal cell, wherein one of polarizing plate protective films of the polarizing plates provided adjacent to the liquid crystal cell is the optical film of Item (1).

(10) The in-plane switching mode liquid crystal display of claim 9, wherein a polarizing plate protective film provided adjacent to the liquid crystal cell other than the polarizing plate protective film provided adjacent to the liquid crystal cell of Item (9) meets the following conditions:
−15 nm≦Ro(b)≦15 nm
−15 nm≦Rth(b)≦15 nm

wherein, Ro(b) and Rth(b) are defined as follows:
Ro(b)=(nx(b)−ny(b))×d Equation (iv)
Rth(b)={(nx(b)+ny(b))/2−nz(b)}×d Equation (v)

wherein, nx(b) represents an in-plane refractive index in a slow axis direction of optical film B, ny(b) represents an in-plane refractive index in a direction perpendicular to the slow axis direction, nz(b) represents a refractive index in a thickness direction of the film, and d (nm) represents a thickness of the film.

(11) An optical film comprising a cellulose ester film manufactured as a roll film,

wherein

the optical film comprises needle-shaped particles;

a mean particle diameter of the needle-shaped particles is 10-500 nm;

a content of the needle-shaped particles is 1-30% by weight;

a mean azimuth angle of the needle-shaped particles is perpendicular or parallel to a film forming direction of the roll film;

H is not more than 30°, H being a mean value of absolute values of angles between the direction of the mean azimuth angle and directions of needle-shaped particles;

Ds/D is not more than 1.5, wherein D represents an inter-particle distance and Ds represents a standard deviation of the inter-particle distances; and

a needle-shape ratio represented by the following equation is 2-200:
(needle-shape ratio)−(absolute maximum length)/(diagonal width) Equation (1)

wherein, the absolute maximum length is a maximum length of the needle-shaped particle, and the diagonal width is a minimum distance between two straight lines parallel to a direction of the absolute maximum length, the parallel lines sandwiching an image of the particle when the image of the particle is projected on an image forming material.

(12) The optical film of Item (11), wherein

a retardation value Ro represented by the following Equation (i) meets 105 nm≦Ro(a)≦350 nm; and

Nz represented by the following Equation (ii) is 0.2-0.7:
Ro(a)=(nx(a)−ny(a))×d Equation (i)
Nz=(nx(a)−nz(a))/(nx(a)−ny(a)) Equation (ii)

wherein, nx(a) represents an in-plane refractive index in a slow axis direction, ny(a) represents an in-plane refractive index in a direction perpendicular to the slow axis direction, nz (a) represents a refractive index in a film thickness direction, and d is a thickness (nm) of the optical film.

(13) A polarizing plate having the optical film of Item (11) or (12) on one surface of the polarizing plate.

(14) A liquid crystal display having the polarizing plate of Item (13) on one surface of a liquid crystal cell.

(15) A polarizing plate having a cellulose ester film of Item (11) or (12) as a polarizing pate protective film, wherein the cellulose ester film is arranged so that a slow axis of the cellulose ester film is practically parallel to or perpendicular to an absorption axis of a polarizer.

(16) An in-plane switching mode liquid crystal display having two polarizing plates sandwiching an in-plane switching mode liquid crystal cell, wherein one of the polarizing plates is the polarizing plate of Item (15).

(17) An in-plane switching mode liquid crystal display having two polarizing plates sandwiching an in-plane switching mode liquid crystal cell, wherein one of the polarizing plates is the polarizing plate of Item (15) and a polarizing plate protective film of another polarizing plate provided, the polarizing plate protective film being provided adjacent to the liquid crystal cell and being defined as an optical film B, meets the following conditions:
−15 nm≦Ro(b)≦15 nm
−15 nm≦Rth(b)≦15 nm

wherein, Ro(b) and Rth(b) are defined by Equations (iv) and (v), respectively:
Ro(b)=(nx(b)−ny(b))×d Equation (iv)
Rth(b)={(nx(b)+ny(b))/2−nz(b)}×d Equation (v)

wherein, nx(b) represents an in-plane refractive index in a slow axis direction of the optical film B, ny(b) represents an in-plane refractive index in a direction perpendicular to the slow axis direction, nz(b) represents a refractive index in a thickness direction of the film, and d (nm) represents a thickness of the film.

(18) The in-plane switching mode type liquid crystal display of Item (17), wherein optical film-B is a cellulose ester film.

The present invention can provide optical film, in which a birefringent property has been controlled and haze and a variation of retardation are decreased, a polarizing plate and a liquid crystal display exhibiting excellent visibility, viewing angle and retardation stability against an environmental change. Further, the present invention can overcome a problem of easy rupture at the time of slitting and provide a liquid crystal display having a decreased variation of retardation as well as reduced luminance unevenness and light leaks.

The most preferable embodiment to practice the present invention will be explained in the following; however, the present invention is not limited thereto.

Optical film of the present invention is cellulose ester film having been cast in a roll form which contains needle-shaped particles having a mean particle diameter (a longer diameter) of 10-500 nm and a needle-shape ratio defined by Equation (1) (also referred to as an aspect ratio) of 2-100, wherein a content of the aforesaid needle-shaped particles is 1-30 weight %, a direction of a mean azimuth angle of the aforesaid particles in the film is perpendicular or parallel to the film forming direction (or the casting direction) of the aforesaid cellulose ester film, mean value H of each absolute value of angles between the direction of the aforesaid mean azimuth angle and needle-shaped particles is not more than 30°, and Ds/D, which is determined from a mean inter-particle distance D and a standard deviation of the inter-particle distances of the aforesaid needle-shaped particles in the film, is not more than 1.5. Herein, the absolute maximum length refers to the maximum diameter of needle-shaped particles observed by an electronmicroscope photograph and is also referred to as a longer diameter. Further, a diagonal width refers to a distance between two straight lines which are parallel to the longer diameter and sandwich a projected particle image, and is also referred to as a shorter diameter.
(needle-shape ratio)=(absolute maximum length)/(diagonal width) Equation (1)

In above equation (1), the diagonal width represents a minimum distance between two straight lines which are parallel to the absolute maximum length and sandwich a projected particle image, and the absolute maximum length represents the maximum length of a needle-shaped particle.

As a means to orient needle-shaped particles, for example, considered is a method to stretch at a high ratio of not less than 2 times, however, it has been newly found that, to restrain haze increase, cellulose ester film preferably containing at least an additive selected from the group consisting of a polyester, a polyalcohol ester, a polycarboxylic acid ester and a polymer obtained by polymerizing an ethylenically unsaturated monomer can make orientation of birefringent particles easy, resulting in reduced haze and decreased variation of retardation. Further, a liquid crystal display utilizing a polarizing plate comprised of said film can provide an in-plane switching mode liquid crystal display which exhibits high contrast at every corner even in a large image screen, excellent visibility without mottled patches as well as superior viewing angle. Specifically, display having a high contrast at every corner in a large image screen can be performed as well as deterioration of flatness of cellulose ester film, which has been stretched at a high stretching ratio such as not less than 2 times, due to an environmental variation and to heat of a backlight can be suppressed, resulting in achieving stable retardation. Specifically, in an in-plane switching mode liquid crystal display utilizing a direct backlight, a liquid crystal display, which has been improved with respect to light leaks, can be provided.

<Needle-Shaped Particles>

First, needle-shaped particles according to the present invention will be explained.

Cellulose ester film of the present invention is characterized by containing needle-shaped particles, having a mean particle diameter of 10-500 nm and a needle-shape ratio, which is defined by above Equation (1), of 2-100, and preferably contains said particles at a range of 1-30 weight %. The content of needle-shaped particles will be adjusted depending on the aimed retardation; however, a sufficient effect can not be achieved at a content of less than 1 weight %, while it is not preferable that film becomes brittle at a content of over 30 weight %.

Needle-shaped particles according to the present invention are not specifically limited provided that the particles are needle-shaped, however, preferable are needle-shaped particles having a birefringent property.

As birefringent particles, birefringent particles described in WO 01/0253643 or JP-A 2004-109355 can be utilized. Examples of birefringent particles include: carbonates such as calcium carbonate, strontium carbonate, magnesium carbonate, manganese carbonate, cobalt carbonate, zinc carbonate and barium carbonate; oxides exemplified by titanium oxide; and birefringent whiskers such as MgSO₄.5Mg(OH)₂.3H₂O, 6CaO.6SiO₂.H₂O and 9Al₂O₃.2B₂O₃.

For example, uniaxial birefringent crystals of a tetragonal system, hexagonal system and a rhombohedral system; and crystals of a monoclinic system and a triclinic system are preferably utilized. Further, these may be either a single crystal or may be a polycrystal.

Further, such as rod-shaped or short fiber particles of polystyrene or acrylic resin are also utilized. For example, also preferable are particles containing polystyrene resin or acrylic resin and made of short fibers manufactured by minutely cutting very thin fibers. These fibers are preferably stretched in the manufacturing process for easy exhibition of a birefringent property. Resin contained in these particles is preferably cross-linked.

However, needle-shaped particles utilized in the present invention are not limited thereto, and various types can be utilized provided satisfying the aforesaid size, form and needle-shape ratio.

These birefringent particles are preferably have a mean longer diameter (the absolute maximum length) of 10-500 nm and a needle-shape ratio, which is defined by aforesaid Equation (1), of not less than 2, and specifically the needle-shape ratio is more preferably 2-100 and furthermore preferably 3-30. A needle-shape ratio can be determined according to aforesaid Equation (1) from an absolute maximum length and a diagonal width of a particle. This can be determined from image data obtained by electron microscope observation of particles or particles contained in the film.

A birefringent property of birefringent particles is defined as follows. A refractive index of birefringent particles measured with light polarized in the longer diameter direction is expressed as npr, and a refractive index measured with light polarized in the direction perpendicular to the longer diameter direction is expressed as nvt. Birefringence Δn of birefringent particles is defined based on following Equation (2).
Δn=npr−nvt Equation (2)

That is, a birefringence is positive when a refractive index in the longer diameter direction of birefringent particles is larger than a refractive index in the direction perpendicular to the longer diameter direction, while a birefringence is negative in the opposite case.

The absolute value of a birefringence characteristic to birefringent particles utilized in the present invention is not specifically limited, however, it is preferably 0.01-0.3 and more preferably 0.05-0.3.

Examples of a birefringent crystal provided with a positive birefringence include MgSO₄.5Mg(OH)₂.3H₂O, 6CaO.6SiO₂.H₂O, 9Al₂O₃.2B₂O₃ and TiO₂ (a rutile type crystal). Examples of a birefringent crystal provided with a negative birefringence include such as calcium carbonate and strontium carbonate. In the case of a needle-like crystal, negative birefringence means that a refractive index in the longer direction of a crystal is smaller than a refractive index in the direction perpendicular to the longer direction.

<Carbonate Particles>

Carbonate particles can be manufactured by a homogeneous precipitation method or a carbonic acid gas combination method. For example, they can be manufactured by a method described in such as JP-A 3-88714, Examined Japanese Patent Application Publication No. 55-51852 and JP-A 59-223225.

A strontium carbonate crystal can be prepared by bringing strontium ions and carbonate ions, which are dissolved in water, in contact with each other. Carbonate ions may be added by bubbling carbonic acid gas into a solution containing a strontium compound, or a substance which can generate carbonic acid gas may be added to be reacted or decomposed, whereby strontium carbonate can be prepared. For example, strontium carbonate crystal particles can be manufactured according to a method described in JP-A 2004-35347, and strontium carbonate particles prepared by this method can be preferably utilized as birefringent particles. A substance which generates carbonic acid gas includes urea, and strontium carbonate particles can be prepared by reacting carbonic acid gas ions, which are generated by incorporation of a hydrolysis catalyst of urea, with strontium ions. To prepare minute crystals, reaction temperature is preferably set to as low as possible. To cool down to lower than the freezing point is preferable to prepare minute crystal particles. For example, addition of an organic substance such as ethylene glycols as a freezing point depression substance is also preferable, and the addition is preferably performed so as to make the freezing point of lower than −5° C. Thereby, strontium carbonate particles having a mean particle diameter in the longer diameter direction of not more than 500 nm can be prepared.

Strontium carbonate is a biaxial birefringent crystal, each refractive index in the optical axis direction being n (na, nb, nc)=(1.520, 1.666, 1.669), and it has been reported that the long axis direction of a needle-like crystal roughly coincides with the optical axis having a refractive index of 1.520. Therefore, it has a negative birefringent effect in the orientation direction of a needle-like crystal. These strontium carbonate crystal particles, due to a form of needle-like (a bar-form), can be statistically oriented in a predetermined direction by reacting a stress in a state of being dispersed in a viscous medium.

[Hydrophobic Treatment of Surface of Needle-shaped Particles]

The surface of needle-shaped particles of the present invention is preferably subjected to a hydrophobic treatment.

A surface hydrophobic treatment method applicable to the present invention is not specifically limited, and for example, a surface treatment by such as a silane coupling agent, a titanate coupling agent and stearic acid are preferable.

In the following, a hydrophobic treatment of the surface of needle-shaped particles according to the present invention will be detailed.

A hydrophobic treatment of the surface of needle-shaped particles according to the present invention can be performed by a conventional method well known in the art such as a dry processing, in which a solution comprising a hydrophobic processing agent dissolved in such as alcohol is sprayed or a vaporized hydrophobicity increasing agent is contacted to be adhered on needle-shaped particles having been dispersed by such as stirring, or a wet processing, in which particles are dispersed in a solution and a hydrophobicity increasing agent is titrated into said solution to be adhered on the particles.

As a hydrophobic processing agent, compounds well known in the art can be utilized and specific examples will be listed below. Further, these compounds may be utilized in combination.

A titanate coupling agent includes such as tetrabutyltitanate, tetraoctyltitanate, isopropyltriisostearoyltitanate, isopropyltridecyl benzenesulfonyltitanate and bis(dioctylpyrophosphate)oxyactatetitanate.

A silane coupling agent includes such as γ-(2-aminoethyl)aminopropyltrimethoxysilane, γ-(2-aminoethyl)aminopropylmethyldimethoxysilane, γ-methacryloxypropyltrimethoxysilane, N-β-vinylbenzylaminoethyl-N-γ-aminopropyltrimethoxysilane hydrochloride, hexamethydisilazane, methylmethoxysilane, butyltrimethoxysilane, isobutyltrimethoxysilane, hexyltrimethoxysilane, octyltrimethoxysilane, decyltrimethoxysilane, dodecyltrimethoxysilnae, phenyltrimethoxysilane, o-methylphenyltrimethoxysilane and p-methylphenyltrimethoxysilne.

Silicone oil includes such as dimethylsilicone oil, methylphenylsilicone oil and amino modified silicone oil.

These hydrophobicity increasing agents are preferably added at 1-40 weight % based on the weight of needle-shaped particles to cover said particles, and more preferably at 3-30 weight %.

Further, in the present invention, the following compounds can be utilized as a hydrophobicity increasing agent.

Compounds utilizable in the present invention include such as fatty acid, alicyclic carboxylic acid, aromatic carboxylic acid and resin acid. For example, listed are saturated fatty acid such as caproic acid, caprylic acid, capric acid, lauric acid, myristic acid, palmitic acid, stearic acid and behenic acid; unsaturated fatty acid such as sorbic caid, elaidic acid, oleic acid, linolic caid, linolenic acid and erucic acid; alicyclic carboxylic acid such as naphthenic acid provided with a cyclopentane ring and a cyclohexane ring; aromatic carboxylic acid such as carboxylic acid of naphthalene such as naphthoic acid and naphthalic acid; resin acid such as abietic acid, pimaric acid, levopimaric acid, neoabietic acid, parastoric acid, dehydroabietic acid, isopimaric acid, sandarachopimaric acid, comuric acid, secodehydroabietic acid and dihydroabietic acid; and among them, preferably utilized are palmitic acid and stearic acid with respect to providing a surface treatment of needle-shaped particles according to the present invention with a dispersibility effect.

Further, metal salt or amine salt of fatty acid, alicyclic carboxylic acid, aromatic carboxylic acid and resin acid includes such as saturated fatty acid salt of such as potassium laurate, potassium myristate, potassium palmitate, barium stearate, calcium, aluminum, zinc and magnesium; unsaturated fatty acid salt of such as potassium oleate, sodium, potassium oleate, sodium, potassium, diethenolamine salt; and alicyclic carboxylic acid such as zinc naphthenate, zinc cycolhexylbutyrate, aromatic carboxylic acid salt such as sodium benzoate and sodium salicylate.

Further, at the time of or before a surface treatment of needle-shaped particles according to the present invention, a compound provided with lithium, sodium, potassium, rubidium, beryllium, magnesium, calcium, strontium, barium, zinc, aluminum, lead, cobalt or an amino group may be mixed and reacted with aforesaid fatty acid, alicyclic carboxylic acid, aromatic carboxylic acid and resin acid to prepare metal salt or amine salt of fatty acid, alicyclic acid, aromatic carboxylic acid and resin acid.

Among metal salt of fatty acid, alicyclic acid, aromatic acid and resin acid described above, in a surface treatment of needle-shaped particles according to the present invention, preferably utilized is calcium stearate.

Ester of fatty acid, alicyclic acid, aromatic acid and resin acid includes saturated fatty acid ester such as ethyl caproate, vinyl caproate, diisopropyl adipate, allyl caprylate, ethyl caprylate, vinyl caprylate, diethyl sebacate, diisopropyl sebacate, cetyl isooctanate, octyldodecyl dimethyloctanate, methyl laurate, butyl laurate acid, lauryl laurate, methyl myristate, isopropyl myristate, cetyl myristate, myristyl myristate, isocetyl myristate, octyldodecyl myristate, isotridecyl myristate, methyl palmitate, isopropyl palmitate, octyl palmitate, cetyl palmitate, isostearyl palmitate, methyl stearate, butyl stearate, octyl stearate, stearyl stearate, cholesteryl stearate, isocetyl isosterate, methyl behanate and behenyl behenate; unsaturated fatty acid ester such as methyl oleate, ethyl linolate, isopropyl linolate and methyl erucate; long chain fatty acid higher alcohol ester, neopentyl polyol (including a long chain and a middle chain), fatty acid type ester and a partial ester compound, dipentaerythritol long chain fatty acid ester, complex middle chain fatty acid ester, 12-isocetyl stearoylstearate, 12-isostearyl stearoylstearate, 12-stearyl stearoylstearate, beef tallow fatty acid octylester, heat resistant special fatty acid ester such as polyhydric alcohol fatty acid ester/fatty acid ester of alkylglyceryl ester, and among them, in a surface treatment of needle-shaped particles according to the present invention, preferably utilized is polyhydric alcohol acid ester of polyhydric alcohol stearate or palmitate.

Sulfonate of aliphatic, alicyclic and aromatic groups includes sulfonate such as sulfosuccinate, dioctylsulfosuccinate and tetradecenesulfonate; alkyl sulfate comprising an alkyl group such as lauryl, myristyl, palmityl, stearyl, oleyl and cetyl; polyoxyethylene(2)laurylether sulfate, polyoxyethylene(3)laurylether sulfate, polyoxyethylene(4)laurylether sulfate, polyoxyethylene(3)alkylether sulfate, polyoxyethylene(4)nonylphenylether nitrate, aromatic sulfonate such as straight chain (C10, C12, C14)alkylbenzene sulfonate, branched chain alkylbenzene sulfonate, naphthalene sulfonate and dodecylbenzene sulfonate; and among them, in a surface treatment of needle-shaped particles according to the present invention, preferably utilized is dodecylbenzene sulfonate.

As examples of metal salt and amine salt of sulfonic acid of aliphatic, alicyclic and aromatic groups, sodium salt and amine salt of the above described sulfonic acid of aliphatic, alicyclic and aromatic groups are general, however, at the time of or before the surface treatment of calcium carbonate of the present invention, a compound provided with lithium, sodium, potassium, rubidium, beryllium, magnesium, calcium, strontium, barium, zinc, aluminum, lead, cobalt or an amino group may be mixed and reacted with sulfonic acid of aliphatic, alicyclic and aromatic groups to appropriately prepare metal salt and amine salt of sulfonic acid of aliphatic, alicyclic and aromatic groups. Among them, in a surface treatment of needle-shaped particles according to the present invention, preferably utilized is dodecylbenzenesulfonate soda.

In the present invention, a blending amount of the above-described compound is preferably 0.1-10 weight parts and specifically preferably 0.5-5 weight parts, in 100 weight parts of needle-shaped particles.

To perform a surface treatment of needle-shaped particles, utilized can be an ordinary processing method such as a dry method employing such as a Henschel mixer, and a wet solvent method in which a solvent is removed after the treatment in the solvent. A solvent utilized in a solvent method is not specifically limited, however, includes aromatic compounds such as toluene and xylene; aliphatic compounds such as hexane and heptane; alcohols such as ethanol, isopropanol and butanol; ethers such as ethylcellosolve and butylcellosolve; esters such as ethyl acetate and butyl acetate; ketones such as acetone and methyl ethyl ketone; and methylene chloride; and these may be utilized alone or as a suitable combination.

### SYNTHESIS EXAMPLE OF NEEDLE-SHAPED PARTICLES

In the following, a specific manufacturing method of strontium carbonate crystals, as an example of needle-shaped particles according to the present invention, will be described.

### Synthesis Example 1

Water of 375 g was added with urea of 81.75 g (21.8 weight % based on water) and strontium nitrate of 30.75 g (8.2 weight % based on water). Further, to perform the reaction at lower than the freezing point, ethylene glycol of 75.00 g (20 weight % based on water) as an organic solvent was added into the reaction solution. The resulting solution was charged in a reaction vessel and cooled with stirring while ultrasonic waves were irradiated.

Three One Motor, produced by Shinto Kagaku Co., Ltd., as a stirring motor, Ultrasonic Washing Machine W-113MK-II, produced by Honda Electronics Co., Ltd., as a water bath equipped with an ultrasonic irradiation function and a sealable tank type handy cooler TRL-C13, produced by Thomas Scientific Instrument Co., Ltd., as a cooler were employed.

The reaction temperature was cooled down to −5° C. and kept at −5° C. by circulating ethylene glycol type non-freezing liquid (Naybrine, manufactured by Thomas Scientific Instrument Co., Ltd.) in a water bath utilizing a cooler. Successively, 1.50 g of digestive enzyme Ureasel was added into the reaction solution. Precipitation of crystals was initiated in the reaction solution after addition of the digestive enzyme, and the solution turned to milky-white. The reaction was continued for 12 hours while keeping the temperature at −5° C.

Thereafter, the temperature of the reaction solution was raised to 20° C., and crystals were ripened for 12 hours while keeping the temperature at 20° C. The obtained crystals were taken out by filtration and dried. Strontium carbonate needle-like crystal particles having a length of not more than 500 nm (approximately 400 nm), which was observed by photographs of a transmission electron microscope, were obtained.

### Synthesis Example 2

Suspension, in which 300 g of water were added with 60 g (20 weight % based on water) of methanol and 80 g (26.7 weight % based on water) of strontium hydroxide octahydrate, was prepared. This suspension was charged in a reaction vessel and stirred with a stirring motor (Three-One Motor BLh600 produced by Shinto Science Co., Ltd.) to accelerate crystal nucleation by application of energy to the reaction system while preventing aggregation of formed particles as much as possible. Further, the suspension was irradiated by ultrasonic waves by use of a water bath equipped with an ultrasonic irradiation function (Ultrasonic Washing Machine W-113MK-II, produced by Honda Electronics Co., Ltd.). The temperature was kept at −10° C. by circulating ethylene glycol type non-freezing liquid (Naybrine, manufactured by Thomas Scientific Instrument Co., Ltd.) in a water bath by use of a cooler (sealable tank type handy cooler TRL-C13 produced by Thomas Scientific Instrument Co., Ltd.).

A CO₂ gas and a N₂ gas were mixed at a ratio of CO₂/N₂=30/70 based on volume by use of a gas mixier (MiNi-Gascom PMG-1, produced by Koflock Corp.) and were introduced into the suspension at a flow rate of 200 ml/min. The mixed gas introduction was stopped after said gas had been introduced until pH became stable at approximately 7.

A silane coupling solution was prepared separately from this suspension. Water of 40 g was added with acetic acid to make the pH of approximately 5.3 and further added with silane coupling agent (3-glycideoxypropyl trimethoxysilane) and the resulting solution was stirred for 3 hours, whereby a silane coupling solution was prepared.

The amount of a silane coupling agent was 30 weight % based on the weight of strontium carbonate. A surface treatment was performed while stirring with a stirring motor for 24 hours by addition of the prepared silane coupling solution into the suspension. To remove the unreacted portion, the suspension was suction filtered through a filter paper having a pore size of 0.1 μm, the resulting product being charged into 500 ml of acetone to be stirred for 24 hours for washing, and the resulting product prepared by further filteration was dried by use of a vacuum drier. The obtained crystals were proved to be strontium carbonate crystals having a mean length of not more than 200 nm by means of electron microscopic observation.

In the present invention, needle-shaped particles are dispersed together with an organic solvent and resin for dispersing needle-shaped particles, which will be described later. By utilizing needle-shaped particle dispersion thus prepared, prepared can be cellulose ester film having a stable retardation, which can be preferably utilized as optical compensation film.

[Mean Azimuth Angle, Ds/D]

Further, it is preferable that needle-shaped particles contained in the optical film of the present invention have a mean azimuth angle perpendicular to or parallel to the casting direction of the film, average value H of absolute values of angles between said mean azimuth angle and directions of each needle-shaped particle being within 30°, and Ds/D, which is determined from mean inter-particle distance D of said needle-shaped particles in the film and standard deviation Ds of the inter-particle distances of said needle-shaped particles, is not more than 1.5.

Evaluation of an orientation state and a dispersion state of needle-shaped particles in the film can be carried out based on image data obtained by observation of particles in the film through an electronmicroscope.

An azimuth angle and a needle-shape ratio with respect to each of needle-shaped particles are determined from the image data. A needle-shape ratio can be determined by aforesaid Equation (1). An absolute maximum length corresponds to a length of a longer axis (a longer diameter) of a needle-shaped particle.

Particles having a needle-shape ratio of less than 2 such as foreign matters or pulverized particles are omitted from the calculation of a mean azimuth angle and a mean inter-particle distance, which will be determined with respect to each particle having a needle-shape ratio of not less than 2.

An azimuth angle mentioned in the present invention means an angle between the absolute maximum length direction and a reference axis. The reference axis can be arbitrary set and, for example, can be set along the width direction of the film. An azimuth angle of each needle-shaped particle was determined and an average value thereof was defined as a mean azimuth angle.

Next the direction of the determined mean azimuth angle is set as a new standard axis, and an angle difference between an azimuth angle of each particle and a mean azimuth angle was determined with respect to each needle-shaped particle to determine an average of absolute value of these angle differences. This is “mean value H of absolute values of angles between the mean azimuth angle and azimuth angles of each needle-shaped particle”. H is within 30 degrees.

A specific evaluation method will be now explained. Prepared film was photographed by a transmission electronmicroscope at a magnification of 20,000 times and the image was read by use of Scanner CanoScan FB 636U produced by Canon Inc. at 300 dpi and a monochromatic 256 gradation.

The image having been read was taken into an image processing software WinROOF ver. 3.60 (manufactured by Mitani Shoji Co., Ltd.) which had been installed on a personal computer Endeavor Pro720L (CPU; Athlon-1 Ghz, memory; 512 MB) produced by Epson Direct Co., Ltd.

Extraction (automatic formation of binary data of an image) was performed with respect to the taken image in a 2×2 μm field of vision as an image pre-processing, whereby image extraction of particles was carried out. Confirming that not less than 90% of particles in an image plane after image extraction have been extracted, the detection level is manually adjusted when the extraction is not sufficient so that not less than 90% of particles will be detected and extracted.

When the number of needle-shaped particles in a viewing region is less than 1,000 particles, a similar operation was performed further with another 2×2 μm field of vision, and was continued until the number of particles exceeds 1,000 particles as a total.

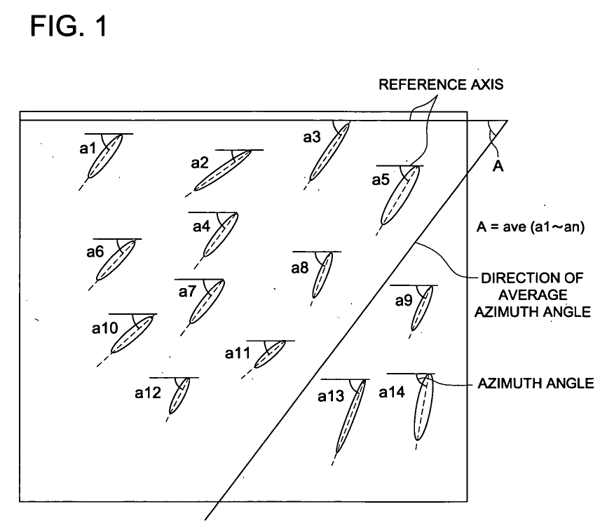

Measurement of an azimuth angle was performed with respect to each needle-shaped particle of the image data having been extraction processed in this manner. An azimuth angle of needle-shaped particles will be explained according to FIG. 1.

FIG. 1 shows an example of an image in which needle-shaped particles have been photographed at a magnification of 20,000 times and read by a scanner. An azimuth angle of an absolute maximum length of a particle against the reference axis is determined with respect to each particle: a1, a2, - - - an. Average value of these azimuth angles A=ave (a1-an) is calculated, and is defined as a mean azimuth angle. As a particle number, not less than 1,000 particles are measured to calculate the average value.

When the mean azimuth angle is within ±5° against the casting direction of the film, particles are said to be parallel to the longitudinal direction of the film. Further, similarly, when it is within ±5° against the direction perpendicular to the casting direction of the film, particles are said to be perpendicular to the casting direction of the film. Said mean azimuth angle is preferably within the direction of ±3° against the film casting direction or the width direction of the film, more preferably within the direction of ±1° and specifically preferably within the direction of ±0.5°.

Further, “mean value H of absolute values of angles between a mean azimuth angle and azimuth angles of needle-shaped particles” is within 30°.

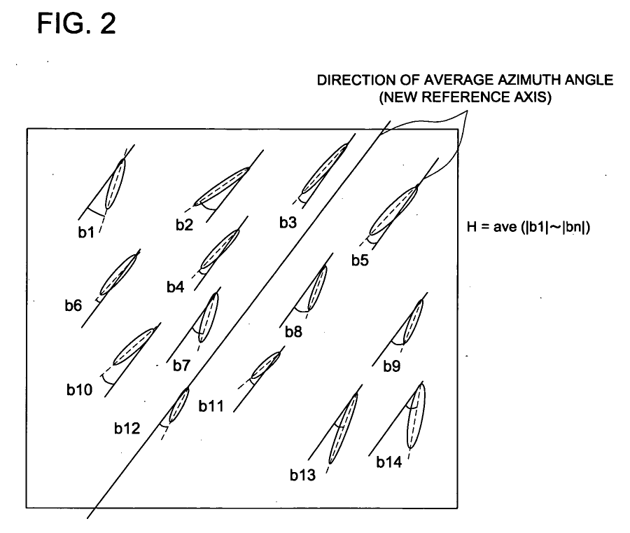

H will be explained according to FIG. 2. b1, b2, b3 - - - bn each represent an angle between the direction of an absolute maximum length (the long axis direction) of each needle-shaped particle and a mean azimuth angle, and the average of the absolute values can be determined by following Equation (3).
H=ave(|b1|−|bn|)

This is also measured with respect to not less than 1,000 particles similar to the calculation of aforesaid mean value A.

H is within 30°, preferably 2-26°, more preferably 2-19° and most preferably 2-11°.

With respect to mean inter-particle distance D, coordinates of a weight center of each needle-shaped particle are firstly determined from the aforesaid image data.

Herein, the direction of a mean azimuth angle determined by a method described above is set to the X axis direction. X-coordinate data of weight centers of each needle-shaped particle are put in order from the smallest to determine differences between adjacent data. This is designated as an inter-particle distance in the X axis direction. Similarly with respect to the Y axis direction, Y-coordinate data of weight centers of each needle-shaped particle are put in order from the smallest to determine differences between adjacent data. This is designated as an inter-particle distance in the Y axis direction. (Number of particles)-1 of data are obtained for both the inter-particle distances in the X axis direction and the inter-particle distances in the Y axis direction. These data of the inter-particle distances in the X axis direction and the inter-particle distances in the Y axis direction are summarized to determine an average value, which is designated as inter-particle distance D, and the standard deviation thereof is represented by Ds, whereby Ds/D value is calculated. This value indicates a dispersion state of needle-shaped particles in the film. A smaller standard deviation means that the distances between the particles are more homogeneous and that the needle-shaped particles are more uniformly dispersed.

In the present invention, this value is not more than 1.5, preferably 0.7-1.5, more preferably 0.7-1.3 and specifically preferably not more than 1.0.

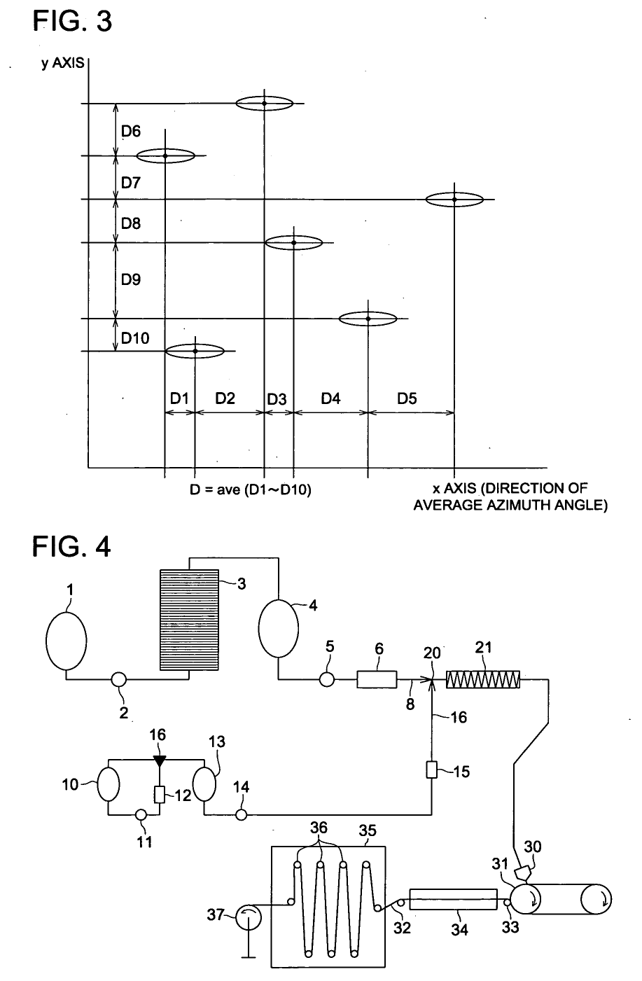

In calculation of the average of distances of weight centers of each particle, specifically as shown in FIG. 3, the both of all X components and Y components on X-Y plane are utilized for calculation.

In FIG. 3, 6 model particles are utilized for explanation, and an average D=ave (D1-D10), with respect to inter-particle distances between adjacent particles each other projected on X axis D1-D5 and inter-particle distances between adjacent particles each other projected on Y axis D6-D10, is designated as a mean inter-particle distance. In practice, this is performed with respect to not less than 1,000 particles to calculate mean value D. Further, determined is a standard deviation (Ds) with respect to the distances between weight centers of each particle obtained above.

In this manner, by dispersing and orienting needle-shaped particles, cutting behavior can be significantly improved as well as variation of retardation can be reduced.

As a method to disperse and orient added particles, employed can be such as a method in which film is stretched along the TD or MD at the time of film preparation (casting), and a method in which flow of dope is generated during casting to orient particles along this flow. Further, orientation of particles can be accelerated by such as an electric field or a magnetic field, and according to these methods, cutting behavior (slitting behavior) can be improved even with addition of needle-shaped particles.

As a manufacturing method of cellulose ester film containing these needle-shaped particles, particle dispersion, which contains at least said particles having a needle form and a birefringent property and resin for dispersion of said particles, is prepared in advance, then said particle dispersion, cellulose ester and a solvent are mixed to prepare a dope, which is supplied for solution casting, whereby cellulose ester film can be manufactured.

(Resin for Dispersion of Needle-shaped particles Having Birefringent Property)

Resin for dispersion of needle-shaped particles provided with a birefringent property has a weight average molecular weight of preferably 3,000 and more preferably 3,000.

Resin for dispersion of needle-shaped particles provided with a birefringent property is preferably one type selected from homopolymer or copolymer provided having an ethylenically unsaturated monomer unit, acrylic ester or methacrylic ester homopolymer or copolymer, methacrylic methylester homopolymer or copolymer, cellulose ester, cellulose ether polyurethane resin, polycarbonate resin, polyester resin, epoxy resin and ketone resin. Cellulose ester preferably has a total acyl substitution degree of 2.0-2.8.

These resins can form-uniform film with depressed haze increase even when being contained in a dope as a cellulose ester solution having a high concentration (cellulose concentration of 15-30 weigh %) which is utilized in solution casting.

In particle dispersion containing needle-shaped particles provided with a birefringent property, the concentration of resin for dispersion thereof is preferably 0.1-10 weight %. Further, a concentration of particles in this dispersion is preferably 0.2-10 weight %.

In the present invention, a viscosity of particle dispersion is preferably controlled in a range of 10-500 mPa·s.

The inventors of the present invention, as a result of study by changing types and molecular weight of resin with respect to various resins, have found that the following resins are preferable and that, by utilizing a resin having a weight average molecular weigh of 3,000, a dispersion state of particle dispersion is significantly improved and a dope having excellent compatibility with a cellulose ester solution and hardly generating flocks can be obtained when a wide range of resins are used. The weight average molecular weight is more preferably 5,000 and furthermore preferably 10,000. The resin is not specifically limited and those conventionally well known in the art can be utilized, however, the following resin can be more preferably utilized.

Examples of a resin preferably utilized in particle dispersion according to the present invention includes a homopolymer and a copolymer having an ethylenic monomer unit, more preferably a homopolymer or a copolymer of acrylate ester or methacrylate ester such as polymethyl acrylate, polyethyl acrylate, polypropyl acrylate, polycyclohexyl acrylate, copolymer of alkylacrylate, polymethyl methacrylate, polyethyl methacrylate, polypropyl methacrylate, polycyclohexyl methacrylate, copolymer of alkylmethacrylate. An acrylic ester or a methacrylic ester is excellent in transparency and compatibility. Preferable is a homopolymer or a copolymer having an acrylate ester unit or a methacrylate ester unit and more preferable is a homopolymer or a copolymer having a methylacrylate ester unit or a methylmethacrylate ester unit. Specifically preferable is polymethylmethacrylate ester. Alicyclic alkylester such as polycyclohexane acrylate or polycyclohxane methacrylate is also preferable due to advantage of exhibiting superior heat resistivity, a low hygroscopic property and a low birefringence.

Other resins include cellulose ester resin having a substitution degree of an acyl group of 1.8-2.80 such as cellulose acetate, cellulose acetate propionate and cellulose acetate butylate; cellulose ester resin having a substitution degree of an alkyl group of 2.0-2.80 such as cellulose metylether, cellulose ethylether and cellulose propylether; polyamide resin comprising polymer of alkyldicarboxylic acid and diamine; polyester resin such as polymer of alkylene dicarboxylic acid and diol, polymer of alkylene diol and dicarboxylic acid, polymer of cyclohexane dicarboxylic acid and diol, polymer of cyclohexane diol and dicarboxylic acid and polymer of aromatic dicarboxylic acid and diol; vinyl acetate resin such as polyvinyl acetate and vinyl acetate copolymer; polyvinyl acetal resin such as polyvinyl acetal and polyvinyl butyral; epoxy resin such as described below, ketone resin such as described below, polyurethane resin as described below such as linear polymer of alkylenediisocyanato and alkylenediol, and at least one type selected from them is preferably contained. Epoxy resin is formed by open ring reaction of a compound provided with at least two epoxy groups in a molecule, and includes the following epoxy resin; typical products available on the market are Araldite EPN1179 and Araldite AER260 (manufactured by Asahi Ciba Co., Ltd.). Herein, Araldite EPN1179 has a weight average molecular weigh of approximately 405. n represents a polymerization degree.

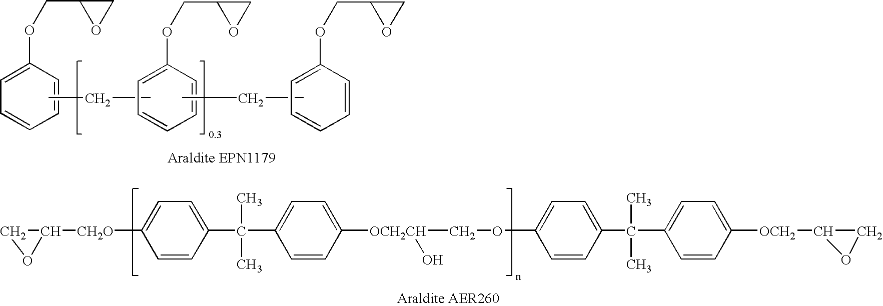

Further, ketone resin is prepared by polymerizing vinyl ketones and includes the following ketone resin. A typical product available on the market includes Hilac 110 and Hilac 110H (manufactured by Hitachi Chemical Co., Ltd.). n represents a polymerization degree.

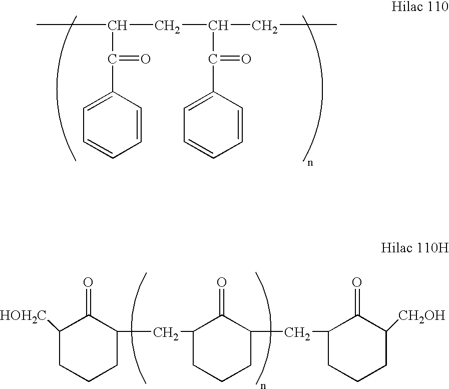

With respect to above-described resin, the inventors have found that dispercibility of particles has been improved by an elaborated dispersion method which will be described later, even with a weight average molecular weight out of the above-described range (less than 3,000 or over 90,000), and particle-dispersion with little aggregation tendency can be prepared.

The above-described resin can be utilized without limitation of the weight average molecular weight, however, the smaller is the weight average molecular weight, the easier is utilized the resin. The weight average molecular weight is preferably in a range of approximately 300-40,000, more preferably of 500-20,000 and furthermore preferably of 5,000. The smaller is the weight average molecular weight, more excellent is compatibility of a dope with cellulose ester as well as dispersibility of particles; while, the larger is the weight average molecular weight, the smaller is a required amount to adjust a viscosity of particle dispersion.

(Dispersant)

Particle dispersion or a dope utilized in the present invention preferably contains a dispersant, and an addition amount of a dispersant is preferably 0.002-2 weight % based on the weight of cellulose ester. As a dispersant, a polymer dispersant is specifically preferably utilized and a nonionic polymer dispersant, an anionic polymer dispersant and a cationic polymer dispersant are appropriately selected.

It is known that that a polymer dispersant which can adsorb on solid particles is utilized to uniformly disperse solid particles in a solvent or in a polymer composition solution. A polymer dispersant forms an adsorption layer on the surface of solid particles and such an adsorption layer generates an exclusive power to prevent aggregation of solid particles. A polymer utilized as a polymer dispersant to disperse particles includes homopolymer comprising a single monomer and random copolymer comprising plural monomers, however, conventionally, developed has been a polymer dispersant containing plural number of the both portions, one of which adsorbs by an interaction with solid particles and the other which is dissolved and spread into a solution, in one molecule and provided with a complex structure in which two actions are functionally shared in one molecule, and specifically, such as comb type polymer, in which such two actions are functionally shared, is known as a preferable polymer dispersant. In the present invention, it is preferable to incorporate these polymer dispersants in a dope or in particle dispersion.

A polymer dispersant includes such as polymer dispersants described in general formula (I) or general formula (II) of JP-A 2001-162934, polymer dispersants described in JP-A 2004-97955, anionic polymer dispersants described in paragraphs Nos. [0024]-[0027] of JP-A 2001-260265, polyoxypropylene fatty acid alkanol amide mixtures described in JP-A 8-337560, polyoxypropylene fatty acid isopropanol amide mixtures described in JP-A 9-20740, dispersants described in JP-A Nos. 9-192470 and 9-313917, dispersants described in JP-A 11-197485, and dispersants described in JP-A 2004-89787, however, is not limited thereto. For example, listed are F-1000, KF-1525, Hinoact T6000, 7000, 8000, 8000E and KM-1300 (manufactured by Kawaken Fine Chemicals Co., Ltd.). In addition to these, also utilized are polyethylene glycol, polypropylene glycol, polyvinyl methylether, polyvinyl acetate, polyvinyl alcohol, poly(N-vinyl pyrrolidone), poly(2-methyl-2-oxazoline), poly(2-ethyl-2-oxazoline) and a macromer containing these polymer components.

A content of a dispersant is preferably 0.0001-1 weight % in a dope or particle dispersion.

Further, in the following, a preferable method to manufacture cellulose ester while controlling the aforesaid dispersion state (Ds/D) of needle-shaped particles will be listed.

(a) A manufacturing method of cellulose ester film, wherein needle-shaped particle dispersion containing needle-shaped particles and resin for dispersing needle-shaped particles is prepared, which is mixed into a dope prepared by dissolving cellulose ester in a solvent, followed by being cast on a support and dried.

(b) The manufacturing method described in above item (a), wherein dispersion of the aforesaid needle-shaped particles has been performed by use of a sand grinder employing a bead diameter of 0.03-0.3 mm.

(c) The manufacturing method described in above item (a), wherein the aforesaid needle-shaped particle dispersion has been prepared by preparing dispersion comprising needle-shaped particles and a solvent, and the resulting dispersion is added with resin for dispersing needle-shaped particles, followed by being dispersed again.

(d) The manufacturing method described in above item (a) or (c), wherein resin for dispersing needle-shaped particles, which is contained in dispersion of the aforesaid-needle-shaped particles, has a weight average molecular weight of 3,000.

(e) The manufacturing method described in above items (a)-(d), wherein resin for dispersing needle-shaped particles contained in dispersion of needle-shaped particles is at least one type selected from homopolymer or copolymer provided with an ethylenically unsaturated monomer unit, acrylic ester or methacrylic ester homopolymer or copolymer, methylmethacrylate ester homopolymer or copolymer, cellulose ester, cellulose ether polyurethane resin, polycarbonate resin, polyester resin, epoxy resin and ketone resin.

(f) The manufacturing method described in above items (a)-(e), wherein a solvent contained in dispersion of the aforesaid needle-shaped particles is at least one type selected from methylene chloride, methyl acetate, ethanol, methanol and acetone.

(g) A manufacturing method of cellulose ester film in which a dope containing the aforesaid needle-shaped particles, cellulose ester and a solvent is cast on a support and successively dried, wherein a stretching process is provided in any one of the drying processes and a process to measure a birefringence of stretched film is provided, and a content of needle-shaped particles, which are contained in a dope and have a birefringent property, is adjusted based on the result in said process to measure the birefringence.

(h) The manufacturing method described in above item (g), wherein the aforesaid method to adjust a content of needle-shaped particles contained in a dope is performed by adding an inline addition solution of needle-shaped particles having a birefringent property into a main dope.

[Materials to Form Dope]

In the present invention, a mixture of a cellulose ester solution, which contains cellulose ester and a solvent, a particle dispersion, which contains needle-shaped particles having a high needle-shape ratio and a birefringent property, resin for dispersion of said particles, an organic solvent and preferably at least one type of an additive selected from polyester, polyhydric alcohol ester, polycarboxylic ester and polymer obtained by polymerization of ethylenically unsaturated monomer, is referred to as a dope, which is employed to perform solution casting, whereby cellulose ester film is formed.

[Additive]

Cellulose ester film of the present invention is characterized by containing at least one type of an additive selected from polyester, polyhydric alcohol ester, polycarboxylic ester and polymer obtained by polymerization of ethylenically unsaturated monomer together with needle-shaped particles according to the present invention. These additives are preferably contained in a range of 1-30 weight % and specifically preferably in a range of 5-30 weight %. By applying the above described content range, compatibility with cellulose ester becomes excellent and needle-shaped particles are easily oriented.

With respect to each compound, the details will be explained below.

(Polyester Type Compound)

A polyester type compound is not specifically limited, however, a polyester type compound having an aromatic ring or a cycloalkyl ring in a molecule can be utilized.

Polyester useful for the present invention will now be described.

As dibasic acid which is one of constituent components of polyester, aliphatic dibasic acid, alicyclic dibasic acid and aromatic dibasic acid are preferable, and aliphatic dibasic acid includes such as malonic acid, succinic acid, glutaric acid, adipic acid, pimelic acid, suberic acid, azelaic acid, sebacic acid, undecanedicarboxylic acid and dodecanedicarboxylic acid; aromatic dibasic acid includes such as phthalic acid, terephthalic acid, isophthalic acid and 1,4-xylidenedicarboxylic acid; and alicyclic dibasic acid includes such as 1,3-cyclopentanedicarboxylic acid, 1,4-cyclohexanedicarboxylic acid and 1,4-cyclohexanediacetic acid.

Specifically, those having a carbon number of 4-12 as aliphatic dicarboxylic acid, alicyclic dicarboxylic acid and aromatic dicarboxylic acid are preferable, and at least one selected from these is utilized. That is, at least two types of dicarboxylic acids may be utilized in combination. Glycol as the other constituent component includes such as ethylene glycol, diethylene glycol, 1,2-propylene glycol, 1,3-propylene glycol, 1,2-butylene glycol, 1,3-butylene glycol, 1,4-butylene glycol, 1,5-pentanediol, 1,6-hexanediol, 1,4-cyclohexanediol, 1,5-pentylene glycol, 1,4-cyclohexane dimethanol, diethylene glycol, triethylene glycol and tetraethylene glycol, however, preferable are ethylene glycol, 1,2-propylene glycol, 1,3-propylene glycol, 1,2-butylene glycol, 1,3-butylene glycol, 1,4-butylene glycol, 1,6-hexanediol, 1,4-cyclohexane dimethanol and diethylene glycol, triethylene glycol, and more preferably utilized are 1,3-propylene glycol, 1,4-butylene glycol, 1,6-hexanediol and diethylene glycol. As polyester, those hardly crystallized are preferred. Polymerization of polyester is performed according to an ordinary method. For example, polyester can be easily synthesized by any method of, a direct reaction of the above-described dibasic acid and glycol, a polyesterification reaction or a melt condensation method by an ester exchange reaction, of the above-described dibasic acid or alkylester thereof such as methylester of dibasic acid and glycols, or a de-hydrogen halogenide reaction of acid chloride of these acids and glycol, however, polyester having a not so large weight average molecular weight is preferably prepared by a direct reaction. Polyester having higher distribution on the lower molecular weight side exhibits excellent compatibility with cellulose ester, and can provide cellulose ester film, which shows small moisture permeability and excellent transparency after film formation. An adjustment method of the molecular weigh is not specifically limited and conventional methods can be utilized. For example, it can be controlled by a method of sealing a molecular terminal with monovalent acid or monohydric alcohol, while changing the addition amount of said monovalent additives. In this case, monovalent acid is preferred with respect to stability of polymer. For example, listed are acetic acid, propionic acid, butyric acid, pivalic acid and benzoic acid, however, selected are those hardly removed during polycondensation reaction but easily removed out of the system when reaction is stopped and such monovalent acid is removed out of the system. They may be utilized in combination. Further, in the case of a direct reaction, a weight average molecular weight can be adjusted by controlling the timing to stop a reaction depending on the amount of water distilled out during the reaction. In addition to these, it can be adjusted also by inclining the mole number of glycol or dibasic acid which are charged, and also by controlling reaction temperature.

Further, the following polyester is also included in polyester utilized in the present invention.

Polyester ether useful in the present invention can be prepared by a thermal fusion condensation method by a polyesterification reaction or an ester exchange reaction of the aforesaid polyester and the aforesaid dibasic acid or alkylesters thereof, and a compound having an OH group on the both terminal of an ether unit; or a reaction method in which polyester having a terminal OH group is etherized. An ether unit is not specifically limited, and includes HO(RO)ₙROH (wherein, R is an alkylene group, an allylene group, an alalkyl group, a bi-functional alicyclic group, and mixtures thereof, and further n is 1-100) such as diethylene glycol, triethylene glycol, tetraethylene glycol, polyethylene glycol, polypropylene glycol, polybutylene glycol, polyphenylene glycol, polycyclohexylene glycol, and mixture thereof. Adjustment of molecular weight of polymer is not specifically limited and can be performed similarly to the case of polyester.

Further, polyester ether suitable for the present invention can be obtained from products available on the market. For example, Hytrel copolyesters manufactured by Dupont Corp., Galflex polymer, manufactured by GAF Corp. and Adekasizer RS Series manufactured by Asahi Denka Co., Ltd. are listed.

Further, as a polyester type compound contained in polyester film of the present invention, compounds represented by following general formula (I) are specifically preferable.
B-(G-A)ₙ-G-B General formula (I)

In the above general formula (I), B is a benzene monocarboxylic acid residue, G is an alkylene glycol residue having a carbon number of 6-12, aryl glycol residue having a carbon number of 6-12 or an oxyalkylene glycol residue having a carbon number of 4-12, and “A” is an alkylene dicarboxylic acid residue having a carbon number of 4-12 or aryl dicarboxylic acid residue having a carbon number of 6-12, and n is an integer of not less than 1.

A compound of general formula (I) is constituted of a benzene monocarboxylic acid residue represented by B and an alkylene glycol residue, an oxyalkylene glycol residue or an arylgrycol residue represented by G, and alkylene dicarboxylic acid residue or an aryl dicarboxylic acid residue represented by “A”, and can be prepared by a reaction similar to that of an ordinary polyester type compound.

A benzene monocarboxylic acid component of polyester type compound utilized in the present invention includes such as benzoic acid, para-tertiary-butyl benzoic acid, ortho-toluic acid, metha-toluic acid, para-toluic acid, dimethylbenzoic acid, ethylbenzoic acid, normal-propylbenzoic acid, aminobenzoic acid and acetoxybenzoic acid, and these may be utilized alone or in combination of at least two types.

In general formula (I), an alkylene glycol component having a carbon number of 2-12 and represented by G includes ethylene glycol, 1,2-propylene glycol, 1,3-propylene glycol, 1,2-butanediol, 1,3-butanediol, 1,4-butanediol, 1,5-pentanediol, 2,2-dimethyl-1,3-propanediol (neopentylglycol), 2,2-diethyl-1,3-propanediol (3,3-dimethylolpentane), 2-n-butyl-2-ethyl-1,3-propanediol (3,3-dimthylolheptane), 3-methyl-1,5-pentanediol-1,6-hexanediol, 2,2,4-trimethyl-1,3-pentanediol, 2-ethyl-1,3-hexanediol, 2-methyl-1,8-octanediol, 1,9-nonanediol, 1,10-decanediol and 1,12-octadecanediol, and these glycols may be utilized alone or as a mixture of at least two types.

Further, in general formula (I), an oxyalkylene glycol component having a carbon number of 4-12 and represented by G includes such as diethylene glycol, triethylene glycol, tetraethylene glycol, dipropylene glycol and tripropylene glycol, and these glycols may be utilized alone or as a mixture of at least two types.

In general formula (I), an aryl glycol component having a carbon number of 6-12 and represented by G includes such as hydroquinone, resorcine, bisphenol A, bisphenol F and bisphenol, and these glycols may be utilized alone or as a mixture of at least two types.

In general formula (I), an alkylene dicarboxylic acid component having a carbon number of 4-12 and represented by “A” includes such as succinic acid, maleic acid, fumaric acid, glutaric acid, adipic acid, azelaic acid, sebasic acid and dodecane dicarboxylic acid, and these may be utilized alone or as a mixture of at least two types. An arylene dicarboxylic acid component having a carbon number of 6-12 includes such as phthalic acid, terephthalic acid, 1,5-naphthalene dicarboxylic acid and 1,4-naphthalene dicarboxylic acid.

An ester type compounds utilized in the present invention is preferably has a number average molecular weight in a range of 300-2,000 and more preferably of 500-1,500. Further, it is preferable that the acid value is not more than 0.5 mgKOH/g and the hydroxyl value is not more than 25 mgKOH/g, and is more preferable that the acid value is not more than 0.3 mgKOH/g and the hydroxyl group value is not more than 15 mgKOH/g.

An acid value of an ester type compound referred in the present invention means mg number of potassium hydroxide required to neutralize acid contained in 1 g of a sample. An acid vale and a hydroxyl value are measured based on JIS K0070.

In the following, a synthesis example of a polyester type compound according to the present invention will be explained.

<Sample 1 (Polyester Type Compound)>

In a reaction vessel, 820 parts of phthalic acid (5 mol), 608 parts (8 mol) of 1,2-propylene glycol, 610 parts (5 mol) of benzoic acid and 0.30 parts of tetraisopropyl titanate as a catalyst are charged as a lump to be stirred under nitrogen gas flow, and heating was continued until the acid value reached not more than 2 while refluxing excessive monohydric alcohol with a reflux condenser to continuously eliminate generated water. Next, the distillate was removed at 200-230° C. and finally under a reduced pressure of not higher than 400 Pa, followed by filtration to prepare a polyester type compound having the following properties was prepared.

Viscosity (25° C., mPa·s): 19,815

Acid value: 0.4

<Sample 2 (Polyester Type Compound)>

A polyester type compound having the following properties was prepared in a similar manner to sample No. 1 except that, in a reaction vessel, 500 parts (3.5 mol) of adipic acid, 305 parts (2.5 mol) of benzoic acid, 583 parts (5.5 mol) of diethylene glycol and 0.45 parts of tetraisopropyl titanate as a catalyst were utilized.

Viscosity (25° C., mPa·s):90

Acid value: 0.05

<Sample 3 (Polyester Type Compound)>

A polyester type compound having the following properties was prepared in a similar manner to sample No. 1 except that, in a reaction vessel, 570 parts (3.5 mol) of isophthalic acid, 305 parts (2.5 mol) of benzoic acid, 737 parts (5.5 mol) of dipropylene glycol and 0.40 parts of tetraisopropyl titanate as a catalyst were utilized.

Viscosity (25° C., mPa·s):33,400

Acid value: 0.2

In the following, specific compounds of a polyester type compound will be shown; however, the present invention is not limited thereto.

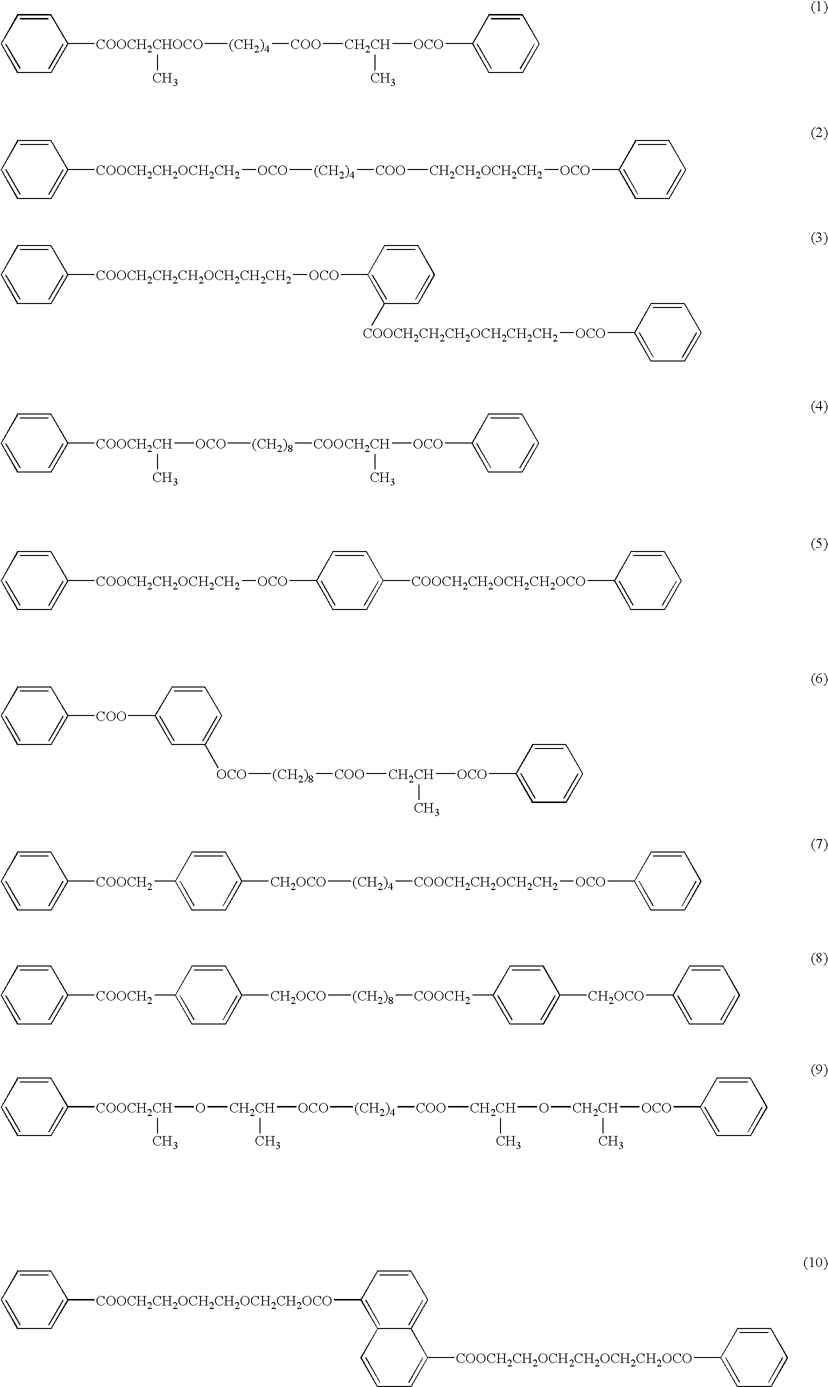

A content of a polyester type compound according to the present invention is preferably 1-20 weight % and specifically preferably 3-11 weight % in cellulose ester film.

(Polyalcohol Ester Compound)

A polyalcohol ester compound contains an ester of aliphatic polyalcohol and monocarboxylic acid having a valence of 2 or more, and preferably contains an aromatic ring or cycloalkyl ring in the molecule. The polyalcohol ester compound is preferably an eater of an aliphatic polyalcohol having a valance of 2 through 20.

The polyalcohol preferably used in the present invention can be expressed by the following Formula (B):
R₁—(OH)ₙ Formula (B)

In the aforementioned Formula (B), R₁ represents an organic group having a valence of n, “n” denotes a positive integer of two or more, and the OH group represents an alcoholic and/or phenolic hydroxyl group.

The preferable polyalcohol is exemplified by the following substances, however, the present invention is not limited thereto: adonitol, arabitol, ethylene glycol, diethylene glycol, triethylene glycol, tetraethylene glycol, 1,2-propanediol, 1,3-propanediol, dipropyleneglycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methyl pentane-1,3,5-triol, pinacol, sorbitol, trimethylol propane, trimethylol ethane, and xylitol. Especially triethylene glycol, tetraethylene glycol, dipropyleneglycol, tripropylene glycol, sorbitol, trimethylol propane and xylitol are preferably used.

There is no particular restriction imposed on the monocarboxylic acid used in the polyalcohol ester in the present invention. A commonly known aliphatic monocarboxylic acid, alicyclic monocarboxylic acid and aromatic monocarboxylic acid can be used. Use of alicyclic monocarboxylic acid and aromatic monocarboxylic acid preferably improves the moisture permeability and retentivity.

The following are preferably cited as monocarboxylic acids, however, the present invention is not limited hereto:

The preferred aliphatic monocarboxylic acid is exemplified by a straight chain fatty acid or a branched fatty acid having 1 through 32 carbon atoms, wherein the number of carbon atoms is more preferably 1 through 20, still more preferably 1 through 10. When acetic acid is contained, the miscibility with cellulose ester is improved. A mixture of acetic acid with one or more other monocarboxylic acids is also preferably used.

The preferably used aliphatic monocarboxylic acid is exemplified by saturated fatty acids such as acetic acid, propionic acid, butyric acid, valeric acid, caproic acid, enanthic acid, caprylic acid, pelargonic acid, caprylic acid, 2-ethyl-hexanoic acid, undecylic acid, lauric acid, tridecylic acid, myristic acid, pentadecylic acid, palmitic acid, heptadecylic acid, stearic acid, nanodecanoic acid, arachic acid, behenic acid, lignoceric acid, cerotic acid, heptacosanoic acid, montanoic acid, melissic acid and lacceric acid; and unsaturated fatty acids such as undecylenic acid, oleic acid, sorbic acid, linolic acid, linolenic acid, and arachidonic acid.

Examples of preferably used alicyclic monocarboxylic acids include cyclopentane carboxylic acid, cyclohexane carboxylic acid, cyclooctonic carboxylic acid and the derivative thereof.

Examples of preferably used aromatic monocarboxylic acids include: compounds having a benzene ring of a benzoic acid in which an alkyl group is introduced such as benzoic acid and toluic acid; aromatic monocarboxylic acids having two or more benzene rings such as biphenylcarboxylic acid, naphthalene carboxylic acid and tetraphosphide carboxylic acid; and the derivatives thereof. Of these, benzoic acid is specifically preferred.

The molecular weight of the polyalcohol ester is not specifically limited, however, the molecular weight of the polyalcohol ester is preferably 300 through 1500, and more preferably 350 through 750. A higher molecular weight is preferable in view of suppressing the volatilization, while a lower molecular weight is preferable in view of moisture permeability and miscibility with cellulose ester.

One type of carboxylic acid or a combination of two or more may be used for the polyalcohol ester. All the OH groups in the polyalcohol may be esterified or some of them may be left as OH groups.

The following describes the specific examples of the compounds of the polyalcohol ester:

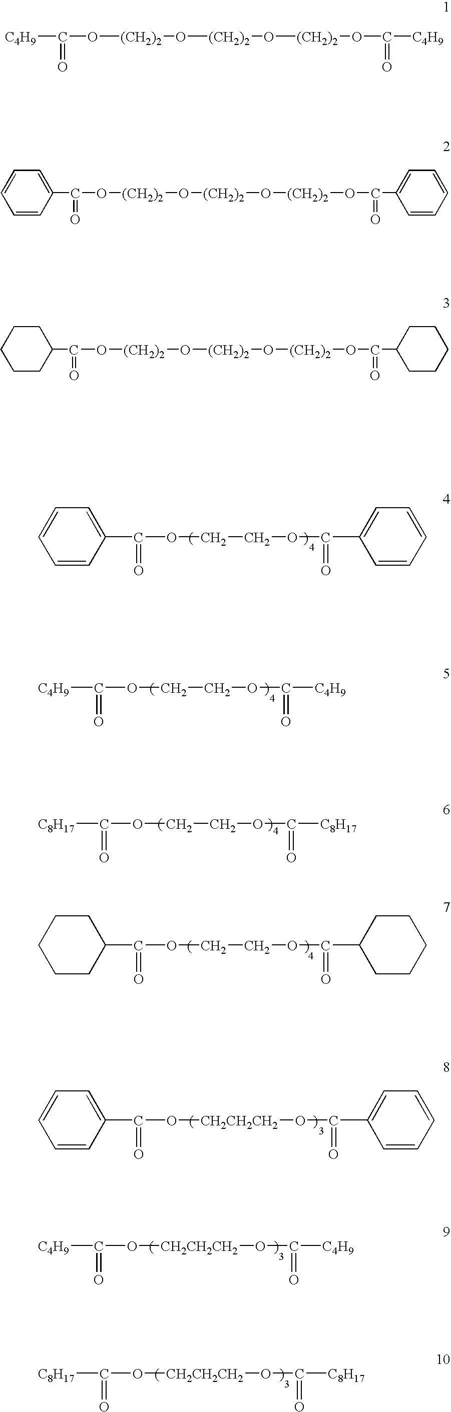

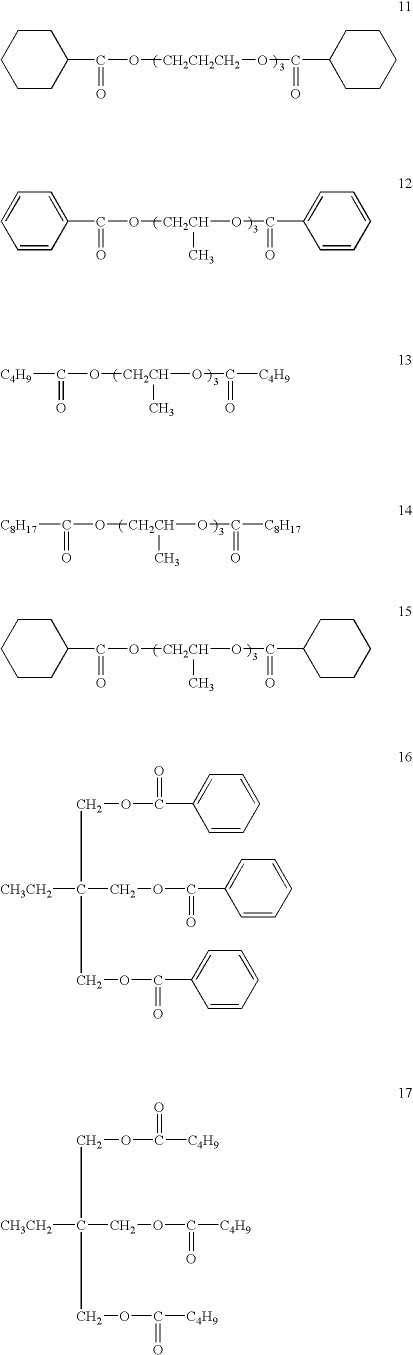

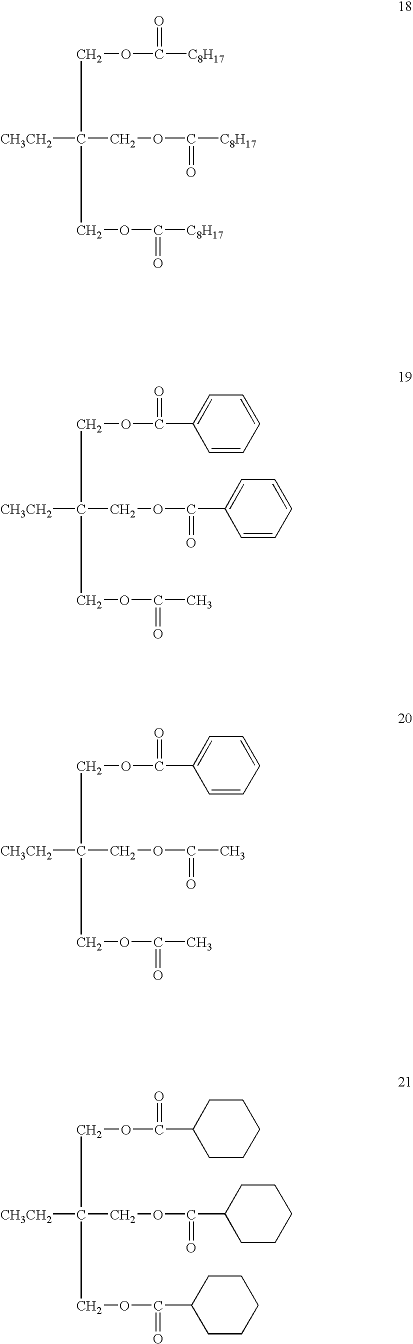

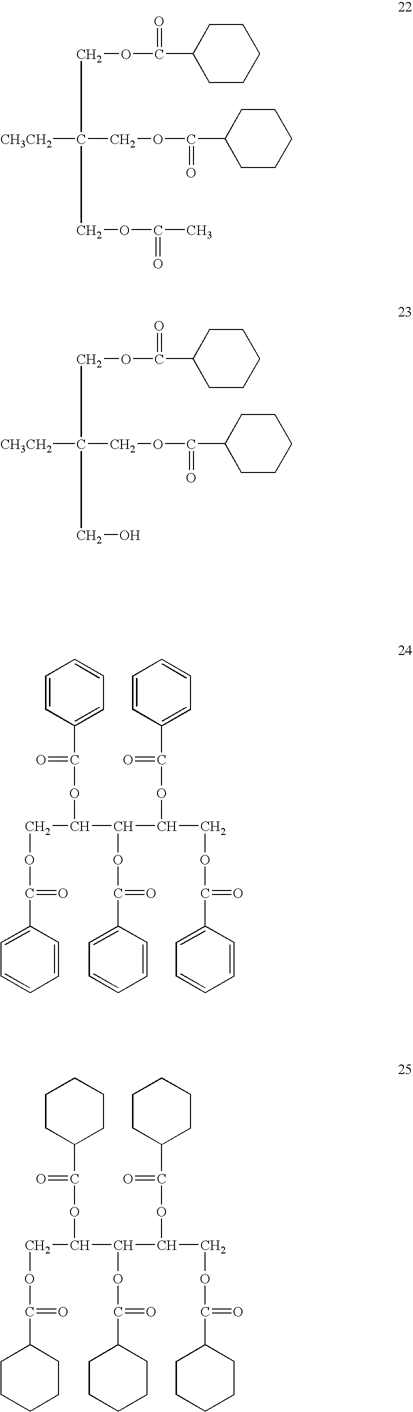

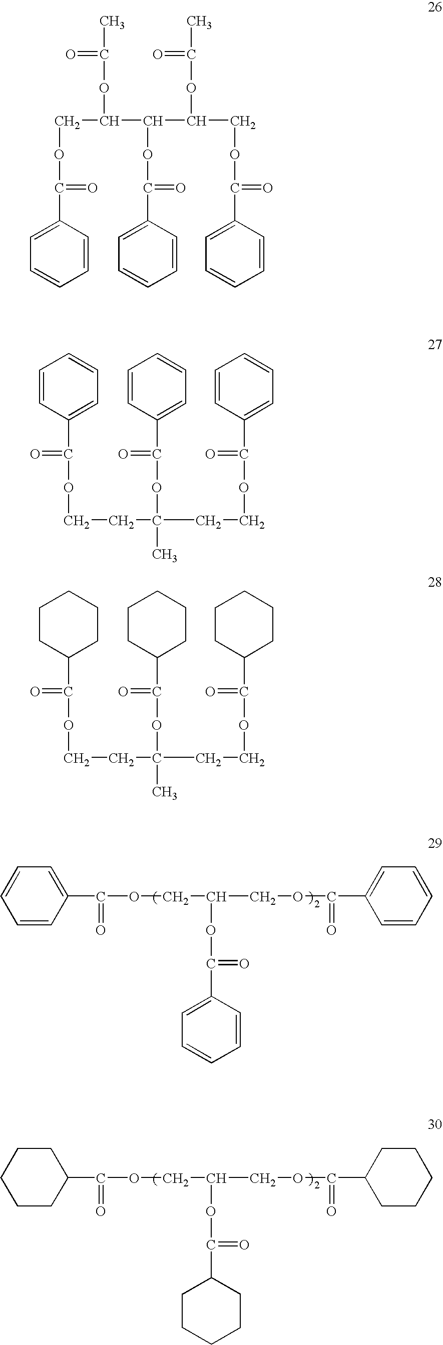

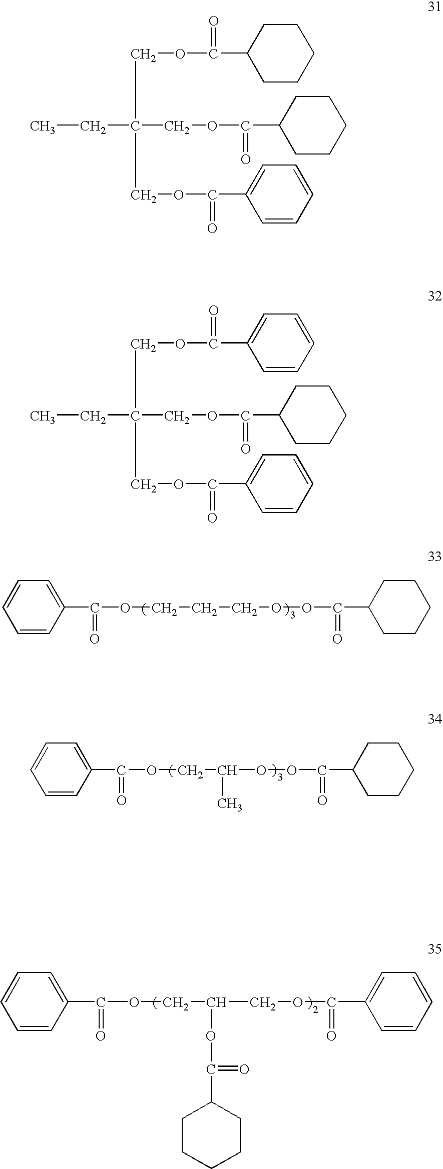

(Polycarboxylic Acid Ester Compound)

The polycarboxylic acid ester compound in the present invention is an ester of a polycarboxylic acid having a valence of 2 or more, preferably 2 through 20, and an alcohol. The aliphatic polycarboxylic acid preferably has a valence of 2 through 20. The aromatic polycarboxylic acid and alicyclic polycarboxylic acid preferably has a valence of 3 through 20.

The polycarboxylic acid used in the present invention is preferably the compound expressed by Formula (C).
R₂(COOH)ₘ(OH)ₙ Formula (C)

In Formula (C), R₂ denotes an organic group having a valence of (m+n), m represents a positive integer of 2 or more, n shows an integer of 0 or more, COOH group shows the carboxyl group, and the OH group represents the alcoholic or phenolic hydroxyl group.

The following shows the examples of the preferred polycarboxylic acid, however, the present invention is not limited thereto: aromatic polycarboxylic acid having a valence of 3 or more such as trimellitic acid, trimesic acid and pyromellitic acid, and the derivative thereof; aliphatic polycarboxylic acid such as succinic acid, adipic acid, azelaic acid, sebacic aid, oxalic acid, fumaric acid, maleic acid and tetrahydrophthalic acid; and oxypolycarboxylic acid such as tartaric acid, tartronic acid, malic acid and citric acid. Use of oxypolycarboxylic acid is particularly preferred for the improved retentivity.

There is no limitation for the alcohol used for the polycarboxylic acid ester compound of the present invention. Commonly known alcohol and phenols can be utilized. For example, preferably used is an aliphatic saturated alcohol or an aliphatic unsaturated alcohol having 1 through 32 carbon atoms which has a straight chain or a side chain. The number of carbon atoms is preferably 1 through 20 and more preferably 1 through 10. Also preferable are, for example: alicyclic alcohols such as cyclopentanol and cyclohexanol or a derivative thereof; and aromatic alcohols such as benzyl alcohol and cinnamyl alcohol or derivatives thereof.

When the oxypolycarboxylic acid is used as the polycarboxylic acid, the alcoholic or phenolic hydroxyl group of oxypolycarboxylic acid is preferably subjected to esterification by a monocarboxylic acid. The following substances can be listed as examples of preferred monocarboxylic acids, however, the present invention is not limited thereto:

The fatty acid having 1 through 32 carbon atoms which has a straight chain or a branched chain is preferably used as the aliphatic monocarboxylic acid. In this case, the number of carbon atoms is more preferably 1 through 20, still more preferably 1 through 10.

The preferably used aliphatic monocarboxylic acid is exemplified by saturated fatty acids such as acetic acid, propionic acid, butyric acid, valeric acid, caproic acid, enanthic acid, caprylic acid, pelargonic acid, caprylic acid, 2-ethyl-hexane carboxylic acid, undecylic acid, lauric acid, tridecylic acid, myristic acid, pentadecylic acid, palmitic acid, heptadecylic acid, stearic acid, nanodecanoic acid, arachic acid, behenic acid, lignoceric acid, cerotic acid, heptacosanoic acid, montanoic acid, melissic acid and lacceric acid; and unsaturated fatty acids such as undecylenic acid, oleic acid, sorbic acid, linolic acid, linolenic acid and arachidonic acid.

Examples of a preferably used alicyclic monocarboxylic acid include: cyclopentane carboxylic acid, cyclohexane carboxylic acid, cyclooctane carboxylic acid, and derivatives thereof.

Examples of a preferably used aromatic monocarboxylic acid include: compounds having a benzene ring of a benzoic acid in which an alkyl group is introduced such as benzoic acid and toluic acid; aromatic monocarboxylic acids having two or more benzene rings such as biphenylcarboxylic acid, naphthalene carboxylic acid and tetraphosphide carboxylic acid; and the derivatives thereof. Of these, acetic acid, propionic acid and benzoic acid are specifically preferred.

There is no particular limitation for the molecular weight of the polycarboxylic acid ester compound. The preferred molecular weight is in the range from 300 through 1000. The range from 350 through 750 is more preferred. The greater molecular weight is more advantageous in improving the retentivity, while smaller molecular weight is more advantageous in improving the moisture permeability, miscibility with cellulose ester.

One type of alcohol or a mixture of two or more types can be used in the polycarboxylic acid ester of the present invention.

The acid number of polycarboxylic acid ester compound used in the present invention is preferably 1 mg KOH/g or less, more preferably 0.2 mg KOH/g or less. If the acid number is kept within the aforementioned range, the change in retardation due to environment can be preferably suppressed.

(Polymer Obtained by Polymerization of the Ethylenically Unsaturated Monomer)

The polymer obtained by polymerization of the ethylenically unsaturated monomer of the present invention is obtained via polymerization of the ethylenically unsaturated monomer and photo-polymerization initiator.

The polymer obtained by polymerization of the ethylenically unsaturated monomer of the present invention (hereinafter referred to as “polymer of the present invention”) includes an acrylic polymer, an acrylic polymer containing an aromatic ring as a side chain, or the acrylic polymer containing a cyclohexyl group as a side chain.

The weight average molecular weight of the polymer of the present invention is preferably 500 through 10,000 because the polymer of this range exhibits excellent miscibility with the cellulose ester without evaporation or volatilization in the film manufacturing process. The acrylic polymer, the acrylic polymer containing an aromatic ring as a side chain, or the acrylic polymer containing the cyclohexyl group as a side chain having a weight average molecular weight of preferably 500 through 5,000 exhibits excellent transparency of the cellulose ester film after the cellulose ester is formed into a film, extremely low moisture permeability, and excellent performances as a polarizing plate protective film, in addition to the aforementioned advantages.

The polymer of the present invention having a weight average molecular weight of 500 through 10,000 is considered to be an intermediate state between an oligomer and a low-molecular weight polymer. To synthesize such a polymer, it is difficult to control the molecular weight if the conventional method of polymerization is utilized. Preferably applied is a technique by which the molecular weight is controlled as uniform as possible while being suppressed not to excessively increase. Examples of such a technique include: a method of using the peroxide polymerization initiator such as cumene-peroxide and t-butylhydroperoxide; a method of using a greater amount of polymerization initiator than in the normal polymerization process; a method of using a chain transfer agent such as a mercapto compound or carbon tetrachloride, in addition to the polymerization initiator; a method of using a polymerization terminator such as benzoquinone or dinitrobenzene, in addition to the polymerization initiator; and a method of bulk polymerization using, as a catalyst, a compound containing one thiol group and secondary hydroxyl group or a material further containing an organometallic compound in addition to the above compound, the method being disclosed in, for example, in JP-A No. 2001-012891 or 2000-344823. Any of these methods may be preferably usable in the present invention, however, more preferable is the method disclosed in any of the above patent documents.

The following shows the monomers constituting the polymer preferably used in the present invention, however the present invention is not limited thereto.

The unit of the ethylenically unsaturated monomer constituting the polymer obtained by polymerization of the ethylenically unsaturated monomer is exemplified by:

a vinyl ester such as vinyl acetate, vinyl propionate, acid vinyl butyrate, vinyl valerate, vinyl vylic pivalate, vinyl caproate, vinyl caproate, vinyl laurate, vinyl myristate, vinyl palmitate, vinyl stearate, vinyl cyclohexane carboxylate, vinyl octoate, vinyl methacrylate, vinyl crotonate, vinyl solbate, vinyl benzoate and vinyl cinnamate;

an acrylic acid ester such as methyl acrylate, ethyl acrylate, propyl acrylate (i-, n-), butyl acrylate (n-, i-, s-, t-), pentyl acrylate (n-, i-, s-), hexyl acrylate (n-, i-), heptyl acrylate (n-, i-), octyl acrylate (n-, i-), nonyl acrylate (n-, i-), myristyl acrylate (n-, i-), cyclohexyl acrylate, (2-ethylhexyl) acrylate, benzyl acrylate, phenetyl acrylate, (ε-caprolactone) acrylate, (2-hydroxy ethyl) acrylate, (2-hydroxy propyl) acrylate, (3-hydroxy propyl) acrylate, (4-hydroxy butyl) acrylate, (2-hydroxy butyl) acrylate, -p-hydroxy methyl phenyl acrylate, and -p-(2-hydroxy ethyl) phenyl acrylate;

a methacrylic acid ester such as methacrylic acid ester changed from the aforementioned acrylic acid ester; and

an unsaturated acid such as acrylic acid, methacrylic acid, maleic anhydride, crotonic acid and itaconic acid.

The polymer made of the aforementioned monomers can be either copolymer or homopolymer. The preferably used polymer is a vinyl ester homopolymer, a vinyl ester copolymer or a copolymer between vinyl ester and acrylic acid or methacrylic acid ester.

In the present invention, the acrylic polymer is defined as an acrylic acid or methacrylic acidalkyl ester homopolymer or copolymer without monomer unit containing an aromatic ring or cyclohexyl group. The acrylic polymer having an aromatic ring on the side chain refers to the acrylic polymer containing the acrylic acid or methacrylic acid ester monomer unit provided with aromatic ring. The acrylic polymer having a cyclohexyl group on the side chain refers to the acrylic polymer containing the acrylic acid or methacrylic acid ester monomer unit equipped with cyclohexyl group.

The acrylic acid ester monomer without aromatic ring or cyclohexyl group is exemplified by methyl acrylate, ethyl acrylate, propyl acrylate (i-, n-), butyl acrylate (n-, i-, s-, t-), pentyl acrylate (n-, i-, s-), hexyl acrylate (n-, i-), heptyl acrylate (n-, i-), octyl acrylate (n-,i-), nonyl acrylate (n-, i-), myristyl acrylate (n-,i-), (2-ethylhexyl) cyclohexyl acrylate, (ε-caprolactone) acrylate, (2-hydroxy ethyl) acrylate, (2-hydroxy propyl) acrylate, (3-hydroxy propyl) acrylate, (4-hydroxy butyl) acrylate, (2-hydroxy butyl) acrylate, (2-methoxy ethyl) acrylate and (2-ethoxy ethyl) acrylate, or methacrylic acid ester changed from the aforementioned acrylic acid ester.

The acrylic polymer is a homopolymer or copolymer of the aforementioned monomer preferably containing 30% by weight or more of the acrylic acid methyl ester monomer unit, and 40% by weight or more of the methacrylic acid methyl ester monomer unit. The homopolymer of acrylic acid methyl or methacrylic acid methyl is particularly preferred.

The acrylic acid or methacrylic acid ester monomer containing the aromatic ring is exemplified by phenyl acrylate, phenyl methacrylate, (2 or 4-chlorophenyl) acrylate, (2 or 4-chlorophenyl) methacrylate, (2, 3 or 4-ethoxycarbonylphenyl) acrylate, (2, 3 or 4-ethoxycarbonylphenyl) methacrylate, (o, m or p-tolyl) acrylate, (o, m or p-tolyl) methacrylate, benzyl acrylate, benzyl methacrylate, phenethyl acrylate, phenethyl methacrylate, and (2-naphthyl) acrylate benzyl acrylate, benzyl methacrylate, phenethyl acrylate, and phenethyl methacrylate can preferably be used.

The acrylic polymer having aromatic ring on the side chain preferably contains 20 through 40% by weight of the acrylic acid or methacrylic acid ester monomer unit having the aromatic ring, and 50 through 80% by weight of acrylic acid or methacrylic acid methyl ester monomer unit. The aforementioned polymer preferably contains 2 through 20% by weight of acrylic acid or methacrylic acid ester monomer unit containing the hydroxyl group.

The acrylic acid ester monomer containing the cyclohexyl group is exemplified by cyclohexyl acrylate, cyclohexyl methacrylate, (4-methyl cyclohexyl) acrylate, (4-methyl cyclohexyl) methacrylate, (4-ethyl cyclohexyl) acrylate, and (4-ethyl cyclohexyl) methacrylate. The acrylic acid cyclohexyl and methacrylic acid cyclohexyl is preferably employed.

The acrylic polymer having a cyclohexyl group on the side chain preferably includes 20 through 40%, and 50 through 80% by weight of acrylic acid or methacrylic acid ester monomer unit containing a cyclohexyl group. The aforementioned polymer preferably includes 2 through 20% by weight of the crylic acid or methacrylic acid ester monomer unit containing the hydroxyl group.

The polymer and acrylic polymer obtained by polymerization of the aforementioned ethylenically unsaturated monomer; acrylic polymer having the aromatic ring on the side chain; and acrylic polymer having the cyclohexyl group on the side chain provide excellent miscibility with the cellulose ester, superb productivity without evaporation or volatilization, outstanding retentivity as a polarizing plate protective film, minimized moisture permeability, and prominent dimensional stability.

In the present invention, the acrylic acid or methacrylic acid ester monomer having a hydroxyl group is based on the structural unit of a copolymer, not homopolymer. In this case, acrylic acid or methacrylic acid ester monomer unit including the hydroxyl group preferably accounts for 2 through 20% by weight in the acrylic polymer.

In the present invention, the polymer including a hydroxyl group on the side chain can be preferably utilized. Similarly to the case of the aforementioned monomer, acrylic acid or methacrylic acid ester is preferably used as the monomer unit having a hydroxyl group, and is exemplified by (2-hydroxy ethyl) acrylate, (2-hydroxy propyl) acrylate, (3-hydroxy propyl) acrylate, (4-hydroxy butyl) acrylate, (2-hydroxy butyl) acrylate, p-hydroxy methyl phenyl acrylate, p-(2-hydroxy ethyl)phenyl acrylate, or the same wherein the aforementioned acrylic acid is replaced by the methacrylic acid. Use of the acrylic acid-2-hydroxy ethyl acrylate, and 2-hydroxy ethyl methacrylate is preferred. Preferably 2 through 20% by weight, more preferably 2 through 10% by weight of the acrylic acid ester or methacrylic acid ester monomer unit having a hydroxyl group in the polymer is included in the polymer.

Aforementioned polymer including 2 through 20% by weight of monomer unit containing the aforementioned hydroxyl group provides excellent compatibility with cellulose ester, outstanding retentivity and dimensional stability, minimized moisture permeability, and prominent dimensional stability, superb adhesiveness with polarizer as a polarizing plate protective film and improved durability of the polarizing plate.

In the present invention, at least one of the terminals of the principal chain of the polymer preferably has a hydroxyl group. There is no restriction to the method of allowing a hydroxyl group to be provided on the terminal of the principal chain if such a method ensures a hydroxyl group to be formed on the terminal of the principle chain in particular. This method includes the method of using such a radical polymerization initiator including a hydroxyl group as azobis (2-hydroxy ethylbutylate), use of such a chain transfer agent having a hydroxyl group as 2-mercaptoethanol, and a polymerization terminator having a hydroxyl group. It also includes the method of ensuring the hydroxyl group to be provided on the terminal by living ion polymerization, and the method of bulk polymerization based on polymerization catalyst through the use of a compound containing one thiol group and secondary hydroxyl group or through the combined use of this compound and organic metal compound, as disclosed in JP-A No. 2000-128911 or 2000-344823. Use of the method disclosed in the Patent Publication is preferred in particular. The polymer manufactured by the method disclosed therein is available on the market under the tradename of Actflow Series manufactured by Soken Kagaku Co., Ltd. This is preferably used.

In the present invention, the polymer having a hydroxyl group on the aforementioned terminal and/or the polymer having a hydroxyl group on the side chain provides a substantial improvement of the miscibility and transparency of the polymer.

(Cellulose Ester)

Although there is no particular restriction to the cellulose as a material of the cellulose ester used in the present invention, a cotton linter, wood pulp and kenaf can be preferably employed. The cellulose esters obtained therefrom can be used independently or in the form mixed in desired proportions.

When the acylating reagent as a cellulose material is an acid anhydride (acetic anhydride, propionic anhydride or butyric anhydride), the cellulose ester of the present invention is subjected to reaction using an organic acid such as acetic acid or an organic solvent such as methylene chloride by means of a protonic catalyst such as sulfuric acid. When the acylating reagent is an acid chloride (CH₃COCl, C₂H₅COCl and C₃H₇COCl), reaction is carried out by a basic compound such as amine as a catalyst. To put it more specifically, synthesis can be performed according to the method described in JP-A No. 10-45804. In the cellulose ester, the acyl group reacts with the hydroxyl group of the cellulose molecule. The cellulose molecule is made up of a combination of multiple glucose units. Each glucose unit has three hydroxyl groups. The number of the acyl groups derived into the three hydroxyl groups is referred to as a substitution degree. For example, in the cellulose triacetate, the acetyl groups are linked to all the three hydroxyl groups of the glycol unit.

In the cellulose ester that can be used in the cellulose ester film, the substitution degree of the total acyl group is preferably 2.4 through 2.8.

The molecular weight of the cellulose ester used in the present invention has a number average molecular weight (Mn) of 50,000 through 200,000. The number average molecular weight (Mn) is preferably 60,000 through 200,000, more preferably 80,000 through 200,000.

In the cellulose ester used in the present invention, the ratio Mw/Mn of the weight average molecular weight (Mw) to the number average molecular weight (Mn) is preferably 1.4 through 3.0 as described above, more preferably 1.7 through 2.2.

The distribution of the average molecular weight and molecular weight of the cellulose ester can be measured in the commonly known technique using a high-speed liquid chromatography. This can be used to calculate the number average molecular weight and weight average molecular weight, and to get the ratio thereof (Mw/Mn).

The following describes the measuring conditions:

Solvent: methylene chloride

Column: Shodex K806, K805 and K803G (Three pieces manufactured by Showa Chemical Industry Co. Ltd. were connected for use)

Column temperature: 25° C.

Sample concentration: 0.1% by weight

Detector: Model 504 (manufactured by GL Science Co., Ltd.)

Pump: L6000 (manufactured by Hitachi Limited)

Flow rate: 1.0 ml/min.

Calibration curve: The calibration curve using 13 samples of the standard polystyrene STK standard polystyrene (manufactured by Toso Co., Ltd.) was used, wherein Mw=1000000 through 500. These 13 samples are preferably used at an approximately equally spaced interval.

The cellulose ester used in the present invention is a carboxylic acid ester having approximately 2 through 22 carbon atoms, and is particularly preferred to be a lower fatty acid ester of cellulose. The lower fatty acid of the lower fatty acid ester of cellulose refers to the fatty acid of 6 or less carbon atoms (per molecule), and is exemplified by the mixed fatty acid ester of cellulose acetate, cellulose propionate, cellulose butylate or cellulose acetate phthalate; and cellulose acetate propionate or cellulose acetate butylate disclosed in JP-A Nos. 10-45804 and 8-231761, and U.S. Patent No. 2, 319 and 052. Alternatively, ester of aromatic carboxylic acid and cellulose, or cellulose acylate thereof disclosed in JP-A Nos. 2002-179701, 2002-265639 and 2002-265638 is also preferably used. The lower fatty acid esters of cellulose preferably used in particular in the above description are cellulose triacetate and cellulose acetate propionate. A mixture of these cellulose esters can be used.

The preferred cellulose ester other than the cellulose triacetate is a cellulose ester having an acyl group having 2 through 4 carbon atoms as a substituent and meeting the following equations (a) and (b) simultaneously, assuming that the acetyl substitution degree is X, and the propionyl or butyryl substitution degree is Y:
2.4≦x+Y≦2.8 Equation (a)
0≦x≦2.5 Equation (b)

The portion without being replaced with acyl group normally takes the form of a hydroxyl group. The commonly known methods can be used for the synthesis thereof.

The acyl substitution degree can be measured according to the method specified in ASTM-D817-96.

In the case of acetyl cellulose, the time for acetylation reaction must be extended in order to improve the acetylation rate. However, if the reaction time is too long, decomposition will take place at the same time, resulting in disadvantages such as breakdown of the polymer chain or decomposition of the acetyl group. Thus, to improve the degree of acetylation and to reduce decomposition to some extent, the reaction time must be set within a certain range. Defining the reaction time is not a good step to be taken, because it may be seriously affected by varied reaction conditions and other conditions of the reaction apparatus and device. With the progress of polymer decomposition, the molecular weight distribution will become more extensive. In the case of the cellulose ester as well, the degree of decomposition can be specified in terms of the commonly employed weight average molecular weight (Mw)/number average molecular weight (Mn). To be more specific, the value for the weight average molecular weight (Mw)/number average molecular weight (Mn) can be used as one of the indicators for the degree of reaction which ensure sufficient time for acetylation reaction, without excessive progress of decomposition resulting from excessive reaction time in the process of acetylation of the cellulose triacetate.

The following describes an example of manufacturing the cellulose ester: Acetyl cellulose was prepared as follows: crushing 100 parts by weight of cotton linter as a cellulose material; adding 40 parts by weight of acetic acid; activating the substance in a pre-treatment step at 36° C. for 20 minutes; adding 8 parts by weight of sulfuric acid, 260 parts by weight of acetic anhydride and 350 parts by weight of acetic acid thereto; causing the substance to be esterified at 36° C. for 120 minutes, then to be neutralized by 11 parts by weight of aqueous solution containing 24% by weight of acetic acid magnesium, and then to be saponified and cured at 63° C. for 35 minutes. Further, the purified acetyl cellulose having an acetyl substitution degree of 2.75 was obtained by taking the further steps of stirring the solution for 160 minutes at the room temperature by a 1-to-10 acetic acid aqueous solution (acetic acid:water=1:1 (mass ratio)); and filtering and drying the solution. This acetyl cellulose had an Mw/Mn of 1.7, wherein Mn was 92, 000, and Mw was 156,000. In the similar manner, the cellulose ester having different substitution degree, Mw/Mn can be synthesized by adjusting the cellulose ester esterification conditions (temperature, time and stirring conditions) and hydrolysis conditions.

The cellulose ester having been synthesized is preferably refined to remove the low molecular weight components, or the unacetylated components are preferably removed from the ester.

The cellulose ester of mixed acid can be prepared by the method disclosed in JP-A No. 10-45804. The acyl substitution degree can be measured according to the provisions of ASTM-D817-96.

The cellulose ester is also affected by the trace of metallic components contained in the cellulose ester. This appears to be related to water used in the manufacturing process. The components that can be insoluble cores should be preferably minimized. The metal ions of iron, calcium and magnesium may produce insoluble substances by forming salts with the polymer decomposition products that may contain organic acid group, and should be minimized. It is preferred that the amount of iron (Fe) component should not exceed 1 ppm. A great amount of the calcium (Ca) component is contained in the underground water and river water. If water contains much calcium, it becomes hard water and is unfit for drinking. Not only that, together with such an acid component as carboxylic acid and sulfonic acid and many ligands, the water contains much calcium tends to form the coordinated compounds, namely, the complexes, as well as the scum (insoluble sediments and impurities) derived from a large amount of insoluble calcium.

It is preferred that the amount of the calcium (Ca) component should not exceed 60 ppm, or preferably should be in the range from 0 through 30 ppm. If the amount of the magnesium (Mg) component is excessive, insoluble components will also be produced. Accordingly, the amount of magnesium is preferably 0 through 70 ppm, more preferably 0 through 20 ppm. The metal component such as the iron (Fe), calcium (Ca) and magnesium (Mg) contents can be obtained by the analysis using the ICP-AES (inductively coupled plasma optical emission spectroscope) after the fully dried cellulose ester has been subjected to pre-treatment by alkali fusion using a micro-digest wet type decomposition apparatus (for decomposition of sulfuric acid and nitric acid).

(Organic Solvent)

A chlorine-based organic solvent and a non-chlorine organic solvent are available as the cellulose ester solution with the cellulose ester dissolved therein or organic solvent useful for formation of the dope. The methylene chloride can be mentioned as the chlorine-based organic solvent, and is fitted for dissolution of the cellulose ester, cellulose triacetate in particular. Studies have been made of the non-chlorine organic solvent for the purpose of solving the environment problems in recent years. The non-chloride organic solvents are methyl acrylate, ethyl acrylate, amyl acetate, acetone, tetrahydrofuran, 1,3-dioxolane, 1,4-dioxane, cyclohexanone, ethyl formate, 2,2,2-trifluoroethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, and nitroethane. When these organic solvents are used for the cellulose triacetate, the method of dissolution at the room temperature can be used. Further, use of high temperature dissolution method, low temperature dissolution method and high pressure dissolution method also preferably reduces the amount of insoluble substances. Methylene chloride can be used for the cellulose ester other than the cellulose triacetate. Methyl acrylate, ethyl acrylate and acetone are preferably utilized. Particularly use of the methyl a certain is preferred. In the present invention, the organic solvent capable of effectively dissolving the aforementioned cellulose ester is called the good solvent, and the organic solvent used in great quantity exhibiting the major effect in dissolution is called the major (organic) solvent.

The dope of the present invention preferably contains 1 through 40% by weight of alcohol of 1 through 4 carbon atoms (per molecule), in addition to the aforementioned organic solvent. After the dope is flow-cast over the metal support, the solvent starts to evaporate and the percentage of alcohol is increased. Then the dope membrane (web) starts to gelates to strengthen the web and to facilitate separation of the web from the metal support. These alcohols can be used as such a gelation solvent. Alcohols also work to accelerate dissolution of the cellulose ester of the non-chlorine organic solvent when the ratio of alcohols is less. Typical alcohols of 1 through 4 carbon atoms (per molecule) are methanol, ethanol, n-propanol, iso-propanol, n-butanol, sec-butanol and tert-butanol. Among these, ethanol is preferable because it excels at stability of dope and has a comparatively-low boiling point, good drying property, and little toxicity. These organic solvents are called poor solvents because they have no ability to dissolve cellulose derivatives.

The concentration of the cellulose ester in the dope is preferably 15 through 30% by weight, and dope viscosity is 100 through 500 Pa·s. Preparation within these ranges is important to ensure satisfactory film surface quality.

Additives added in the dope are a plasticizer, ultraviolet absorbent antioxidant, dye, and particles. In the present invention, additives other than particles can be added at the time of preparing the cellulose ester solution, or at the time of preparing the particle dispersion liquid. The plasticizer for improving resistance to heat and moisture, antioxidant and ultraviolet absorbent are preferably added to the polarizing plate used in the liquid crystal image display apparatus. The following describes these additives:

(Plasticizer)

The compound known as the so-called plasticizer is preferably added to the cellulose ester solution or dope of the present invention in order to improve mechanical properties, flexibility and resistance to water absorption, to reduce vapor transmittance and to adjust the retardation. For example, phosphoric acid ester and carboxylic acid ester are preferably utilized.

The phosphoric acid ester is exemplified by diphenyl phosphate, tricresyl phosphate, phenyl diphenyl phosphate.

The carboxylic acid ester is exemplified by phthalic acid ester and citric acid ester. The phthalic acid ester is exemplified by dimethyl phthalate, diethylphosphate, dioctylphthalate and diethyl hexylphthalate. The citric acid ester is exemplified by acetyltriethyl citrate and acetyl tributyl citrate. Further, oleic acid butyl, methyl acetyl ricinoleate, dibutyl sebacate, and triacetin can also be mentioned. Alkylphthalylalkyl glycolate can also be used for this purpose. The alkyl of alkylphthalylalkylglycolate is an alkyl group of 1 through 8 carbon atoms (per molecule). The alkylphthalylalkylglycolate is exemplified by methylphthalylmethyl glycolate, ethylphthalyl ethylglycolate, propylphthalylpropyl glycolate, butylphthalylbutyl glycolate, octylphthalyloctyl glycolate, methylphthalylethyl glycolate, ethylphthalyl methyl glycolate, ethylphthalylpropyl glycolate, propylphthalylethyl glycolate, methylphthalylpropyl glycolate, methylphthalylbutyl glycolate, ethylphthalylbutyl glycolate, butylphthalylmethylglycolate, butylphthalylethyl glycolate, propylphthalylbutyl glycolate, butylphthalylpropyl glycolate, methylphthalyloctyl glycolate, ethylphthalyloctyl glycolate, octylphthalyl methyl glycolate, and octylphthalylethyl glycolate. Use of methylphthalylmethyl glycolate, ethylphthalylethyl glycolate, propylphthalylpropyl glycolate, butylphthalylbutyl glycolate, and octylphthalyloctyl glycolate is preferred. Two or more types of the aforementioned alkylphthalylalkyl glycolate can be used in combination.

The aforementioned polyalcohol ester is also preferably used.

These compounds are contained in the cellulose ester in the amount of preferably 1 through 30% by weight, more preferably 1 through 20% by weight. To suppress bleed-out during the process of stretching and drying, the vapor pressure at 200° C. is preferably 1400 Pa or less.

These compounds can be added together with the cellulose ester and solvent before, during or after the process of preparing the cellulose ester solution.

Other additives are the polyester and polyester ether disclosed in JP-A No. 2002-22956, the urethane resin shown in JP-A No. 2003-171499, rosin, rosin derivative, epoxy resin, ketone resin, toluene sulfonamide resin described in JP-A No. 2002-146044, the ester of polyalcohol and carboxylic acid given in JP-A No. 2003-96236, the compounds defined by the general expression (1) of JP-A No. 2003-165868, and polyester polymer or polyurethane polymer of JP-A No. 2004-292696. These additives can be contained in the dope or particle dispersion liquid.

(Ultraviolet Absorbent)

The optical film of the present invention may contain an ultraviolet absorbent. The ultraviolet absorbents that can be used are oxybenzophenone compound, benzotriazole compound, salicylic acid ester compound, benzophenone compound, cyianoacrylate compound, nickel complex salt compound, and triazine compound. Use of the benzotriazole compound with less coloring is preferred. The ultraviolet absorbent disclosed in JP-A Nos. 10-182621, 8-337574 and 2001-72782, and the polymer ultraviolet absorbent disclosed in JP-A Nos. 6-148430, 2002-31715, 2002-169020, 2002-47357, 2002-363420 and 2003-113317 are also preferably used. The preferably used ultraviolet absorbent is the one having a wavelength 370 nm or less, characterized by excellent ultraviolet absorbing capability from the viewpoint of protecting the polarizer and liquid crystal against deterioration, and is the one having a wavelength of 400 nm or more without absorbing much visible light, from the viewpoint of ensuring a superb liquid crystal display performance.

The ultraviolet absorbent preferably used in the present invention is exemplified by the mixture of 2-(2′-hydroxy-5′-methylphenyl) benzotriazole, 2-(2′-hydroxy-3′,5′-di-tert-butylphenyl) benzotriazole, 2-(2′-hydroxy-3′-tert-butyl-5′-methyl phenyl) benzotriazole, 2-(2′-hydroxy-3′,5′-di-tert-butylphenyl)-5-chlorobenzotriazole, 2-(2′-hydroxy-3′-(3″,4″,45″,56″-tetrahydophthalimide methyl)-5′-methyl phenyl) benzotriazole, 2,2-methylene bis (4-(1,1,3,3-tetramethylbutyl)-6-(2H-benzotriazole-2-yl) phenol), 2-(2′-hydroxy-3′-tert-butyl-5′-methyl phenyl)-5-chlorobenzotriazole, 2-(2H-benzotriazole-2-yl)-6-(dodecyl on straight chain and side chain)-4-methylphenol, octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate, however, the present invention is not limited thereto. The commercially available products of TINUVIN 109, TINUVIN 171 and TINUVIN 326 (all are manufactured by Ciba Specialty Chemicals K.K) are preferably used. The high molecular ultraviolet absorbent is exemplified by the reactive ultraviolet absorbent RUVA-93 manufactured by Otsuka Chemicals Co., Ltd.

The specific examples of the benzophenone compound are 2,4-dihydroxy benzophenone, 2,2′-dihydroxy-4-methoxybenzophenone, 2-hydroxy-4-methoxy-5-sulfobenzophenone, and bis (2-methoxy-4-hydroxy-5-benzoylphenyl methane).

The aforementioned ultraviolet absorbent preferably used in the present invention is the benzotriazole ultraviolet absorbent and benzophenone ultraviolet absorbent characterized by a high degree of transparency and excellent effect in preventing the polarizing plate and liquid crystal device from deteriorating, and the benzo triazole ultraviolet absorbent characterized by less unwanted coloring.

The ultraviolet absorbent can be added to the dope by any method if the ultraviolet absorbent is dissolved in the dope. In the present invention, ultraviolet absorbent is dissolved in a good solvent such as methylene chloride, methyl acrylate or dioxolane capable of effectively dissolving the cellulose ester, or a mixed organic solvent made up of the good solvent and poor solvent such as a lower aliphatic alcohol (methanol, ethanol, propanol, butanol, etc.). This mixture as an ultraviolet absorbent solution is added to the cellulose ester solution, and is used as a dope. This method is preferably used in the present invention. In this case, it is preferred that the dope solvent composition and ultraviolet absorbent solution solvent composition should be the same or similar, wherever possible. The preferred amount of ultraviolet absorbent content is 0.01 through 5% by weight, particularly 0.5 through 3% by weight.

(Antioxidant)

A hindered phenol compound is preferably used as the antioxidant. This is exemplified by 2,6-di-t-butyl-p-cresol, pentaerithrityl-tetrakis [3-(3,5-di-t-butyl-4-hydroxy phenyl) propionate], triethylene glycol-bis [3-(3-t-butyl-5-methyl-4-hydroxy phenyl) propionate], 1,6-hexane diol-bis [3-(3,5-di-t-butyl-4-hydroxy phenyl) propionate], 2,4-bis-(n-octylthio)-6-(4-hydroxy-3,5-di-t-butylanilino)-1,3,5-triazine, 2,2-thio-diethylene bis [3-(3,5-di-t-butyl-4-hydroxy phenyl) propionate], octadesyl-3-(3,5-di-t-butyl-4-hydroxy phenyl) propionate, N,N′-hexamethylene bis (3,5-di-t-butyl-4-hydroxy-hydrocinnamide), 1,3,5-trimethyl-2,4,6-tris (3,5-di-t-butyl-4-hydroxy benzyl) benzene, and tris-(3,5-di-t-butyl-4-hydroxy benzyl)-isocyanulate. Especially the 2,6-di-t-butyl-p-cresol, pentaerithrityl-tetrakis [3-(3,5-di-t-butyl-4-hydroxy phenyl) propionate], and triethylene glyco-bis [3-(3-t-butyl-5-methyl-4-hydroxy phenyl) propionate) are preferably utilized. Further, a hydrazine metal deactivator such as N,N′-bis [3-(3,5-di-t-butyl-4-hydroxy phenyl) propionyl] hydrazine and a phosphorus based processing stabilizer such as tris (2,4-di-t-butylphenyl) phosphite can be used in combination. The amount of these compounds to be added to the cellulose ester is preferably 1 ppm through 1.0% by weight, more preferably 10 through 1000 ppm.

(Matting Agent)

In the present invention, particles can be further incorporated as a matting agent other than needle-shaped particles having a birefringent property. This can provide easier transportation and winding.

A particle diameter of a matting agent is preferably 10 nm-0.1 μm as primary particles or secondary particles. A nearly spherical matting agent having a needle-shape ratio of a primary particle of not more than 1.1 is preferably utilized.

The particles are preferably those containing silicon and specifically silicon dioxide. Particles of silicon dioxide preferable in the present invention include those available on the market under products name of Aerosil R972, R972V, R974, R812, 200, 200V, 300, R202, OX50 and TT600 (all are manufactured by Nippon Aerosil Co., Ltd.), and preferably utilized are Aerosil 200V, R972, R974, R202 and R812. An example of polymer particles includes silicone resin, fluorine resin and acrylic resin. Silicone resin is preferable and those having a three dimensional network structure are specifically preferable, and listed are Tosparl 103, 105, 108, 120, 145, 3120 and 240 (manufactured by Toshiba silicone Co., Ltd.).

Particles of silicon dioxide preferably have a mean primary particle diameter of not more than 20 nm and an apparent specific gravity of not less than 70 g/L. The mean particle diameter of primary particles is more preferably 5-16 nm and furthermore preferably 5-12 nm. The smaller is the mean primary particle diameter, the smaller is haze, which is preferable. The apparent specific gravity is more preferably 90-200 g/L and furthermore preferably 100-200 g/L. The larger is the apparent specific gravity, the higher concentration of particle dispersion is possible and haze and aggregation hardly generate, which is preferable.

The addition amount of a matting agent in the present invention is preferably 0.01-1.0 g, more preferably 0.03-0.3 g and furthermore preferably 0.08-0.16 g, based on cellulose ester film of 1 m².

(Surfactant)

In a dope or particle dispersion utilized in the present invention, preferably incorporated is a surfactant which includes such as a phosphoric acid type, a sulfonic acid type, a carboxylic acid type, a nonionic type and a cationic type, and is not specifically limited. These are described in such as JP-A 61-243837. The addition amount of a surfactant is preferably 0.002-2 weight % and more preferably 0.01-1 weight % based on cellulose ester. An addition effect is not sufficient when the addition amount is less than 0.001 weight %, while a surfactant may precipitate or generate insoluble matters when it is over 2 weight %.

A nonionic type surfactant is a surfactant provided with such as polyoxyethylene, polyoxypropylene, polyoxybutylene, polyglycidyl and sorbitane as a nonionic hydrophilic group and specifically includes polyoxyethylene alkylether, polyoxyethylene alkylphenylether, polyoxyethylene-polyoxypropylene glycol, polyhydric alcohol fatty acid partial ester, polyoxyethylene polyhydric alcohol fatty acid partial ester, polyoxyethylene fatty acid ester, polyglycerin fatty acid ester, fatty acid diethanolamide and triethanolamine fatty acid partial ester.

An anionic surfactant is carboxylate, sulfate, sulfonate and phosphoric acid ester salt and includes, as typical examples, fatty acid salt, alkylbenzene sulfonate, alkylnaphthalene sulfonate, alkylsulfonate, α-olefin sulfonate, dialkyl sulfosuccinate, α-sulfonated fatty acid salt, N-methyl-N-oleyltaurine, petroleum sulfonate, alkylsulfate, sulfated oil and fat, polyoxyethylene alkylether sulfate, polyoxyethylene alkylphenylether sulfate, polyoxyethylene styrenated phenylether sulfate, alkylphosphate, polyoxyethylene alkylether phosphate and naphthalenesulfonate formaldehyde condensate.

Cationic surfactants are such as amine salt, quaternary ammonium salt and pyridium salt, and include primary-tertiary aliphatic amine salt and quaternary ammonium salt (such as tetraalkyl ammonium salt, trialkylbenzyl ammonium salt, alkylpyridium salt and alkylimidazolium salt). Amphoteric surfactants are carboxybetaine and sulfobetaine, and include such as N-trialkyl-N-carboxymethyl ammoniumbetaine and N-trialkyl-N-sulfoalkylene ammoniumbetaine. A fluorine type surfactant is a surfactant provided with a fluorocarbon chain as a hydrophobic group. A fluorine type surfactant includes C₈F₁₇CH₂CH₂O—(CH₂CH₂O)₁₀—OSO₃Na, C₈F₁₇SO₂N(C₃H₇) (CH₂CH₂O)₁₆—H, C₈F₁₇SO₂N(C₃H₇)CH₂COOK, C₇F₁₅COONH₄, C₈F₁₇SO₂N(C₃H₇) (CH₂CH₂O)₄—(CH₂)₄—SO₃Na, C₈F₁₇SO₂N(C₃H₇) (CH₂)₃—N⁺(CH₃)₃.I⁻, C₈F₁₇SO₂N(C₃H₇) CH₂CH₂CH₂N⁺(CH₃)₂—CH₂COO⁻, C₈F₁₇CH₂CH₂O(CH₂CH₂O)₁₆—H, C₈F₁₇CH₂CH₂O(CH₂)₃—N⁺(CH₃)₃.I⁻, H(CF₂)₈—CH₂CH₂OCOCH₂CH(SO₃) COOCH₂CH₂CH₂CH₂ (CF₂)₈—H, H(CF2)₆CH₂CH₂O(CH₂CH₂O)₁₆—H, H(CF₂)₈—CH₂CH₂O(CH₂)₃—N⁺(CH₃)₃.I⁻, H(CF₂)₈—CH₂CH₂OCOCH₂CH(CF₂)₈(SO₃) COOCH₂CH₂CH₂CH₂C₈F₁₇, C₉F₁₇C₆H₄—SO₂N(C₃H₇) (CH₂CH₂O)₁₆—H and C₉F₁₇C₆H₄—CSO₂N(c₃H₇) (CH₂)₃—N⁺(CH₃)₃.I, however, is not limited thereto.

(Peeling Accelerator)

A peeling accelerator may be added in a dope to decrease a load at the time of peeling. They are preferably surfactants and include a phosphoric acid type, a sulfonic acid type, a carboxylic acid type, a nonionic type and a cationic type, however, are not limited thereto. These peeling accelerators are described in such as JP-A 61-243837. Polyethoxylated phosphoric ester is disclosed as a peeling accelerator in JP-A 57-500833. In JP-A 61-69845, it is disclosed that rapid peeling is possible by addition of mono- or di-phosphoric alkylester, a free acid form of which is a non-esterified hydroxyl group. Further, in JP-A 1-299847, it is disclosed that a peeling load can be reduced by addition of a phosphoric ester compound containing a non-esterified hydroxyl group and a propyleneoxide chain in addition to inorganic particles.

Further, a compound represented by following formula (2) or (3) is preferably incorporated.
(R₁—B₁—O)ₙ₁—P(═O)—(OM₁)ₙ₂ Formula (2)
R₂—B₂—X Formula (3)

wherein, R₁ and R₂ each are an alkyl group, an alkenyl group, an aralkyl group or an aryl group which is substituted or unsubstituted and has a carbon number of 4-40, respectively; M₁ is alkali metal, ammonia or lower alkylamine; B₁ and B₂ each are a divalent connecting group; X is carboxylic acid or salt thereof, sulfonic acid or salt thereof, or sulfuric ester or salt thereof; n1 is 1 or 2; and n2 is 3-n1.

The present invention is characterized by that cellulose acylate film contains at least one type of a peeling agent represented by formula (2) or (3). In the following, these peeling agents will be described. Preferable examples of R₁ and R₂ are a substituted or unsubstituted alkyl group having a carbon number of 4-40 (such as butyl, hexyl, octyl, 2-ethylhexyl, nonyl, dodecyl, hexadecyl, octadecyl, eichosanyl, docosanyl and myricyl), a substituted or unsubstituted alkenyl group having a carbon number of 4-40 (such as 2-hexenyl, 9-decenyl and oleyl), a substituted or unsubstituted aryl group having a carbon number of 4-40 (such as phenyl, naphthyl, methylphenyl, dimethylphenyl, trimethylphenyl, ethylphenyl, propylphenyl, diisopropylphenyl, triisopropylphenyl, t-butylphenyl, di-t-butylphenyl, tri-t-butylphenyl, isopentylphenyl, octylphenyl, isooctylphenyl, isononylphenyl, diisononylphenyl, dodecylphenyl and isopentadecylphenyl).

Among them, preferable are hexyl, octyl, 2-ethylhexyl, nonyl, dodecyl, hexadecyl and octadecyl as an alkyl group; oleyl as alkenyl; phenyl, naphthyl, trimetylphenyl, diisopropylphenyl, triisopropylphenyl, di-t-butylphenyl, tri-t-butylphenyl, isooctylphenyl, isononylphenyl, diisononylphenyl, dodecylisopentadecylphenyl as an aryl group.

Next, a divalent connecting group represented by B₁ and B₂ will be described. The connecting group is alkylene having a carbon number of 1-10, polyoxyethylene (polymerization degree of 1-50), polyoxypropylene (polymerization degree of 1-50), polyoxyglycerin (polymerization degree of 1-50) and may be mixtures thereof. Among them, preferable connecting groups are methylene, ethylene, propylene, butylenes, polyoxyethylene (polymerization degree of 1-25), polyoxypropylene (polymerization degree of 1-25) and polyoxyglycerin (polymerization degree of 1-15).

Next, X is carboxylic acid (or salt thereof), sulfonic acid (or salt thereof) or sulfuric ester (or salt thereof), and is specifically preferably sulfonic acid (or salt thereof) and sulfuric ester (or salt thereof). Preferable salt is Na, K, ammonium, trimethylamine and triethanol amine. In the following, specific examples of preferable compounds of the present invention will be described.

RZ-1 C₈H₁₇O—(P═O)—(OH)₂

RZ-2 C₁₂H₂₅O—(P═O)—(OK)₂

RZ-3 C₁₂H₂₅OCH₂CH₂O—(P═O)—(OK)₂

RZ-4 C₁₅H₃₁(OCH₂CH₂O)₅O—(P═O)—(OK)₂

RZ-5 {C₁₂H₂₅O(CH₂CH₂O)₅}₂—(P═O)—OH

RZ-6 {C₁₈H₃₅O(OCH₂CH₂O)₈O}₂—(P═O)—ONH₄

RZ-7 (t-C₄H₉)₃—C₆H₂—OCH₂CH₂O—(P═O)—(OK)₂

RZ-8 (iso-C₉H₁₉O—C₆H₄—O— (CH₂CH₂O)₅P (═O)—(OK)(OH)

RZ-9 C₁₂H₂₅SO₃Na

RZ-10 C₁₂H₂₅OS₃Na

RZ-11 C₁₇H₃₃COOH

RZ-12 C₁₇H₃₃COOH.N(CH₂CH₂OH)₃

RZ-13 iso-C₈H₁₇—C₆H₄—O—(CH₂CH₂O)₃—(CH₂)₂SO₃Na

RZ-14 (iso-C₉H₁₀)₂—C₆H₄—O—(CH₂CH₂O)₃—(CH₂)₄SO₃Na

RZ-15 sodium triisopropylnaphthalene sulufonate

RZ-16 sodium t-butylnaphthalene sulufonate

RZ-17 C₁₇H₃₃CON(CH₃) CH₂CH₂SO₃Na

RZ-18 C₁₂H₂₅C—C₆H₄SO₃.NH₄

The using amount of these compound is preferably 0.002-2 weight %, more preferably 0.005-1 weight % and furthermore preferably 0.01-0.5 weight %, in a dope. The addition method is not specifically limited, however, the compound may be added as liquid or solid as it is, as a solution in which the compound is added together with other material before dissolution, or may be added later into a cellulose acylate solution having been prepared in advance. Orientation of particles can be easily made uniform by incorporation of these compounds.

(Other Additives)

In addition to above-described additives, inorganic particles such as kaolin, talc, diatomaceous earth, quartz, calcium carbonate, barium sulfate, titanium oxide and alumina; salt of alkali earth metal such as calcium may be added as a thermal stabilizer. Further, such as an antistatic agent, a non-flammable agent, a sliding agent and oil agent may be also added.

<Solution Casting Method>

Cellulose ester film of the present invention is preferably cast by a solution casting method. Herein, a solution casting method will be explained with reference to FIG. 4. In FIGS. 4, 1 and 10 are dissolution vessels. 2 and 11 are solution sending pumps. 3, 6, 12 and 15 are filters. 4 and 13 are stock tanks. 5, 14 are solution sending pumps. 8 and 16 are guiding tubes. 20 is a junction tube. 21 is a stirrer. 30 is a die. 31 is a metal support. 32 is a web. 33 is a peeling position. 34 is a tenter. 35 is a roll drier. 36 is a transport roll. Further, 37 is roll film.

FIG. 4 is a schematic drawing to show an example of a dope preparation process, a casting process and a drying process of a solution casting method according to the present invention.

(1) Preparation Process of Needle-Shaped Particle Dispersion

A preparation method of needle-shaped particles of the present invention is not specifically limited, however, following method (a) or (b) is preferably employed.

a) An organic solvent and resin for dispersing needle-shaped particles are introduced into a dissolution vessel, and are stirred and dissolved to prepare a resin solution. Separately, a mixed solution comprising an organic solvent and needle-shaped particles is transported by a solution sending pump to a homogenizer such as a Manton-Gaulin homogenizer and a sand mill, whereby a pre-dispersion is performed. This is added into the aforesaid resin solution, and the resulting solution is stirred and filtered to eliminate aggregated matters to prepare particle dispersion, which is stocked (being somewhat different from FIG. 4). The prepared particle dispersion may be further subjected to dispersion and filtration several times.

b) An organic solvent and resin are charged in a dissolution vessel, and dissolved with stirring to prepare a resin solution, which is added with needle-shaped particles to be dispersed with a homogenizer (being not shown in the drawing) such as a Manton-Gaulin homogenizer or a sand mill, the resulting dispersion is sent to a filter with a solution sending pump to eliminate aggregated matters, whereby needle-shaped particles dispersion (similar operation may be repeated to circulate the dispersion several times). Then, the needle-shaped particle dispersion is transferred to a stock tank through a switching valve, being transferred with a solution sending pump after standing defoam, and is filtered through a filter followed by being transferred through a guide tube.

The needle-shaped particle dispersion may be further added with such as a plasticizer, an ultraviolet absorbent and a dispersant.

A homogenizer utilized to prepare needle-shaped particle dispersion of the present invention as described above is roughly classified into a media-less homogenizer and a media homogenizer, and either can be utilized.

A media-less homogenizer includes such as an ultrasonic type, a centrifugal type and a high pressure type; and a high pressure type is preferably utilized in the present invention. A high pressure homogenizer is an apparatus to generate a special condition such as a high share and a high pressure state by passing a composition, which is comprised of particles and a solvent being mixed, through a micro-tube at a high speed. By treating with a high pressure homogenizer, for example, it is preferable that the maximum pressure condition in a micro tube inside the apparatus is not less than 9.8×10⁶ Pa and more preferably not less than 19.6×10⁶ Pa. Further, in that case, the condition is preferably reaches the maximum speed of not less than 100 m/sec and a heat transfer rate of not less than 100 kcal/hr. A high pressure homogenizer as described above includes an ultra-high homogenizer produced by Microfluidics Corporation (product name: Microfluidizer) or Nanomizer or Ultraux produced by Nanomizer Corp. in addition to a Manton-Gaulin high pressure homogenizer such as a homogenizer produced by Izumi Food Machinary Co., Ltd. and UHN-01 produced by Sanwa Machine Co., Ltd.

A media homogenizer includes such as a ball mill, a sand mill and a dyno mill which perform dispersion by utilizing a collision power of media such as glass beads and ceramic beads. In the present invention, a media homogenizer is specifically preferably utilized.

Particle dispersion prepared in this manner is filtered to eliminate aggregated matters and foreign matters. A dope is prepared by utilizing the obtained particle dispersion.

(2) Preparation Process of Cellulose Ester Solution

In the present invention, a dope is prepared by mixing needle-shaped particle dispersion prepared according to the above method in advance, a solvent and cellulose ester. Specifically, after a part of a solvent and needle-shaped particle dispersion are charged with mixing in a dissolution vessel, it is preferable that the residual solvent and cellulose ester are added into the resulting dispersion with stirring and dissolved. Such as an additive and a plasticizer according to the present invention may be added in advance into a dissolution vessel or may be added later.

In another procedure, cellulose ester, an additive and a plasticizer according to the present invention may be added with stirring into a solvent in a dissolution vessel, and the aforesaid needle-shaped particles may be further added during dissolution of cellulose ester. Or a solvent and cellulose ester, preferably in addition to an additive and a plasticizer according to the present invention, are mixed to prepare a cellulose ester solution, to which the aforesaid needle-shaped particle dispersion may be added with stirring.

A method to prepare a cellulose ester solution will be further detailed.

Cellulose ester and an additive such as a plasticizer are dissolved with stirring into an organic solvent which primarily contains a good solvent for cellulose ester, in a dissolution vessel. For dissolution, there are various types of dissolution method such as a method in which dissolution is performed under an ordinary pressure, a method in which dissolution is performed at not higher than the boiling point of a primary solvent, a high temperature dissolution method in which dissolution is performed under pressure at not lower than the boiling point of a primary solvent, a cooling dissolution method in which dissolution is performed while cooling and a high pressure dissolution method in which dissolution is performed under a considerably high pressure, however, a high temperature dissolution method is preferably utilized in the present invention.

Cellulose ester solution prepared by mixing the aforesaid needle-shaped particle dispersion and cellulose, and preferably with an additive and a solvent according to the present invention, in a dissolution vessel, is sent to a filter by a pump to be filtered after cellulose has been dissolved.

Filtering is preferably performed with this cellulose ester solution by utilizing a suitable filter material such as filter paper for a filter press. As a filter material in the present invention, the smaller is absolute filtering precision, the more preferable to eliminate such as insoluble matters, however, there is a problem of easy generation of clogging of the filtering material when the absolute filtering precision is excessively small; therefore preferable is a filtering material having an absolute filtering precision of not more than 8 μm, more preferably in a range of 1-8 μm and furthermore preferably in a range of 3-6 μm. Filter paper includes products available on the market such as Nos. 244 and 277 manufactured by Azumi Filter Paper Co., Ltd., which are preferably utilized.

A filtering material of filtration is not specifically limited and ordinary filtering materials can be utilized, however, a filtering material made of plastic such as polypropylene and Teflon (a registered mark) and a filtering material made of metal such as stainless steel are preferable with respect to no drop out of fibers. Filtration can be performed by an ordinary method, however, a method to filter under pressure while being heated or kept warm in a temperature range of not lower than the boiling point under an ordinary pressure of an employed organic solvent and not to boil the organic solvent is preferable, with respect to decreased rise of a pressure difference (hereinafter, also referred to as a filtering pressure) between before and after a filtering material. The preferable temperature range depends on a utilized organic solvent, however, is 45-120° C., more preferably 45-70° C. and furthermore preferably 45-55° C. The lower the filtering pressure, the more preferable, and is preferably 0.3-1.6 MPa, more preferably 0.3-1.2 MPa and furthermore preferably 0.3-1.0 MPa.

The dope prepared in this manner is stored in a stock tank and utilized for casting after having being defoamed.

To prepare a dope by mixing needle-shaped particle dispersion and a cellulose ester solution in a dope vessel is a preferable method; however, it is also possible to in-line mix a cellulose ester solution and a part of or the whole of particle dispersion. For example, FIG. 4 shows an example of a process for in-line addition of needle-shaped particles dispersion. Needle-shaped particle dispersion is joined with a cellulose ester solution at confluence tube 20. A filter is arranged immediately before confluence tube 20 and such as lumps containing needle-shaped particles and large foreign matters, which are generated from the path, for example, accompanied with exchange of a filter material, can be eliminated from needle-shaped particle dispersion or a dope original solution during transportation. Herein, a filter made of metal having solvent resistance is preferably utilized. A filter material is preferably made of metal and specifically preferably made of stainless steel, with respect to durability. A filter material is preferably provided with a pore ratio of 60-80% with respect to clogging. To filter with a filter material made of metal having an absolute filtering precision of 30-60 μm and a pore ratio of 60-80% is most preferable, whereby coarse foreign matters can be surely eliminated for a long period. A metal filter material having an absolute filtering precision of 30-60 μm and a pore ratio of 60-80% includes such as NF-10, NF-12 and NF-13 of Finepore NF Series manufactured by Nippon Seisen Co., Ltd.

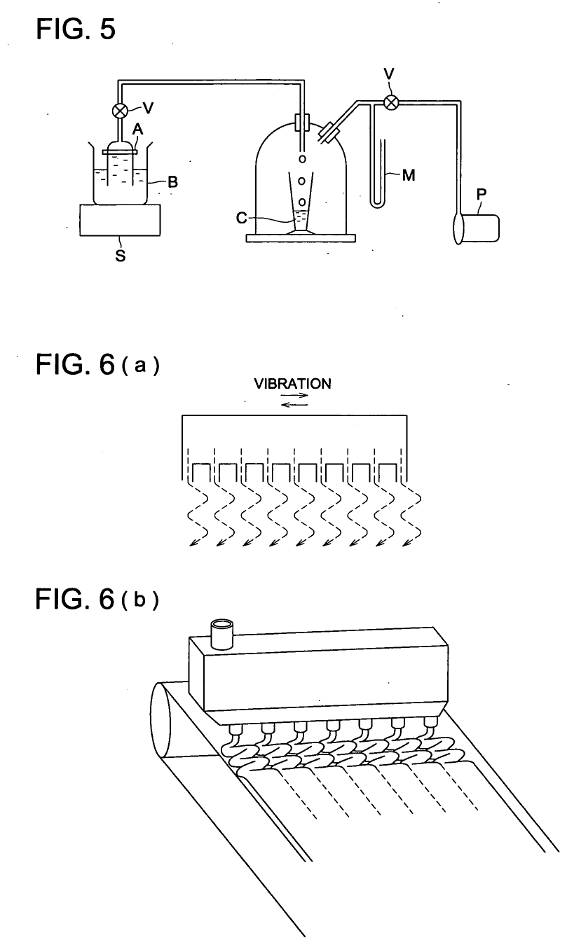

In the invention, an absolute filtering precision is defined as follows. Glass beads of test powder having different particle diameters defined in JIS Z 8901 and pure water are charged in a beaker, which is suction filtered by an apparatus as shown in FIG. 5 while being stirred with a stirrer. FIG. 5 is a schematic drawing to show an apparatus to measure an absolute filtering precision. Herein, “A” is a filter material to be measured, B is a solution to be filtered and C is a filtrate. Solution to be filtered B is stirred by stirrer S, and filtration is performed keeping a pressure of from atmospheric pressure to −4 kPa by use of low pressure vacuum pump P. V is a switching valve and M is a manometer. At this time, the number of glass beads in solution to be filtered B and filtrate C are observed through a microscope, and a particle capturing rate is determined. A particle diameter at the time of a particle capturing rate of 95% is designated as an absolute filtering precision.
Particle capturing ratio (%)=(number in solution to be filtered−number in filtrate)/(number in solution to be filtered)×100 Equation (6)

The pore ratio of the above-described filter material is preferably 60-80% and more preferably 65-75%. The larger is the pore ratio, the more preferred is it with respect to smaller pressure loss; while the smaller is the pore ratio, the more preferred is it with respect to excellent pressure resistance. To determine the pore ratio, first a filter material is immersed in a solvent having a low surface tension to eliminate air in the filter material, and the pore volume is determined from the increased volume of the solvent followed by being divided by the filter material volume to calculate the pore ratio.

(3) In-Line Addition Process

In the case of preparing a dope by mixing needle-shaped particle dispersion and cellulose ester, preferably with an additive and a solvent according to the present invention, needle-shaped particle dispersion is not necessarily in-line added. However, the whole of or a part of needle-shaped particle dispersion may be appropriately in-line mixed. In-line addition process will be explained with reference to FIG. 4: Cellulose ester solution and needle-shaped particle dispersion each are transferred by a solution sending pumps 5 and 14 to be filtered with a filters 6 and 15, and are transferred through guide tubes 8 and 16 to join the both solutions at confluence tube 20. Since the joined both solutions are transferred in a laminar state, it is difficult to mix the both solution as they are. Therefore, the both solution after having been joined, are transferred to the next process while being sufficiently mixed with mixer 21 such as an in-line mixer. As an in-line mixer utilizable in the present invention, for example, Static Mixer SWJ (Toray static in-line mixer, produced by Toray Engineering Co., Ltd.) is preferable.

In the present invention, it is preferable that stretching is performed in any one of drying processes described later and a birefringence of film having been stretched is measured to adjust the content of needle-shaped particles provided with a birefringent property in a dope depending on said measurement result of a birefringence. That is, in the case of the measurement result of a birefringence being shifted from a desired birefringence value being confirmed, and the reason is considered to be a smaller content of needle-shaped particles, it is preferable to further add the particles to compensate the shortage portion. In this case, an in-line addition process is preferably employed as a method to add the particles in a dope original solution. Specifically, there is a method in which needle-shaped particle dispersion provided with a birefringent property is in-line added into a dope to adjust a content of needle-shaped particle dispersion provided with a birefringent property in a dope. Specifically, it can be performed by use of the above-described in-line mixer. As needle-shaped particle dispersion to be in-line added (this may be also referred to as an in-line addition solution), needle-shaped particle dispersion prepared by the above-described method can be utilized as it is. In addition to this, a solution, which is prepared by further addition of such as a solvent, a cellulose ester solution and other additives to adjust the needle-shaped particles concentration and the cellulose ester concentration, can be utilized as an in-line addition solution. An in-line addition solution preferably contains needle-shaped particles at a concentration of 1.1-50 times of a particle concentration in a dope which is utilized for casting.

It is preferable to measure a birefringence of film having been stretched and to vary the addition amount of the aforesaid needle-shaped particle addition solution to adjust the content of particles in a dope, whereby a birefringence of film having been stretched is controlled to a desired value. Variation of the content of particles in a dope can be performed by changing a mixing ratio of needle-shaped particle addition solution and a dope original solution. To change the mixing ratio, the solution sending amounts of needle-shaped particle dispersion addition solution and a dope original solution may be changed.

A dope prepared by process (2) or by processes (2) and (3) is preferably adjusted to have a solid concentration in a dope of not less than 15 weight % and specifically preferably of 18-30 weight %. Since a viscosity of the dope may become too high to generate such as a shark skin at the time of casting resulting in deteriorated flatness when the solid concentration in a dope is excessively high, the solid concentration is preferably not more than 30 weight %.

(4) Casting Process

This is a process to send the dope, which has been prepared up to the above process, to die 30 and cast the dope on infinitely transported endless metal support 31, such as a stainless belt, or on metal support 31, which is comprised of such as a rotating metal drum, at a casting position from die 30. The surface of metal support 31 is a mirror surface. Die 30 (such as a pressure type die) is preferable because the slit form of a cap portion is adjustable to enable film thickness to be easily made uniform. Die 30 includes such as a coat hanger die and a T die, and either can be preferably utilized. To increase a casting speed, at least two sets of dice may be arranged on metal support 31 to multilayer coat while dividing the dope volume.

It is preferable to set the surface temperature of a metal support for casting to 10-55° C., the temperature of a dope to 25-60° C. and further the temperature of a solution to same as or not lower than the temperature of the support and more preferably to not lower than 5° C.

It is preferable that the higher are the solution temperature and the support temperature because drying rate of a solvent can be made fast, however, there may be caused foaming and deterioration of flatness when the temperatures are excessively high.

A more preferable temperature range of a support is dependent on an organic solvent, however, is 20-55° C. and a more preferable temperature range of a solution is 35-45° C.

(5) Solvent Evaporation Process

This is a process to heat web 32 (dope film after a dope is cast on a metal support is referred to as a web) on metal support 31 and to evaporate a solvent until enabling web 32 peelable from metal support 31. To evaporate a solvent, there are a method in which wind is blown from web 32 side and/or heat is transferred from the back side of metal support 31 by use of a liquid, and a method in which heat transfer from the front and back sides is performed by means of radiant heat, however, a method of back surface liquid heat transmission is preferable with respect to good drying efficiency. The combination of these methods is also preferable. In the case of back surface liquid heat transmission, it is preferable to heat at not higher than the boiling point of a primary solvent or an organic solvent having the lowest boiling point among organic solvents utilized in a dope.

(6) Peeling Process

This is a process to peel off web 32 a solvent of which has been evaporated on metal support 31 at peeling position 33. Web 32 having been peeled off is transported to the next process. Peeling-off may be difficult when a residual solvent amount (represented by the equation described later) is excessively large, while web 32 may be partly peeled off on the way when the web is peeled off after having been sufficiently dried on metal support 31. In the present invention, to peel off a thin web from a metal support without generating such as deterioration of flatness and uneven tension, it is preferable to perform peeling at a peeling tension of from the lowest tension enabling peeling off to 170 N/m and more preferably at not higher than 140 N/m.

A method to increase a casting speed (a casting speed can be increased because peeling off is performed at a residual solvent amount of as much as possible) is a gel casting method, which includes such as a method to add a poor solvent for cellulose ester into a dope to cause gelation, and a method to lower the temperature of metal support 31 to cause gelation. It is possible to accelerate peeling off to increase a casting speed by causing gelation on metal support 31 to increase the film strength at peeling. Web 32 on metal support 31 can be peeled off when a residual solvent amount is in a range of 5-150 weight % depending on the strength of a drying condition and the length of metal support 31, however, flatness at peeling-off may be deteriorated or uneven tension and longitudinal streaks are liable to be generated due to a peeling tension when web 32 is excessively soft in the case of peeling with more residual solvent, and the residual solvent amount at the time of peeling is determined considering the balance of economical speed and quality. Therefore, in the present invention, it is preferable to set a temperature at the peeling position on said metal support 31 to 10-40° C. and preferably to 15-30° C., and the residual solvent amount of web 32 at said peeling position is preferably 10-120 weight %.

To maintain good flatness of cellulose ester film during manufacturing, the residual solvent amount at the timer of peeled off of the web from a metal support is preferably set to 10-150 weight %, more preferably to 70-150 weight % and furthermore preferably to 100-130 weight %; The ratio of a good solvent in the residual solvent is preferably 50-90 weight %, more preferably 60-90 weight % and specifically preferably 70-80 weight %.

In the present invention, a residual solvent amount is represented by the following Equation (7).
Residual solvent amount (weight %)={(M−N)/N}×100 Equation (7)
wherein, M is a weight of a web at arbitrary time which is measured by the following gas chromatograph, N is a weight at the time after said M has been dried at 110° C. for 3 hours. The measurement is performed by a gas chromatograph connected with a head space sampler. In the present invention, measurement was performed by use of a gas chromatograph, 5890 Type SERISII and a head space sampler HP 7694, produced by Hewlett-Packard Company under the following measurement condition.

Head space sampler heating condition: 120° C., 20 minutes

GC introduction temperature: 150° C.

Temperature rise: 40° C., 5 minutes hold→100° C. (8° C./min)

Column: DW-WAX manufactured by J & W Company (inner diameter of 0.32 mm, length of 30 m)

(7) Drying Process

After having been peeled off, generally, web 32 is dried by use of roll drying apparatus 35 which transfer web 32 by alternately passing through plural number of rolls, and tenter apparatus 34 which transfer web 32 by clipping the both edges thereof. In FIG. 4, roll drying apparatus 35 is arranged after tenter apparatus 34; however, the present invention is not limited to this arrangement. As a drying means, to blow hot wind on the both surfaces of a web is generally applied; however, there is a means to heat by irradiating microwaves instead of wind. Excessively rapid drying is liable to damage flatness of film. Throughout the process, drying temperature is generally in a range of 40-250° C. Drying temperature, drying wind volume and drying time are differs depending on a utilized solvent and a drying condition is suitably selected depending on the type and combination of a utilized solvent. 37 is a finished rolled cellulose ester film. In a drying process of cellulose ester film, the film is wound at a residual solvent amount of preferably not more than 0.5 weight % and more preferably not more than 0.1 weight %.

Cellulose ester film of the present invention is cast by a casting process after a dope added with needle-shaped particles has been prepared, and a method to orient added needle-shaped particles includes a method, in which film is stretched in the TD or MD direction at the time of film preparation, or a method, in which a flow of a dope is formed at the time of casting and orient needle-shaped particles along this flow. Further, it is also possible to accelerate orientation of needle-shaped particles by such as an electric field and a magnetic field.

In the following, a specific method to orient needle-shaped particles will be described.

In the present invention, MD represents the cellulose ester film casting direction and TD represents the direction perpendicular to the casting direction in the cellulose ester film plane. Therefore, in the case of rolled cellulose ester film, MD is the film length direction and TD is the film width direction.

(Method to Arrange Needle-Shaped particles in TD Direction)

Cellulose ester film of the present invention can be prepared by the following manufacturing method.

(A) A manufacturing method of cellulose ester film containing needle-shaped particles having a birefringent property by a solution casting method, wherein at the time of ejecting a dope containing needle-shaped particles having a birefringent property, cellulose ester and a solvent, from a nozzle on a casting support, said dope is cast on a casting support while moving said nozzle along the direction not parallel to the transfer direction of the casting support.

In this case, plural nozzles are preferably arranged along the width direction (FIG. 6 (a)). Therefore, needle-shaped particles are oriented by ejection of a dope on a casting support (FIG. 6 (b)) while a coater equipped with the aforesaid nozzles is moved back and forth or vibrated, along the direction perpendicular to the transfer direction of a casting support.

It is preferable to smoothen dope film on a casting support by successive casting of a cover layer to accumulate dopes by use of the aforesaid coater equipped with nozzles or an ordinary die.

Further,

(B) A manufacturing method of cellulose ester film containing needle-shaped particles having a birefringent property by a solution casting method, wherein at the time of ejecting a dope containing needle-shaped particles having a birefringent property, cellulose ester and a solvent, from a die on a casting support, the utilized die has a structure in which a dope flows in the die along the direction not parallel to the transfer direction of a casting support.

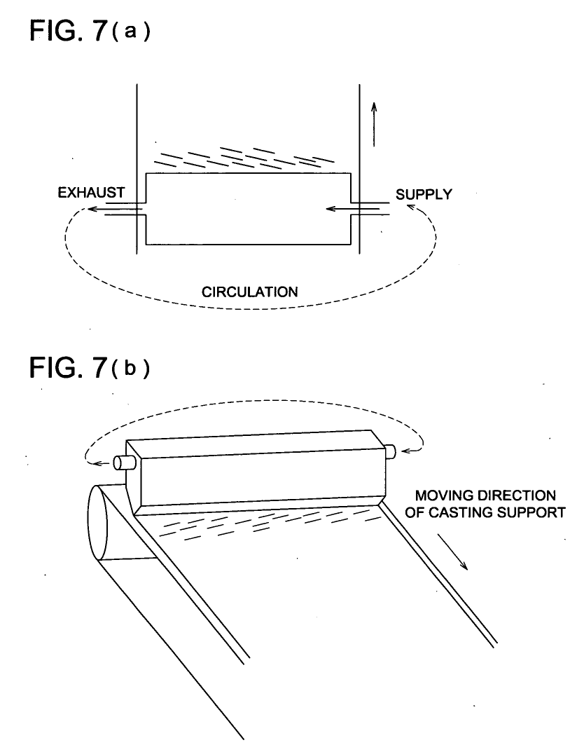

For example, utilized is a die in the interior of which a dope supply portion and a dope ejection portion are arranged not parallel to the transfer direction of a casting support (FIG. 7).

Preferably, a dope supply portion and a dope ejection portion in the interior of a die are arranged almost perpendicular to the transfer direction of a casting support. Thereby, a dope is made flow not parallel to the transfer direction of a casting support and a part of the flow is ejected on the casting support from the die. Preferably, a dope once ejected from a dope ejection portion is recycled and returned again to a dope supply portion. Thereby needle-shaped particles in a dope, which has been ejected on a casting support, can be oriented

Also with respect to this, a dope can be cast (a cover layer) by means of successive casting to be smoothened by utilizing one more coater. In this case, a structure of a coater to cast a cover layer is preferably made symmetric with respect to the MD direction against a coater which has previously performed casting. Thereby uniformity of orientation can be achieved.

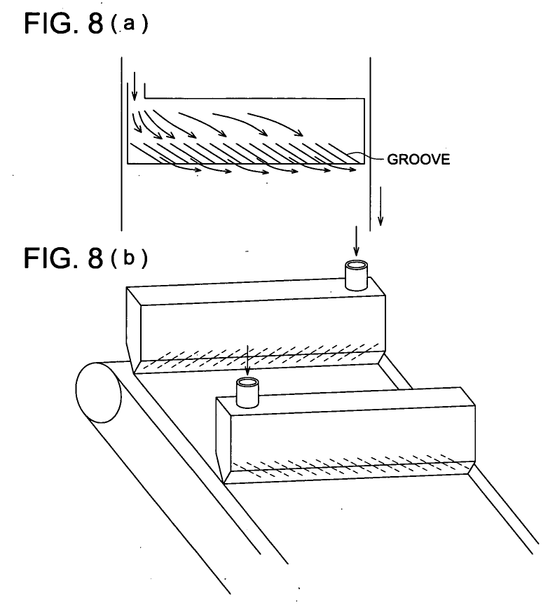

Further, grooves may be provided in the interior of a die slit along the direction not parallel to the transfer direction of a casting support (FIG. 8 (a)). Thereby, a flow along the grooves is generated in the interior of a die at the time of casting, which enables a dope as a state of needle-shaped particles being oriented in the TD direction to be cast. Also with respect to this, it is preferable to achieve uniformity of orientation and smoothness by casting a dope by means of successive casting employing another die which is provided with grooves along the opposite direction in the interior of the slit (FIG. 8 (b)).

(C) A manufacturing method of cellulose ester film containing needle-shaped particles having a birefringent property by a solution casting method, wherein a dope containing needle-shaped particles having a birefringent property, cellulose ester and a solvent is rubbed on a casting support along the direction not parallel to the transfer direction of a casting support (that is, to push a part material against a web to determine the direction of a layer).

A part material to rub is not specifically limited, and includes such as a gravure roll on which slant lines have been cut and an orientation belt separately arranged. Thereby, share is given to a dope, resulting in orientation of needle-shaped particles.

Next, one embodiment is as follows:

(D) A manufacturing method of cellulose ester film containing needle-shaped particles having a birefringent property by a solution casting method, wherein at the time of casting a dope containing needle-shaped particles having a birefringent property, cellulose ester and a solvent on a casting support, a dope is cast so as to be rubbed (to be pressed) along the direction not parallel to the transfer direction of a casting support by use of a gravure roll.

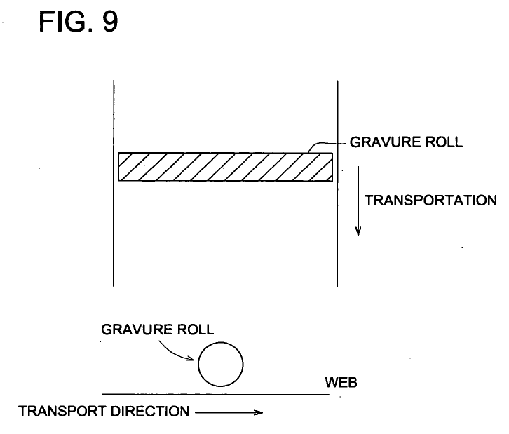

In this method, a gravure roll, on the surface of which slant lines have been cut, is utilized. In FIG. 9, doted lines indicate slant line grooves cut on the gravure roll.

A dope is cast on a support so as to be provided with a gravure texture along the width direction or the diagonal direction by a gravure roll. Specifically, by use of a slant lined gravure roll, the rotation speeds of a casting support and a gravure roll are controlled so as to provide a gravure texture along the width direction or the diagonal direction.

When rotation speeds of a web and a support are 1/1, provided are diagonal lines as those cut on a gravure roll as they are, however, since diagonal angle changes by making a difference between circumferential speeds, the rotation speeds of the casting support and the gravure roll can be controlled so as to provide a gravure texture in the width direction.

A gravure roll may be arranged perpendicular or being inclined to the casting direction.

(E) A manufacturing method of cellulose ester film containing needle-shaped particles having a birefringent property by a solution casting method, wherein at the time of casting a dope containing needle-shaped particles having a birefringent property, cellulose ester and a solvent by use of a die on a casting support, a dope on a casting support is pressed by a part material which transfers in the direction not parallel to the transfer direction of a casting support.

A part material, which transfers in the direction not parallel to the transfer direction of a casting support, is an orientation belt.

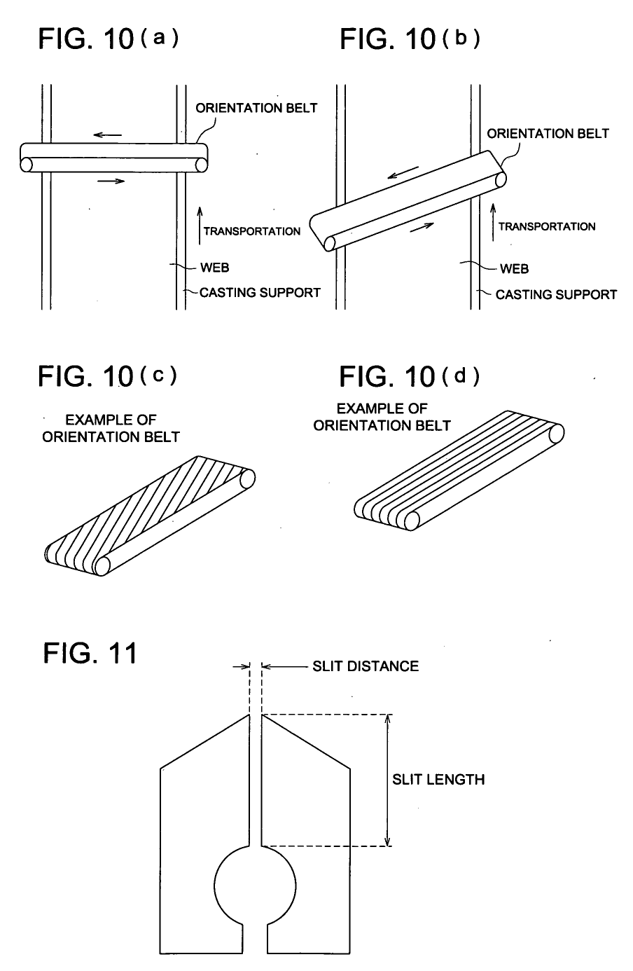

This is shown in FIG. 10, and a cast web is rubbed by an orientation belt as an example of the aforesaid part material. The surface of an orientation belt is preferably provided with a structure comprising grooves cut on the surface to accelerate orientation similar to the aforesaid gravure roll. Grooves of an orientation belt are cut inclined against the transfer direction of the orientation belt (FIG. 10 (a)). In this case, similar to the aforesaid gravure roll, orientation can be adjusted to the width direction by controlling the transfer speed of an orientation belt and the casting speed of a dope (that is the transfer speed of a casting support).

Further, the grooves of an orientation belt may be cut along the rotation direction of the belt, and in this case, similar effect can be achieved by arranging the orientation belt to provide an angle so that the rotation direction of the orientation belt is not parallel to the transport direction of a web (FIG. 10 (b)).

The grooves cut on a gravure roll are provided with an interval of a range of 25-250 lines/inch (2.54 mm) and preferably of 50-150 lines/inch, a curving depth of approximately 30-500 μm and a curving angle of 45°±15°.

Further, it is similar also with grooves cut in the interior of a slit of a die and grooves cut on an orientation belt.

(F) A manufacturing method of cellulose ester characterized by that a cellulose ester solution containing needle-shaped particles having a birefringent property is cast on a support, and a web is dried after having been stretched while containing a solvent.

A web in a state of containing a solvent, after having been peeled off, is laterally stretched, whereby film, in which needle-shaped particles are oriented, can be prepared. Further, a web containing a solvent may be stretched together with a support by use of such as a resin casting support.

However, since this method is sometimes insufficient, it is preferable to be utilized in combination with the above described method.

By orienting needle-shaped particles in the TD direction according to the above manner, cellulose ester film, which is specifically preferably utilized for a liquid crystal display of an in-plane switching mode, can be prepared.

Next a method to arrange needle-shaped particles in the MD direction will be described.

(Method to Arrange Needle-Shaped Particles in MD Direction)

(G) A manufacturing method of cellulose ester film containing needle-shaped particles having a birefringent property by a solution casting method, wherein at the time of ejecting a dope containing needle-shaped particles having a birefringent property, cellulose ester and a solvent from a die on a casting support, a dope ejected as a laminar flow parallel to the transfer direction of a casting support is cast on a casting support.

A laminar flow and a turbulent flow are defined based on a Reynolds' number (Re). A Reynolds' number is defined by the following non-dimensional number when a typical length is D, a speed is U, a specific density is ρ and a coefficient of viscosity is η:
Re=DUρ/η

Generally, it is said to be a laminar flow when Re<2,300, a transition region when 2,300<Re<3,000 and a turbulent flow when Re>3,000. In the present invention, a particle diameter, a casting speed and a specific density of a dope are controlled.

For example, FIG. 11 is a cross-sectional drawing of a die utilized for casting, and it is preferable that by setting a slid gap (generally 400-1,000 μm) to slightly narrower such as not more than 350 μm and a slit length to longer than an ordinary case (10-30 mm) such as not less than 35 mm at the above described slit width, whereby needle-shaped particles in a dope can be oriented utilizing a laminar flow portion in the interior of a die. Further, although not shown in the drawing, by stepwise narrowing a slit gap in the interior of a die, a share is given to a dope, whereby needle-shaped particles are oriented.

(H) A manufacturing method of cellulose ester film containing needle-shaped particles having a birefringent property by a solution casting method, wherein at the time of ejecting a dope containing needle-shaped particles having a birefringent property, cellulose ester and a solvent from a die on a casting support, a ribbon of a dope ejected as a laminar flow parallel to the transfer direction of a casting support is cast so as to be pulled by a casting support.

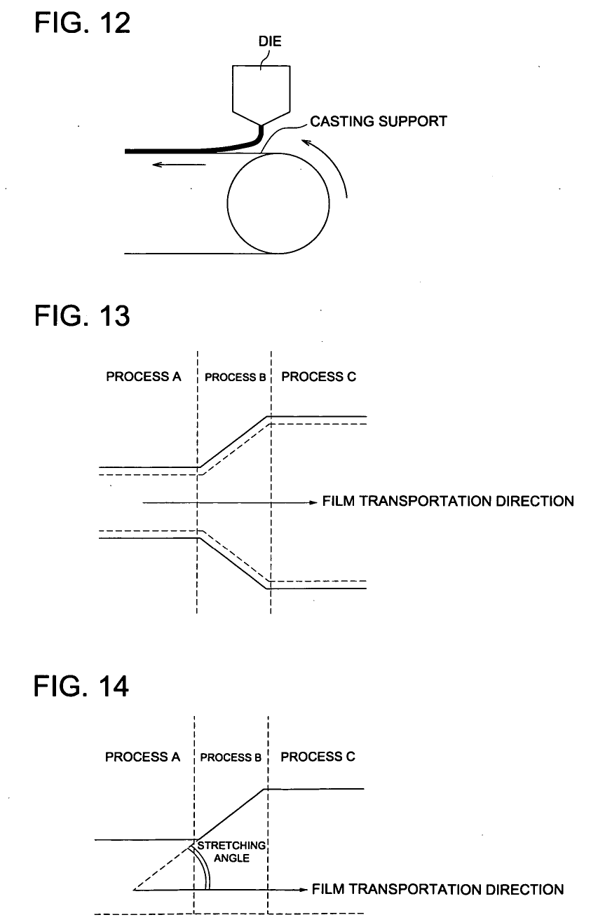

FIG. 12 shows said manufacturing method. In the drawing, stretching is performed by pulling the ribbon due to a difference of an ejection rate of a dope and a transport rate of a support (belt).

Further, similar to (F), orientation can be achieved by stretching a web in a MD direction while containing a solvent. However, in this method, other method is preferably utilized in combination since this method may not achieve sufficient orientation. Further, this method cannot perform orientation in the TD direction.

Next, a stretching process of the present invention will be described.

(8) Stretching Process (also referred to as Tenter Process)

Cellulose ester film of the present invention can exhibit a birefringent property by stretching. Stretching can be performed in a state of containing a solvent at the time of manufacturing by a solution casting method, or film in a state of solvent having been dried can be stretched. The temperature at stretching is preferably from “a glass transition temperature −20° C.” to “not higher than fluidized temperature” of film. Herein, a glass transition temperature of film can be measured by a method well known in the art. Stretching can be performed in the casting direction or in the width direction, however, in the present invention, is preferably performed in the width direction.

By stretching, cellulose ester exhibits a birefringent property and needle-shaped particles are oriented in the stretching direction at a higher ratio. The birefringence value of cellulose ester film is considered to be a sum value of a birefringence of cellulose resin and a birefringence due to orientation of needle-shaped particles having a birefringent property. In this manner, stable manufacturing of cellulose ester film having characteristics, which has been conventionally difficult to be manufactured, has come to be possible.

According to the present invention, cellulose ester film having retardation value Ro in a range of 105 nm≦Ro≦350 nm and Nz in a range of 0.2≦Nz≦0.7, and more preferably having Rth in a range of −30 nm≦Rth≦+20 nm, which has been conventionally difficult to be manufactured, has come to be possible to be manufactured. Furthermore, cellulose ester film of the present invention can form film having a slow axis perpendicular to the width direction, or in the casting direction, even having been stretched in the width direction by utilizing needle-shaped particles having a negative birefringence. By employing this cellulose ester film as a polarizing plate protective film, a polarizing plate, which can restrain light leak at oblique 45 degrees and increase contrast, can be provided, whereby a viewing angle of a liquid crystal cell of an in-plane switching mode has been significantly improved. Herein, an in-plane switching mode liquid crystal display also includes a fringe-field switching (FFS) mode other than an IPS mode, and the viewing angle can be significantly improved similar to an IPS mode.

Herein, the above-described Ro, Rth and Nz were measured by use of an automatic birefringence meter KOBRA-21 ADH (produced by Oji Measurement Instruments Co., Ltd.), retardation at 590 nm being measured under an environment of 23° C. and 55 RH %, and further a value of a mean refractive index of a sample having been measured by use of an Abbe's refractive index meter was input into the following equation to determine values of retardation in the plane Ro, a retardation in the thickness direction Rth, and Nz.
Ro=(nx−ny)×d
Rth={(nx+ny)/2−nz}×d
Nz=(nx−nz)/(nx−ny)
(wherein, a refractive index in the slow axis direction in a plane is nx, a refractive index in the direction perpendicular to the slow axis in a plane is ny, a refractive index in the film thickness direction is nz, and d is a film thickness (nm).)

In this manner, preferably obtained can be cellulose ester film having a retardation value of the present invention, as well as cellulose ester film having excellent flatness. This width holding or stretching in the width direction in a casting process is preferably performed by a tenter, and a tenter may be either a pin tenter or a clip tenter.

A stretching process will now be further detailed. The stretching ratio at the time of manufacturing of cellulose ester film is 1.01-3 times and preferably 1.5-3 times along the casting direction or the width direction. In the case of biaxial stretching, the stretching ratio in a higher stretching direction is 1.01-3 times and preferably 1.5-3 times and the stretching ratio in the other direction is 0.8-1.5 times and preferably 0.9-1.2 times.

Further, cellulose ester film containing needle-shaped particles is liable to increase haze, and specifically, haze will increase when the stretching ratio is high. However, cellulose ester film of the present invention, characterized by containing at least one type of an additive selected from polyester, polyhydric alcohol ester, polycarboxylic ester and polymer prepared by polymerization of ethylenically unsaturated monomer, exhibits small increase of haze even when being stretched at a ratio as high as not less than 1.5, and can be preferably utilized as retardation film. A haze value of film is preferably not more than 2%, more preferably not more than 1.5% and most preferably not more than 1.0%.

An example of a stretching process for preparation of optical compensation film according to the present invention will be explained with reference to FIG. 13.

In FIG. 13, process A is a process to hold film transported from film transport process D0, which is not shown in the drawing, and film is stretched in the width direction (the direction perpendicular to the progressive direction of film) in the following process B as shown in FIG. 14; process C is a process to transport film while being held after finish of stretching.

From after film peeling to before the start of process B and/or immediately after process C, a slitter to cut down the edges of the film width direction is preferably provided. In particular, a slitter to cut down the film edges is preferably provided immediately before the start of process A. When the same stretching in the width direction is carried out to compare the case to cut off the film edges before the start of process B and the case not to cut off the film edges are compared, the former exhibits an improvement effect of the distribution of an optical slow axis (hereinafter, referred to as azimuth angle distribution).

This is considered to be an effect of restraining unintended stretch in the longitudinal direction during from the peeling-off, where a residual solvent amount is relatively large, to width stretching process B.

In a tenter process, it is also preferable to intentionally provide zones having different temperatures to improve an azimuth angle distribution. Further, it is also preferable to provide a neutral zone between the zones having different temperatures not as to cause interference between said zones each other.

Stretching operation may be performed by being divided into plural steps, and biaxial stretching in the casting direction and the width direction is preferably performed. Further, in the case of biaxial stretching, either simultaneous biaxial stretching or stepwise stretching is possible. In this case, stepwise means that stretching in different directions may be performed successively or stretching in one direction is divided into plural steps and stretching in the different direction may be added to any one of said steps. Further, in biaxial stretching, stretching in one direction is performed and tension is relaxed in the other direction to perform shrinkage.

Further, a stretching direction in the present invention generally means the direction in which stretching stress is directly applied in the case of stretching operation, however, means the direction in which a stretching ratio finally has come to be larger in the case of biaxial stretching.

In the case of stretching cellulose ester film in the width direction, it is well known that an azimuth angle may be deteriorated. To keep a certain ratio of values of Rth and Ro and to perform width stretching keeping a good state of azimuth angle distribution, there is a preferable interrelation of temperatures of processes A, B and C. It is preferable that Ta≦Tb-10 when film temperatures at the end points of processes A, B and C are Ta ° C., Tb ° C. and Tc ° C., respectively. Further, it is preferable that Tc≦Tb. It is more preferable that Ta≦Tb−10 and Tc≦Tb.

A temperature raising rate in process B is preferably in a range of 0.5-10° C./s to make a good azimuth angle distribution.

The shorter is a stretching time in process B, the more preferable, to minimize a dimension change at 80° C. and 90% RH. However, in view of film uniformity, the minimum required stretching time is defined. Specifically, it is preferably in a range of 1-10 seconds and more preferably 4-10 seconds. Further, the temperature of process B is 40-180° C. and preferably 100-160° C.

In the above-described tenter process, a coefficient of heat transfer may be either constant or varied. The coefficient of heat transfer is preferably in a range of 41.9-419×10³ J/m² hr, more preferably in a range of 41.9-209.5×10³ J/m² hr and most preferably in a range of 41.9-126×10³ J/m² hr.

To improve dimension stability under a condition of 80° C. and 90% RH, the stretching rate in the width direction in above-described process B may be either constant or varied. A stretching rate is preferably 50-500%/min, more preferably 100-400%/min and most preferably 200-300%/min.

In a tenter process, it is preferable that a temperature distribution in the width direction is small with respect to increasing uniformity of film, and a temperature distribution in the width direction in a tenter process is preferably within ±5° C., more preferably within ±2° C. and most preferably within ±1° C. By decreasing the above-described temperature distribution, it is expected that a temperature distribution in the film width direction may also become smaller.

In process C, relaxation in the width direction is preferably performed to restrain a dimensional change. Specifically, the film width is preferably adjusted to a range of 95-99.5% of the film width at the previous process.

It is preferable to provide a post-drying process (hereinafter, referred to as process D) after film has been processed in a tenter process. The process is preferably operated at 50-160° C., more preferably in a range of 80-150° C. and most preferably in a range of 110-150° C.

To keep a narrow environmental temperature distribution in the film direction is preferable with respect to increasing uniformity of the film. It is preferably within ±5° C., more preferably within ±2° C. and most preferably within ±1° C.

The film transport tension in process D1 is affected by such as physical properties of a dope, residual solvent amounts at peeling-off and at process D0, and temperature at process D1, however, is preferably 120-200 N/m, more preferably 140-200 N/m and most preferably 140-160 N/m.

A tension cut roll is preferably provided for the purpose of preventing elongation of film in the transport direction in process D1. After drying, it is preferable to cut down the edge portions by providing a slitter before winding to obtain a good roll form.

In the present invention, when cellulose ester film is a long length form, the slow axis of cellulose ester film preferably coincides with the transport direction. To realize this, cellulose ester film containing needle-shaped particles having a negative birefringence is continuously stretched in the width direction, whereby a slow axis is formed along the transport direction. Since a PVA polarizer of a long length form has the absorption axis in the longitudinal direction and cellulose ester film applied as polarizing plate protective film has the slow axis in the longitudinal direction, the both can be arranged to be directly pasted up. This is a preferable constitution with respect to productivity of a polarizing plate.

(9) Winding Process

This is a process to wind up a web having been dried as film. The residual solvent amount to finish drying is set to preferably not more than 0.5 weight % and preferably not more than 0.1 weight % to prepare film having excellent dimension stability. As a winding method, a generally utilized winder may be employed, and listed is a method to control the tension such as a constant torque method, a constant tension method, a tapered tension method, and a programmed tension control method with a constant inner stress, which may be employed by suitable selection. A residual solvent amount is represented by above-described Equation (7).

A thickness of cellulose ester film differs depending on the application purpose, however, is preferably in a range of 10-150 μm, more preferably 30-100 μm and specifically preferably 40-80 μm, as finished film in view of achieving a thin liquid crystal display. When the thickness is excessively thin, a required strength may not be achieved, for example, as polarizing plate protective film. While, when the thickness is excessively thick, advantages of a thinner layer against conventional cellulose ester film will be lost. To adjust the layer thickness, such as a dope concentration, a flow rate of a pump, a slit gap of a die cap, an ejection pressure of a die and a speed of metal support are preferably controlled so as to make a desired thickness. Further, as a means to make a uniform layer thickness, it is preferable to perform adjustment by feeding the programmed feedback information back to the above-described each apparatus.

In processes, from immediately after casting to drying, throughout a solution casting method, the atmosphere in the drying apparatus may be air, however, may be also an inert gas atmosphere comprising such as a nitrogen gas and a carbonic acid gas. Herein, it is natural that danger with respect to a limit of inflammability of an evaporated solvent in a drying atmosphere should be always in consideration.

Next, the case, in which optical film (preferably cellulose ester film) of the present invention is utilized for an in-plane switching mode liquid crystal display, will be explained. Herein, optical film of the present invention is referred to as optical film-A. In the present invention, optical film-A is utilized as cellulose ester film which is arranged on the liquid crystal cell side of a polarizing plate employed in a liquid crystal panel of an in-plane switching mode, and is preferably satisfies the relationship of nx (a)>nz (a)>n (a) when a refractive index in the slow axis direction in the film plane is nx (a), a refractive index in the direction perpendicular to x in the film plane is ny (a), a refractive index in the thickness direction is nz (a) and a thickness of film is d (nm), as well as retardation value Ro represented by following Equation (i) is preferably satisfies 105 nm≧Ro (a)≧350 nm and Nz represented by following Equation (ii) preferably satisfies 0.2<Nz<0.7. Specifically, in the case of optical film of the present invention being cellulose ester film, nx (a) is preferably in the casting direction of optical film-A.
Ro(a)=(nx(a)−ny(a))×d Equation (i)
Nz=(nx(a)−nz(a))/(nx(a)−ny(a)) Equation (ii)
Rth={(nx(a)+ny(a))/2−nz(a)}×d Equation (iii)

Further, a polarizing plate of the present invention employs the above-described optical film as a protective film and the slow axis of said optical film is preferably arranged practically parallel to or perpendicular to the absorption axis of the polarizing plate.

Further, it is specifically preferable that one of polarizer plates sandwiching a liquid crystal cell of an in-plane switching mode is the above-described polarizing plate as well as polarizing plate protective film arranged on the liquid crystal cell side of the other polarizing plate satisfies the optical values of −15 nm≦Ro≦15 nm, −15 nm≦Rth (a)≦15 nm wherein Rth is represented by above Equation (iii) because an in-plane switching mode liquid crystal display having more improved viewing angle properties is obtained.

Next, optical film-B, which is preferable in the present invention, will be explained.

Optical film-B preferable in the present invention is an optical film arranged on the liquid crystal cell side of the polarizing plate other than the polarizing plate employing the optical film of the present invention, the two polarizing plates sandwiching an in-plane switching mode liquid crystal cell. Retardation values Ro (b) and Rth (b) of optical film-B represented by Equations (iv) and (v), respectively, satisfy optical values of −15 nm≦Ro (b)≦15 nm, −15 nm≦Rth (b)≦15 nm.
Ro(b)=(nx(b)−ny(b))×d Equation (iv)
Rth={(nx(b)+ny(b))/2−nz(b)}×d Equation (v)
wherein, nx (b) is a refractive index in the slow axis direction in the film plane, ny (b) is a refractive index in the direction perpendicular to the slow axis and nz (b) is a refractive index in the thickness direction and d is a thickness of film (nm). These can be determined according to similar method to Ro represented by aforesaid Equation (I) and Rth represented by Equation (III).

Optical film-B is preferably cellulose ester film and is also referred to as cellulose ester film-B.

To prepare film satisfying the above-described range of a retardation value, optical film-B preferably contains polymer described in paragraphs [0032]-[0049] of JP-A 2003-12859, and a retardation value can be adjusted by such as a type, an amount and a stretching condition of polymer described in the aforesaid Patent Publication.

These polymer is preferably added at 1-35 weight % in a dope and specifically preferably at 3-25 weight % with respect to controlling of a retardation value.

As a manufacturing method and a stretching method of optical film-B, a method similar to the aforesaid optical film-A can be utilized, however, a method described in JP-A 2002-249599 is preferably utilized.

In the following, physical properties of cellulose ester and optical film-B according to the present invention will be summarized.

(Transmittance of Cellulose Ester Film)

A part material for a LCD display is required to have a high transmittance and a transmittance at 500 nm of cellulose ester film manufactured with addition of the above-described additives is preferably 85-100%, more preferably 90-100% and most preferably 92-100%. A transmittance at 400 nm is preferably 40-100%, more preferably 50-100% and most preferably 60-100%. Further, an ultraviolet absorptive ability may be required, and the transmittance at 380 nm in this case is 0-10%, more preferably 0-5% and most preferably 0-3%.

(Thickness Distribution in Width direction of Cellulose Ester Film)

Cellulose ester film of the present invention has a thickness distribution in the width direction R (%) of 0≦R (%)≦5%, more preferably of 0≦R (%)≦3% and specifically preferably of 0≦R (%)≦1%.

(Haze Value of Cellulose Ester Film)

Cellulose ester film of the present invention has a haze value of preferably not more than 2%, more preferably not more than 1.5% and most preferably not more than 1%.

(Modulus of Elasticity of Cellulose Ester Film)

The modulus of elasticity is preferably in a range of 1.5-5 GPa, more preferably in a range of 1.8-4 GPa and specifically preferably in a range of 1.9-3 GPa.

Further, the stress at a breaking point is preferably in a range of 50-200 MPa, more preferably in a range of 70-150 MPa and most preferably in a range of 80-100 MPa.

The breaking point ductility at 23° C. and 55% RH is preferably in a range of 20-80%, more preferably in arrange of 30-60% and most preferably in a range of 40-50%.

Further, the hygroscopic coefficient of expansion is preferably in a range of −1-1%, more preferably in a range of −0.5-0.5% and most preferably in a range of 0-0.2%.

Further, a bright point foreign matter defect is preferably in a range of 0-80 points/cm², more preferably in a range of 0-60 points/cm² and most preferably in a range of 0-30 points/cm².

Generally, in the case of utilizing cellulose ester film as polarizing plate protective film, alkaline saponification treatment is performed to improve an adhesive property with a polarizer. Since film after having been subjected to an alkaline saponification treatment and a polarizer are adhered by use of a polyvinyl alcohol aqueous solution as an adhesive, it is problematic as a polarizing plate protective film that adhesion of cellulose ester film with polyvinyl alcohol is impossible when a contact angle with water of said cellulose ester film after alkaline saponification treatment is high.

Therefore, a contact angle of cellulose ester film after an alkaline saponification treatment is preferably 0-60°, more preferably 5-55° and most preferably 10-30°.

(Center-line Mean Roughness (Ra) of Cellulose Ester Film)

At the time of utilizing cellulose ester film as a part material for a LCD, the film is required to be highly flat to decrease light leaks. A center-line mean roughness (Ra) is a value defined in JIS B 0601, and a measurement method includes such as a needle contact method or an optical method.

A center-line mean roughness (Ra) of cellulose ester film of the present invention is preferably not more than 20 nm, more preferably not more than 10 nm and specifically preferably not more than 4 nm.

(Polarizing Plate)

A polarizing plate of the present invention and a liquid crystal display of the present invention utilizing the same will be now explained.

A polarizing plate can be prepared by an ordinary method. Cellulose ester film having been subjected to an alkaline saponification treatment is preferably pasted up on at least one surface of a polarizer, which has been prepared by immersing and stretching polyvinyl alcohol type film in an iodine solution, by use of a completely saponified polyvinyl alcohol aqueous solution. Cellulose ester film of the present invention may be utilized also on the other surface, or another polarizing plate protective film may be utilized. As polarizing plate protective film on the other surface, cellulose ester film available on the market can be utilized. For example, as cellulose ester film available on the market, such as KC8UX2M, KC4UX, KC5UX, KC4UX, KC4UY, KC8UY, KC12UR, KC8UY-HA and KC8UX-RHA (these are manufactured by Konica Minolta Opto Inc.) are preferably utilized. In addition to these, film of such as cycloolefin resin, acrylic resin, polyester and polycarbonate may be utilized as polarizing plate protective film on the other surface. In this case, since the saponification adaptability is low, the adhesion process onto a polarizing plate is preferably performed via suitable adhesive layer.

A polarizing plate of the present invention is comprised of cellulose ester film of the present invention being utilized at least one side of a polarizer as polarizing plate protective film. At this time, the slow axis of said cellulose film is preferably arranged practically parallel to or perpendicular to the absorption axis of a polarizer.

This polarizing plate is one of polarizing plates which are arranged to sandwich a liquid crystal cell of an in-plane switching mode, and cellulose ester film of the present invention (specifically preferably aforesaid optical film-A) is preferably arranged on the liquid crystal display cell side.

A polarizer preferably utilized in the present invention includes polyvinyl alcohol type polarizing film, which is classified into polyvinyl type film dyed with iodine and one dyed with dichromatic dye. As polyvinyl alcohol type film, modified polyvinyl alcohol type film modified by ethylene is preferably utilized. As a polarizer, preferably utilized are those prepared by polyvinyl alcohol aqueous solution being cast and the resulting film being uniaxially stretched and dyed or uniaxially stretched after being dyed, followed by being subjected to a durability treatment with a boron compound. The layer thickness of a polarizer is 5-40 μm, preferably 5-30 μm and specifically preferably 5-20 μm. On said polarizer surface, one surface of cellulose ester film of the present invention is pasted to form a polarizing plate. The pasting up is preferably performed by use of a water based adhesive comprising such as completely saponified polyvinyl alcohol as a primary component. Further, resin film other than cellulose ester film can be adhered on a polarizing plate while a suitable adhesive layer intervenes.

Since a polarizer has been stretched in uniaxial direction (generally in the longitudinal direction), a polarizing plate shrinks in the stretched direction and extends in the direction perpendicular to the stretched direction when being placed under an environment of high temperature and high humidity. The thicker is a layer thickness of polarizing plate protective film, the larger is a rate of extension or shrinkage of a polarizing plate, and specifically large is a shrinkage amount in the stretched direction of a polarizer. Generally, since the stretched direction of a polarizer is pasted up with the casting direction (MD direction) of a polarizing plate protective film, it is specifically important to restrain an elongation rate in the casting direction in the case of a polarizing plate protective film is made thinner. Cellulose ester film of the present invention is superior in dimensional stability to be suitably utilized as such a polarizing plate protective film.

A polarizing plate can be constituted by pasting up protective film on one surface of said polarizing plate and separate film on the opposite surface. Protective film and separate film are utilized for the purpose of protecting a polarizing plate at such as shipping and product inspection of a polarizing plate.

(In-plane Switching Mode Liquid Crystal Display)

A liquid crystal display of the present invention, which exhibits excellent visibility and an enlarged viewing angle, can be prepared by a polarizing plate of the present invention being combined into an in-plane switching mode liquid crystal display.

An in-plane switching mode includes also a fringe-field switching mode, in which a polarizing plate of the present invention can be incorporated similar to an IPS mode, and a liquid crystal display exhibiting a similar effect can be prepared.

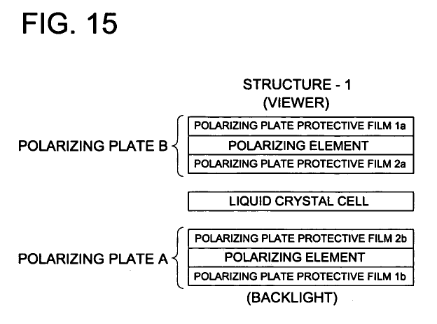

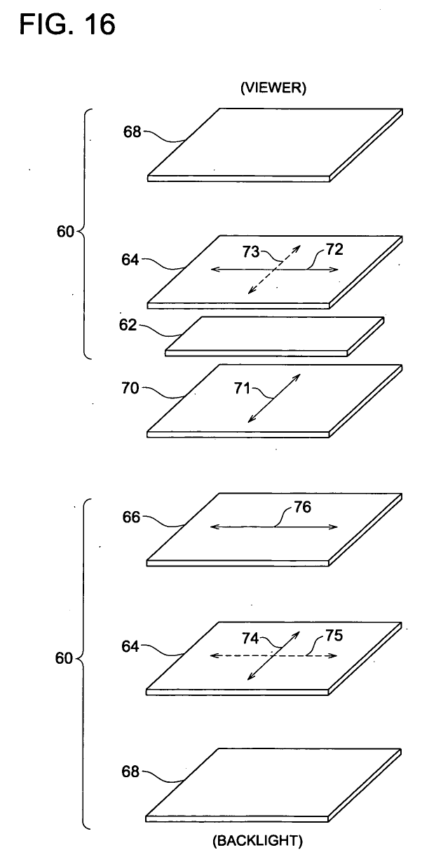

In an in-plane switching mode liquid crystal display, polarizing plates are arranged on the both sides sandwiching an operating liquid crystal cell. In the present invention, a polarizing plate in which cellulose ester film of the present invention which satisfies optical values of retardation value Ro of 105 nm≦Ro≦350 nm and Nz of 0.2≦Nz≦0.7, is utilized on one surface of the aforesaid liquid crystal cell. In this case, cellulose ester film-A is arranged between an adjacent polarizer and an operating liquid crystal cell. In polarizing plate-B arranged on the other side sandwiching a liquid crystal cell, optical film-B, which satisfies optical values of −15 nm≦Ro≦15 nm and −15 nm≦Rth≦15 nm, is utilized, is utilized as a polarizing plate protective film, and the optical film-B is specifically preferable arranged between an adjacent polarizer and an operating liquid crystal cell. Specifically, constitution-1 of FIG. 15 is preferable, however, constitution in which a viewing side polarizing plate and a backlight side polarizing plate may be arranged opposite-wise. Further, arrangement of cellulose ester film, polarizing plates and a liquid crystal cell shown in FIG. 16 is an example of an in-plane switching mode liquid crystal display preferable in the present invention. That is, it is preferable that polarizing plate protective film 2a of constitution-1 of FIG. 15 is cellulose ester film-A, and polarizing plate protective film 2b is optical film-B, or it is preferable that polarizing plate protective film 2a of constitution-1 of FIG. 15 is optical film-B, and polarizing plate protective film 2b is optical film-A. In FIG. 16, 60 is a polarizing plate. 62 is optical film-B (a polarizing plate protective film). 64 is a polarizer. 66 is optical film-A (a polarizing plate protective film) of the present invention. 68 is a polarizing plate protective film. 70 is an in-plane switching mode liquid crystal cell. 71 is a rubbing axis of liquid crystal. 72 and 74 are a transmission axis of a polarizer. 73 and 75 are an absorption axis of a polarizer. Further, 76 is the slow axis of optical film according to the present invention.

To prepare film satisfying the above-described range of a retardation value, optical film-B is preferably cellulose ester film, and said cellulose ester film-B can be prepared according to a method described in JP-A 2003-12859. Specifically, polymer described in paragraphs [0032]-[0049] of JP-A 2003-12859 is preferably blended in cellulose ester film, and a retardation value can be adjusted by a type and an amount of polymer described in the aforesaid patent publication.

These polymers are preferably blended in cellulose ester film-B at 1-35 weight % and specifically preferably at 3-25 weight %, with respect to controlling a retardation value.

As a manufacturing method of cellulose ester film-B, a manufacturing method of cellulose ester film well known in the art can be employed. Specifically, a manufacturing method described in JP-A 2002-249599 may be utilized, which is preferably applied in combination with the above described additives.

### EXAMPLES

The following describes the specific examples of the present invention, however, the present invention is not limited thereto. The following examples will use the term “part(s)” and “%” which should be interpreted as “parts by weight” and “% by weight”, respectively, unless otherwise specified.

### Example 1

<<Preparation of Needle-Shaped Particles>>

[Preparation of Needle-Shaped Particles 1: SrCO₃]

A suspension was prepared by adding 60 g of methanol (20% based on water) and 80 g of strontium hydroxide octahydrate (26.7% based on water) to 300 g of water. This suspension was put in a beaker, and an ultrasonic wave was applied to the suspension in a water bath equipped with a built-in ultrasonic wave irradiator (ultrasonic wave washer W-113MK-II manufactured by Honda Electronics Co., Ltd.) while being stirred by a stirring motor (Three One motor BLH 600 manufactured by Shinto Scientific Co., Ltd.). In order to keep the suspension temperature at −10° C., the commercially available ethylene glycol based anti freezing solution under the tradename of NYBRINE manufactured by Thomas Science Equipment Co., Ltd.) was circulated in the water bath using a cooler (enclosed tank type handy cooler TRL-C13, manufactured by Thomas Science Equipment Co., Ltd.).

CO₂ gas and N₂ gas at a volume ratio of CO₂:N₂=30:70 were mixed, and the mixture was introduced into the suspension at the flow rate of 200 ml/min. After the mixed gas was bubbled in this suspension until the pH valued was stabilized at about 7, supply of the mixed gas was stopped.

The suspension was suction-filtered using a filtering paper having a pore size of 0.1 μm to remove the unreacted substances. Then the reactant was stirred in a 500 ml of acetone for 24 hours and was washed. The reactant was subjected to another filtering operation and then dried by a vacuum dryer. After that, the crystal was observed by a scanning electron microscope (SEM), and was found to be the strontium carbonate needle-shaped crystal particle having a longer diameter of 200 nm or less (150 nm average) and a shorter diameter of 10 through 20 nm with a needle-shape ratio of 4 through 20.

[Needle-Shaped Particles 2: TiO₂]

The rutile type titanium oxide TTO-S-4 (manufactured by Ishihara Sangyo Kaisha Ltd.) which was surface treated by Al(OH)₃ and stearic acid, having a minor axis of 10 through 20 nm and a major axis of 50 through 100 nm was used as the needle-shaped particles 2.

<<Preparation of Needle-Shaped Particle Liquid>>

[Preparation of Needle-Shaped Particle Liquid 1: Needle-Shaped Particles=SrCO₃]

The following composition was dispersed at an output dial gauge of 10 of an ultrasonic wave dispersion device UH-300 (manufactured by SMT. Co., Ltd.) continuously for five minutes.

| | |
|---|---|
| Needle-shaped particles 1 | 32 g |
| Methylene chloride | 184 g |
| Ethanol | 184 g |

The needle-shaped particle liquid 1 was prepared by dispersing the aforementioned dispersion, using the Ultra Apex Mill UAM015 (manufactured by Kotobuki Industry Co., Ltd.) under the following conditions.

| | | |
|---|---|---|
| Dispersion media: zirconia beads (particle size 50 μm) | 400 | g |
| Peripheral speed | 10 | m/sec |
| Dispersion liquid circulation rate | 60 | ml/min. |
| Dispersion time | 5 | hours |

The jacket was cooled by a coolant.

[Preparation of Needle-Shaped Particle Liquid 2: Needle-Shaped Particles=SrCO₃+Silane Coupling Agent]

The following composition was dispersed at an output dial gauge of 10 of an ultrasonic wave dispersion device UH-300 (manufactured by SMT. Co., Ltd.) continuously for five minutes.

| | | |
|---|---|---|
| Needle-shaped particles 1 | 32 | g |
| 3-methacryloxypropyltrimethoxy silane (KBM503 | 1 | g |
| manufactured by Shin-Etsu Chemical Co., Ltd.) | | |
| 1 mol/L of hydrochloric acid | 0.1 | g |
| Methylene chloride | 184 | g |
| Ethanol | 184 | g |

The needle-shaped particle liquid 2 with the surface of the needle-shaped particle treated by silane coupling agent was prepared by dispersing the aforementioned dispersion using the Ultra Apex Mill UAM015 (manufactured by Kotobuki Industry Co., Ltd.) under the following conditions.

| | | |
|---|---|---|
| Dispersion media: zirconia beads (particle size 50 μm) | 400 | g |
| Peripheral speed | 10 | m/sec |
| Dispersion liquid circulation rate | 60 | ml/min. |
| Dispersion time | 5 | hours |

The jacket was cooled by a coolant.

[Preparation of Needle-Shaped Particle Liquid 3: SrCO₃+Stearic Acid]

The following composition was dispersed at an output gradation of 10 continuously for five minutes using an ultrasonic wave dispersion device UH-300 (manufactured by SMT. Co., Ltd.).

| | | |
|---|---|---|
| Needle-shaped particles 1 | 32 | g |
| Stearic acid | 1.0 | g |
| Methylene chloride | 184 | g |
| Ethanol | 184 | g |

Then the needle-shaped particle liquid 3 with the surface of the needle-shaped particle treated by stearic acid was prepared by dispersing the aforementioned dispersion using the Ultra Apex Mill UAM015 (manufactured by Kotobuki Industry Co., Ltd.) under the following conditions.

| | | |
|---|---|---|
| Dispersion media: zirconia beads (particle size 50 μm) | 400 | g |
| Peripheral speed | 10 | m/sec |
| Dispersion liquid circulation rate | 60 | ml/min. |
| Dispersion time | 5 | hours |

The jacket was cooled by a coolant. Dispersion was carried out according to this method concurrently with treatment of the surface needle-shaped particles by stearic acid.

[Preparation of Needle-Shaped Particle Liquid 4: TiO₂]

The following composition was dispersed at an output gradation of 10 continuously for five minutes using an ultrasonic wave dispersion device UH-300 (manufactured by SMT. Co., Ltd.).

| | |
|---|---|
| Needle-shaped particles 2 | 32 g |
| Methylene chloride | 184 g |
| Ethanol | 184 g |

The needle-shaped particle liquid 4 was prepared by dispersing the aforementioned dispersion using the Ultra Apex Mill UAM015 (manufactured by Kotobuki Industry Co., Ltd.) under the following conditions

| | | |
|---|---|---|
| Dispersion media: zirconia beads (particle size 50 μm) | 400 | g |
| Peripheral speed | 10 | m/sec |
| Dispersion liquid circulation rate | 60 | ml/min. |
| Dispersion time | 5 | hours |

The jacket was cooled by a coolant.

<<Preparation of Dope Solution>>

[Preparation of dope solution 1]

| | | |
|---|---|---|
| Cellulose acetate propionate (acetyl substitution | 25 | parts |
| degree: 1.90; propionyl substitution degree: 0.75; weight | | |
| average molecular weight: 190,000) | | |
| Additive A (polyester compound) | 26 | parts |
| TINUVIN 326 (manufactured by Ciba Specialty Chemicals | 1 | part |
| K.K) | | |
| TINUVIN 109 (manufactured by Ciba Specialty Chemicals | 1 | part |
| K.K) | | |
| TINUVIN 171 (manufactured by Ciba Specialty Chemicals | 1 | part |
| K.K) | | |
| Methylene chloride | 468 | parts |
| Ethanol | 34 | parts |

The aforementioned compositions were put into a container and were completely dissolved.

The needle-shaped particle dispersion liquid was prepared by taking the steps of slowly adding 200 parts of needle-shaped particle liquid 1 to the aforementioned solution, and 350 g of this mixture was dispersed at an output dial gauge of 10 continuously for ten minutes, using an ultrasonic wave dispersion device UH-300 (manufactured by SMT. Co., Ltd.), while cooling around the container with a coolant.

The dope solution 1 was prepared by slowly dissolving the following composition completely while stirring the needle-shaped particle dispersion liquid sufficiently.

| | |
|---|---|
| Cellulose acetate propionate (acetyl substitution | 147 parts |
| degree: 1.90; propionyl substitution degree: 0.75; weight | |
| average molecular weight 190,000) | |
| Methylene chloride | 100 parts |

[Preparation of Dope Solution 2]

The dope solution 2 was prepared according to the same procedure as that for preparing the aforementioned dope solution 1, except that the additive B (polyalcohol ester) was used in the same amount instead of additive A.

[Preparation of Dope Solution 3]

The dope solution 3 was prepared according to the same procedure as that for preparing the aforementioned dope solution 1, except that the additive C (polycarboxylic acid ester) was used in the same amount instead of additive A.

[Preparation of Dope Solution 4]

The dope solution 4 was prepared according to the same procedure as that for preparing the aforementioned dope solution 1, except that the additive D (ethylenically unsaturated monomer polymer) was used in the same amount instead of additive A.

[Preparation of Dope Solution 5]

The dope solution 5 was prepared according to the same procedure as that for preparing the aforementioned dope solution 1, except that the additive E (ethylenically unsaturated monomer polymer 2) was used in the same amount instead of additive A.

[Preparation of dope solution 6]

| | | |
|---|---|---|
| Cellulose acetate propionate (acetyl substitution | 25 | parts |
| degree: 1.90; propionyl substitution degree: 0.75; weight | | |
| average molecular weight: 190,000) | | |
| Additive B | 16 | parts |
| Additive C | 10 | parts |
| TINUVIN 326 (manufactured by Ciba Specialty Chemicals | 1 | part |
| K.K) | | |
| TINUVIN 109 (manufactured by Ciba Specialty Chemicals | 1 | part |
| K.K) | | |
| TINUVIN 171 (manufactured by Ciba Specialty Chemicals | 1 | part |
| K.K) | | |
| Methylene chloride | 468 | parts |
| Ethanol | 34 | parts |

The aforementioned compositions were put into a container and was completely dissolved.

Then the needle-shaped particle dispersion liquid was prepared by taking the steps of slowly adding 200 parts of needle-shaped particle liquid 1 to the aforementioned solution while stirring the aforementioned solution, and dispersing 350 g of this mixture at an output gradation of 10 continuously for ten minutes, using an ultrasonic wave dispersion device UH-300 (manufactured by SMT. Co., Ltd.), while cooling around the container with a coolant.

Then the dope solution 6 was prepared by adding the following composition slowly and dissolving it completely while stirring the needle-shaped particle dispersion liquid sufficiently.

| | |
|---|---|
| Cellulose acetate propionate (acetyl substitution | 147 parts |
| degree: 1.90; propionyl substitution degree: 0.75; weight | |
| average molecular weight: 190,000) | |
| Methylene chloride | 100 parts |

[Preparation of dope solution 7]

| | | |
|---|---|---|
| Cellulose acetate propionate (acetyl substitution | 26 | parts |
| degree: 1.90; propionyl substitution degree: 0.75; weight | | |
| average molecular weight: 190,000) | | |
| Additive B | 6 | parts |
| Additive C | 4 | parts |
| TINUVIN 326 (manufactured by Ciba Specialty Chemicals | 1 | part |
| K.K) | | |
| TINUVIN 109 (manufactured by Ciba Specialty Chemicals | 1 | part |
| K.K) | | |
| TINUVIN 171 (manufactured by Ciba Specialty Chemicals | 1 | part |
| K.K) | | |
| Methylene chloride | 486 | parts |
| Ethanol | 42 | parts |

The aforementioned composition was put into a container and was completely dissolved.

Then the needle-shaped particle dispersion liquid was prepared by the step of slowly adding 188 parts of needle-shaped particle liquid 1 while stirring the aforementioned solution, followed by the step of dispersing 350 g of this mixture at an output gradation of 10 continuously for ten minutes using an ultrasonic wave dispersion device UH-300 (manufactured by SMT. Co., Ltd.), while cooling around the container with coolant.

Then the dope solution 7 was prepared by adding the following composition slowly and dissolving it completely while sufficiently stirring the needle-shaped particle dispersion liquid.

| | |
|---|---|
| Cellulose acetate propionate (acetyl substitution | 149 parts |
| degree: 1.90; propionyl substitution degree: 0.75; weight | |
| average molecular weight: 190,000) | |
| methylene chloride | 100 parts |

[Preparation of dope solution 8]

| | | |
|---|---|---|
| Cellulose acetate propionate (acetyl substitution | 23 | parts |
| degree: 1.90; propionyl substitution degree: 0.75; weight | | |
| average molecular weight: 190,000) | | |
| Additive B | 29 | parts |
| Additive C | 17 | parts |
| TINUVIN 326 (manufactured by Ciba Specialty Chemicals | 1 | part |
| K.K) | | |
| TINUVIN 109 (manufactured by Ciba Specialty Chemicals | 1 | part |
| K.K) | | |
| TINUVIN 171 (manufactured by Ciba Specialty Chemicals | 1 | part |
| K.K) | | |
| Methylene chloride | 445 | parts |
| Ethanol | 23 | parts |

The aforementioned composition was put into a container and was completely dissolved.

Then the needle-shaped particle dispersion liquid was prepared by the step of slowly adding 217 parts of needle-shaped particle liquid 1 to the aforementioned solution, followed by the step of dispersing 350 g of this mixture at an output gradation of 10 continuously for ten minutes using an ultrasonic wave dispersion device UH-300 (manufactured by SMT. Co., Ltd.), while cooling around the container with coolant.

Then the dope solution 8 was prepared by adding the following composition slowly and dissolving it completely while sufficiently stirring the needle-shaped particle dispersion liquid.

| | |
|---|---|
| Cellulose acetate propionate (acetyl substitution | 145 parts |
| degree: 1.90; propionyl substitution degree: 0.75; weight | |
| average molecular weight: 190,000) | |
| Methylene chloride | 100 parts |

[Preparation of dope solution 9]

| | | |
|---|---|---|
| Cellulose acetate propionate (acetyl substitution | 21 | parts |
| degree: 1.90; propionyl substitution degree: 0.75; weight | | |
| average molecular weight: 190,000) | | |
| Additive B | 48 | parts |
| Additive C | 29 | parts |
| TINUVIN 326 (manufactured by Ciba Specialty Chemicals | 1 | part |
| K.K) | | |
| TINUVIN 109 (manufactured by Ciba Specialty Chemicals | 1 | part |
| K.K) | | |
| TINUVIN 171 (manufactured by Ciba Specialty Chemicals | 1 | part |
| K.K) | | |
| Methylene chloride | 410 | parts |
| Ethanol | 7 | parts |

The aforementioned composition was put into a container and was completely dissolved.

Then the needle-shaped particle dispersion liquid was prepared by the step of slowly adding 243 parts of needle-shaped particle liquid 1 to the aforementioned solution, followed by the step of dispersing 350 g of this mixture at an output gradation of 10 continuously for ten minutes using an ultrasonic wave dispersion device UH-300 (manufactured by SMT. Co., Ltd.), while cooling around the container with coolant.

Then the dope solution 9 was prepared by adding the following composition slowly and dissolving it completely while sufficiently stirring the needle-shaped particle dispersion liquid.

| | |
|---|---|
| Cellulose acetate propionate (acetyl substitution | 141 parts |
| degree: 1.90; propionyl substitution degree: 0.75; weight | |
| average molecular weight: 190,000) | |
| Methylene chloride | 100 parts |

[Preparation of dope solution 10]

| | | |
|---|---|---|
| Cellulose acetate propionate (acetyl substitution | 19 | parts |
| degree: 1.90; propionyl substitution degree: 0.75; weight | | |
| average molecular weight: 190,000) | | |
| Additive B | 61 | parts |
| Additive C | 36 | parts |
| TINUVIN 326 (manufactured by Ciba Specialty Chemicals | 1 | part |
| K.K) | | |
| TINUVIN 109 (manufactured by Ciba Specialty Chemicals | 1 | part |
| K.K) | | |
| TINUVIN 171 (manufactured by Ciba Specialty Chemicals | 1 | part |
| K.K) | | |
| Methylene chloride | 392 | parts |

The aforementioned composition was put into a container and was completely dissolved.

Then the needle-shaped particle dispersion liquid was prepared by the step of slowly adding 258 parts of needle-shaped particle liquid 1 to the aforementioned solution, followed by the step of dispersing 350 g of this mixture at an output gradation of 10 continuously for ten minutes using an ultrasonic wave dispersion device UH-300 (manufactured by SMT. Co., Ltd.), while cooling around the container with coolant.

Then the dope solution 10 was prepared by adding the following composition slowly and dissolving it completely while sufficiently stirring the needle-shaped particle dispersion liquid.

| | |
|---|---|
| Cellulose acetate propionate (acetyl substitution | 141 parts |
| degree: 1.90; propionyl substitution degree: 0.75; weight | |
| average molecular weight: 190,000) | |
| Methylene chloride | 100 parts |

[Preparation of Dope Solution 11]

The dope solution 11 was prepared according to the same procedure as that for preparing the aforementioned dope solution 1, except that the additive F (the sample 1 shown in the example of the aforementioned composition (polyester compound)) was used in the same amount instead of additive A.

[Preparation of Dope Solution 12]

The dope solution 12 was prepared according to the same procedure as that for preparing the aforementioned dope solution 1, except that triphenylphosphate (abbreviated as TPP) was used in the same amount (12% by weight) instead of additive A.

[Preparation of dope solution 13]

| | | |
|---|---|---|
| Cellulose acetate propionate (acetyl substitution | 25 | parts |
| degree: 1.90; propionyl substitution degree: 0.75; weight | | |
| average molecular weight: 190,000) | | |
| Triphenylphosphate (abbreviated as TPP) | 21 | parts |
| Ethylphthalylglycolate (abbreviated as EPEG) | 5 | parts |
| TINUVIN 326 (manufactured by Ciba Specialty Chemicals | 1 | part |
| K.K) | | |
| TINUVIN 109 (manufactured by Ciba Specialty Chemicals | 1 | part |
| K.K) | | |
| TINUVIN 171 (manufactured by Ciba Specialty Chemicals | 1 | part |
| K.K) | | |
| Methylene chloride | 468 | parts |
| Ethanol | 34 | parts |

The aforementioned composition was put into a container and was completely dissolved.

Then the needle-shaped particle dispersion liquid was prepared by the step of slowly adding 200 parts of needle-shaped particle liquid 1 to the aforementioned solution, followed by the step of dispersing 350 g of this mixture at an output gradation of 10 continuously for ten minutes using an ultrasonic wave dispersion device UH-300 (manufactured by SMT. Co., Ltd.), while cooling around the container with coolant.

Then the dope solution 13 was prepared by adding the following composition slowly and dissolving it completely while sufficiently stirring the needle-shaped particle dispersion liquid.

| | |
|---|---|
| Cellulose acetate propionate (acetyl substitution | 147 parts |
| degree: 1.90; propionyl substitution degree: 0.75; weight | |
| average molecular weight: 190,000) | |
| Methylene chloride | 100 parts |

[Preparation of dope solution 14]

| | | |
|---|---|---|
| Cellulose acetate propionate (acetyl substitution | 27 | parts |
| degree: 1.90; propionylsubstitution degree: 0.75; weight | | |
| average molecular weight: 190,000) | | |
| TINUVIN 326 (manufactured by Ciba Specialty Chemicals | 1 | part |
| K.K) | | |
| TINUVIN 109 (manufactured by Ciba Specialty Chemicals | 1 | part |
| K.K) | | |
| TINUVIN 171 (manufactured by Ciba Specialty Chemicals | 1 | part |
| K.K) | | |
| Methylene chloride | 497 | parts |
| Ethanol | 47 | parts |

The aforementioned composition was put into a container and was completely dissolved.

Then the needle-shaped particle dispersion liquid was prepared by the step of slowly adding 179 parts of needle-shaped particle liquid 1 to the aforementioned solution, followed by the step of dispersing 350 g of this mixture at an output gradation of 10 continuously for ten minutes using an ultrasonic wave dispersion device UH-300 (manufactured by SMT. Co., Ltd.), while cooling around the container with coolant.

Then the dope solution 14 was prepared by adding the following composition slowly and dissolving it completely while sufficiently stirring the needle-shaped particle dispersion liquid.

| | |
|---|---|
| Cellulose acetate propionate (acetyl substitution | 150 parts |
| degree: 1.90; propionylsubstitution degree: 0.75; weight | |
| average molecular weight: 190,000) | |
| Methylene chloride | 100 parts |

[Preparation of Dope Solutions 101 through 106 and 111 through 114]

The dope solutions 101 through 106 and 111 through 114 were prepared according to the same procedure as that used in the preparation of the aforementioned dope solutions 1 through 6 and 11 through 14, except that the needle-shaped particle liquid 1 was changed to needle-shaped particle liquid 2 (SrCO₃+silane coupling agent).

[Preparation of Dope Solution 206]

The dope solution 206 was prepared according to the same procedure as that used in the preparation of the aforementioned dope solution 6, except that the needle-shaped particle liquid 1 was changed to needle-shaped particle liquid 3 (SrCO₃+stearic acid).

[Preparation of Dope Solutions 301 through 306 and 311 through 314]

The dope solutions 301 through 306 and 311 through 314 were prepared according to the same procedure as that used in the preparation of the aforementioned dope solutions 101 through 106 and 111 through 114, except that cellulose acetate propionate (acetyl substitution degree 1.90, propionyl substitution degree 0.75, weight average molecular weight 190,000) was changed to the cellulose acetate propionate (acetyl substitution degree: 0.18; propionyl substitution degree: 2.50; weight average molecular weight: 160,000), with the amount being kept unchanged.

[Preparation of Dope Solutions 401 through 406 and 411 through 414]

The dope solutions 401 through 406 and 411 through 414 were prepared according to the same procedure as that used in the preparation of the aforementioned dope solutions 1 through 6 and 11 through 14, except that the needle-shaped particle liquid 1 was changed to needle-shaped particle liquid 4 (TiO₂).

The following describes the details of the compound used to prepare the dope solutions given in abbreviations in Tables 1 and 2:

Additive A (Polyester)

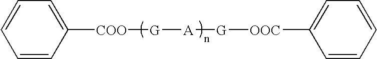

G: Terephthalic acid

A: 1,4-butane diol

Weight average molecular weight: 800

Additive B (Polyalcohol Ester)

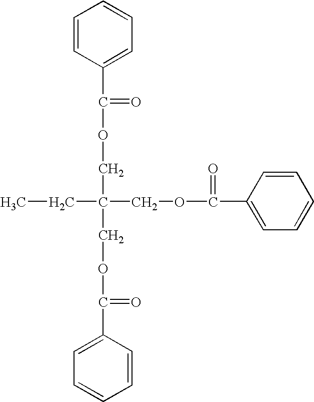

Additive C (Polycarboxylic Acid Ester)

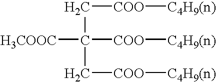

Additive D (Polymerized Ethylenically Unsaturated Monomer)

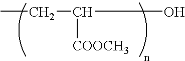

Weight average molecular weight: 1000

Additive E (Ethylenically Unsaturated Monomer Polymer)

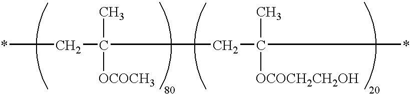

Weight average molecular weight: 8000

<<Film Manufacturing Method>>

[Film Manufacturing Method 1 at a Stretching Ratio of ×1.2]

A cellulose ester film having a thickness of 80 μm and a width of 1.3 m was prepared by taking the steps of: flow-casting the dope uniformly over the stainless steel belt maintained at 40° C. through the use of a die wherein a plurality of nozzles shown in FIG. 6 were laid out across the width; drying the web until the amount of residual solvent was 80%; peeling the web from the stainless steel belt at a tension of 170 N/m; clamping both ends of the web by a tenter; stretching the web to make the stretching ratio 1.2 in the lateral (TD); conveying the web by multiple rolls at a conveyance tension of 130 N/m; and drying the web for ten minutes at 120° C. This film was provided with knurling having a height of 10 μm and a width of 1.5 cm on each edge.

[Film Manufacturing Method 2 at a Stretching Ratio of ×1.5]

The film manufacturing method 2 is the same as the aforementioned film manufacturing method 1, except that the stretching ratio is ×1.5.

[Film Manufacturing Method 3 at a Stretching Ratio of ×3.0]

The film manufacturing method 3 is the same as the aforementioned film manufacturing method 1, except that the stretching ratio is ×3.0.

<<Preparation of Cellulose Ester Films>>

The cellulose ester films 1 through 55 were prepared according to the film manufacturing method shown in Tables 1 and 2 using the dope solutions as above.

TABLE 1

| | | | | Film | | |
|---|---|---|---|---|---|---|
| | Dope | | | manufacturing | | |
| Cellulose | so- | Additive to film | | method | | |
| ester | lution | | Amount | | Stretching | |
| film No. | No. | Type | (%) | No. | Ratio | Remarks |
| 1 | 1 | Additive A | 12 | 1 | 1.2 | Inv. |
| 2 | 2 | Additive B | 12 | 1 | 1.2 | Inv. |
| 3 | 3 | Additive C | 12 | 1 | 1.2 | Inv. |
| 4 | 4 | Additive D | 12 | 1 | 1.2 | Inv. |
| 5 | 5 | Additive E | 12 | 1 | 1.2 | Inv. |
| 6 | 6 | Additive B/ | 12 | 1 | 1.2 | Inv. |
| | | Additive C | | | | |
| 7 | 11 | Additive F | 12 | 1 | 1.2 | Inv. |
| 8 | 12 | TPP | 12 | 1 | 1.2 | Comp. |
| 9 | 13 | TPP/EPEG | 12 | 1 | 1.2 | Comp. |
| 10 | 14 | — | — | 1 | 1.2 | Comp. |
| 11 | 1 | Additive A | 12 | 2 | 1.5 | Inv. |
| 12 | 2 | Additive B | 12 | 2 | 1.5 | Inv. |
| 13 | 3 | Additive C | 12 | 2 | 1.5 | Inv. |
| 14 | 4 | Additive D | 12 | 2 | 1.5 | Inv. |
| 15 | 5 | Additive E | 12 | 2 | 1.5 | Inv. |
| 16 | 6 | Additive B/ | 12 | 2 | 1.5 | Inv. |
| | | Additive C | | | | |
| 17 | 7 | Additive B/ | 5 | 2 | 1.5 | Inv. |
| | | Additive C | | | | |
| 18 | 8 | Additive B/ | 20 | 2 | 1.5 | Inv. |
| | | Additive C | | | | |
| 19 | 9 | Additive B/ | 30 | 2 | 1.5 | Inv. |
| | | Additive C | | | | |
| 20 | 10 | Additive B/ | 35 | 2 | 1.5 | Inv. |
| | | Additive C | | | | |
| 21 | 11 | Additive F | 12 | 2 | 1.5 | Inv. |
| 22 | 12 | TPP | 12 | 2 | 1.5 | Comp. |
| 23 | 13 | TPP/EPEG | 12 | 2 | 1.5 | Comp. |
| 24 | 14 | — | — | 2 | 1.5 | Comp. |

Inv.: Inventive Sample,
Comp.: Comparative Sample

TABLE 2

| | | | | Film | | |
|---|---|---|---|---|---|---|
| | Dope | | | manufacturing | | |
| Cellulose | so- | Additive to film | | method | | |
| ester | lution | | Amount | | Stretching | |
| film No. | No. | Type | (%) | No. | Ratio | Remarks |
| 25 | 101 | Additive A | 12 | 2 | 1.5 | Inv. |
| 26 | 102 | Additive B | 12 | 2 | 1.5 | Inv. |
| 27 | 103 | Additive C | 12 | 2 | 1.5 | Inv. |
| 28 | 104 | Additive D | 12 | 2 | 1.5 | Inv. |
| 29 | 105 | Additive E | 12 | 2 | 1.5 | Inv. |
| 30 | 106 | Additive B/ | 12 | 2 | 1.5 | Inv. |
| | | Additive C | | | | |
| 31 | 111 | Additive F | 12 | 2 | 1.5 | Inv. |
| 32 | 112 | TPP | 12 | 2 | 1.5 | Comp. |
| 33 | 113 | TPP/EPEG | 12 | 2 | 1.5 | Comp. |
| 34 | 114 | — | — | 2 | 1.5 | Comp. |
| 35 | 206 | Additive B/ | 12 | 2 | 1.5 | Inv. |
| | | Additive C | | | | |
| 36 | 301 | Additive A | 12 | 3 | 3.0 | Inv. |
| 37 | 302 | Additive B | 12 | 3 | 3.0 | Inv. |
| 38 | 303 | Additive C | 12 | 3 | 3.0 | Inv. |
| 39 | 304 | Additive D | 12 | 3 | 3.0 | Inv. |
| 40 | 305 | Additive E | 12 | 3 | 3.0 | Inv. |
| 41 | 306 | Additive B/ | 12 | 3 | 3.0 | Inv. |
| | | Additive C | | | | |
| 42 | 311 | Additive F | 12 | 3 | 3.0 | Inv. |
| 43 | 312 | TPP | 12 | 3 | 3.0 | Comp. |
| 44 | 313 | TPP/EPEG | 12 | 3 | 3.0 | Comp. |
| 45 | 314 | — | — | 3 | 3.0 | Comp. |
| 46 | 401 | Additive A | 12 | 2 | 1.5 | Inv. |
| 47 | 402 | Additive B | 12 | 2 | 1.5 | Inv. |
| 48 | 403 | Additive C | 12 | 2 | 1.5 | Inv. |
| 49 | 404 | Additive D | 12 | 2 | 1.5 | Inv. |
| 50 | 405 | Additive E | 12 | 2 | 1.5 | Inv. |
| 51 | 406 | Additive B/ | 12 | 2 | 1.5 | Inv. |
| | | Additive C | | | | |
| 52 | 411 | Additive F | 12 | 2 | 1.5 | Inv. |
| 53 | 412 | TPP | 12 | 2 | 1.5 | Comp. |
| 54 | 413 | TPP/EPEG | 12 | 2 | 1.5 | Comp. |
| 55 | 414 | — | — | 2 | 1.5 | Comp. |

Inv.: Inventive Sample,
Comp.: Comparative sample

<<Evaluation of Cellulose Ester Films>>

The cellulose ester films having been prepared were evaluated according to the aforementioned procedure, for the following points:

[Evaluation of the Average Azimuth Angle and Ds/D of Particles]

The cellulose ester film having been prepared was captured by a transmission electron microscope at a magnification of ×20,000, and the image was then scanned by the scanner CanoScan FB 636U manufactured by Canon Inc. at 300 dpi with a 256-step gradations in the monochromatic mode.

The image having been was captured into the image processing software WinROOF ver 3.60 (manufactured by Mitani Trading Co., Ltd.) installed on the Endeavor Pro720L (CPU: Athlon-1 GHz, with a memory size of 512 MB), a PC manufactured by Epson Direction Co., Ltd.

This image processing software is capable of calculating the needle-shape ratio, absolute maximum length, azimuth angle and the position of gravity center of the particles to be described later.

In an image pre-treatment process, particle image extraction was performed, wherein the captured image was extracted in the field of view of 2×2 μm (where the image was automatically binarized). It was confirmed on the screen subsequent to particle image extraction that 90% or more of the particles were extracted. If the extraction was insufficient, the detection level was manually adjusted to ensure that 90% or more of the particles were detected and extracted.

If the number of needle-shaped particles in the range to be observed was less than 1,000, the same procedure was taken in a further 2×2 μm field of view until the total number of the particles reached 1,000.

The azimuth angle and needle-shape ratio of each needle-shaped particle of the extracted image data were measured according to the aforementioned procedure. The needle-shape ratio was calculated according to the following Equation. The absolute maximum length was assumed as the length of the longer axis of the needle-shaped particle.
Needle-shape ratio=absolute maximum length/diagonal width

The particles of foreign substance or pulverized particles having a needle-shape ratio of less than 2 were excluded from the calculation of the average azimuth angle and average inter-particle distance, since they produced noise. This calculation was made only for the particles having a needle-shape ratio of 2 or more.

As shown in FIG. 1, when the direction of absolute maximum length of the needle-shaped particle was taken, the angle with respect to the reference axis is assumed as the azimuth angle. The reference axis can be set in any direction, however, the lateral direction (width direction or TD) of the film was set as the reference axis in the present invention. The azimuth angle of each needle-shaped particle was calculated, and the average value thereof was used as the average azimuth angle.

Assuming that the direction of the average azimuth angle shown in FIG. 2 was a new reference axis, the angular difference between the azimuth angle of each needle-shaped particle and the direction of the average azimuth angle was calculated to find out the average of the absolute values of the angular differences. This was termed as “H” which represents the average value of the absolute value of the angles between the direction of the average azimuth angle and the azimuth angle of each needle-shaped particle.

To get the average inter-particle distance D, the coordinate of the position of the gravity center of each needle-shaped particle was obtained from the aforementioned image data.

As shown in FIG. 3, the direction of the average azimuth angle found in the aforementioned procedure was assumed as the coordinate X axis. The X-axis coordinate data of the position of gravity center of each needle-shaped particle were arranged in the ascending order to find out the difference between the adjacent data. This was assumed as the inter-particle distance in the X-axis direction. The same procedure was taken for the Y-axis direction. Namely, the y-axis coordinate data of the position of gravity center of each needle-shaped particle were arranged in the ascending order to find out the difference between the adjacent data. This was assumed as the inter-particle distance in the y-axis direction. Two sets of data each having the number of particle number minus 1 were obtained for the inter-particle distances in the X-axis direction and Y-axis direction. These data of inter-particle distances in the X-axis direction and Y-axis direction were put together to find out the average value. The resultant average value was considered as the average inter-particle distance D of which the standard deviation was represented as Ds, thereby the Ds/D value was calculated. This value indicates the state of dispersion of needle-shaped particles in the film. The smaller the standard deviation is, the more constant the inter-particle distances are, and the more uniform the dispersion is.

[Measurement of Haze Value]

The the haze was measured according to JIS K-7136 using the haze meter NDH2000 (manufactured by Nihon Denshoku Co., Ltd.). This was used as an indicator of transparency.

[Measurement of Retardation Values Ro, Rth, Ro(b) and Rth b]]

The average refractive index of each cellulose ester film was determined using the Abbe refractormeter 1T (manufactured by Atago Co., Ltd.) and spectral light source apparatus. Also measured was the film thickness with a commercially available micrometer.

Using the film being left to stand for 24 hours in an environment of 23° C. and 55% RH, the retardation of the film at a wavelength of 590 nm was measured in the same environment using an automatic birefringence meter KOBRA-21ADH (by Oji Scientific Instruments). The average values of the above refractive indexes and film thickness were put into the following Equation to get the in-plane retardation Ro and the retardation in the thickness direction Rth and Nz.
Ro=(nx−ny)×d
Rth={(nx+ny)/2−nz}×d
Nz=(nx−nz)/(nx−ny)

wherein, nx represents an in-plane refractive index in a slow axis direction, ny represents an in-plane refractive index in a direction perpendicular to the slow axis direction, nz represents a refractive index in a film thickness direction, and d is a thickness (nm) of the film.

Ro(b) and Rth(b) of the cellulose ester film-B were calculated in the same procedure as the aforementioned Ro and Rth.

[Evaluation of Retardation Stability]

A cellulose ester film was conditioned in an environment of 23° C. and 80% RH for five hours and Rth(80% RH) was measured in the same environment. In the same way, Rth(20% RH) was determined in an environment of 23° C. and 20% RH. The absolute value of the difference between Rth(80% RH) and Rth(20% RH) was designated as ARth and used as a measure of the stability of retardation.
Retardation stability ΔRth=|Rth(80% RH)−Rth(20% RH)|

[Evaluation of Retardation Variation]

The Ro values at a total of 60 points were measured as follows: 20 points in a portion close to the core of the roll of produced cellulose ester film, namely, 5 points equally spaced in the TD direction of the cellulose ester film in each of four lines having an interval of 1 m in the MD direction; 20 points similarly distributed in the same manner as above in a portion close to the center of the roll of the produced cellulose ester film; and 20 points similarly distributed in the same manner as above in a portion close to the outside of the roll of the produced cellulose ester film. Variation of Ro of the Ro values measured as above was calculated in the following equation:
Variation of Ro(%)=(maximum value of Ro−minimum value of Ro)/(average value of Ro)×100

Tables 3 and 4 summarize the results obtained as described above.

TABLE 3

| | Evaluation results | | | | | | | | |
|---|---|---|---|---|---|---|---|---|---|
| Cellulose | Chemical | | | Retardation | | | | | |
| ester | formula | | | values | | | | | |
| film | (3) H | | Haze | Ro | Rt | | *2 ΔRth | *3 | |
| No. | (*1) | Ds/D | (%) | (nm) | (nm) | Nz | (nm) | (%) | Remarks |
| 1 | 22 | 0.9 | 0.6 | 163 | 53 | 0.83 | 5 | 0.9 | Inv. |
| 2 | 21 | 0.8 | 0.5 | 171 | 50 | 0.79 | 4 | 0.7 | Inv. |
| 3 | 22 | 0.9 | 0.4 | 163 | 53 | 0.83 | 4 | 0.8 | Inv. |
| 4 | 23 | 0.8 | 0.7 | 156 | 57 | 0.86 | 5 | 0.8 | Inv. |
| 5 | 24 | 0.9 | 0.6 | 148 | 61 | 0.91 | 6 | 0.9 | Inv. |
| 6 | 20 | 0.7 | 0.4 | 182 | 44 | 0.74 | 3 | 0.8 | Inv. |
| 7 | 25 | 1.0 | 0.7 | 137 | 66 | 0.98 | 7 | 1.0 | Inv. |
| 8 | 38 | 1.1 | 0.8 | 34 | 118 | 3.97 | 15 | 3.1 | Comp. |
| 9 | 39 | 1.2 | 0.9 | 23 | 123 | 5.85 | 12 | 2.7 | Comp. |
| 10 | 40 | 1.3 | 1.1 | 16 | 127 | 8.44 | 27 | 6.0 | Comp. |
| 11 | 17 | 0.8 | 1.2 | 186 | 39 | 0.71 | 6 | 0.9 | Inv. |
| 12 | 16 | 0.9 | 1.2 | 194 | 35 | 0.68 | 5 | 0.8 | Inv. |
| 13 | 15 | 0.8 | 1.1 | 203 | 31 | 0.65 | 5 | 0.8 | Inv. |
| 14 | 17 | 0.8 | 1.4 | 186 | 39 | 0.71 | 6 | 0.9 | Inv. |
| 15 | 18 | 0.9 | 1.3 | 178 | 43 | 0.74 | 6 | 0.9 | Inv. |
| 16 | 15 | 0.7 | 1.1 | 203 | 31 | 0.65 | 4 | 0.8 | Inv. |
| 17 | 28 | 0.8 | 1.4 | 96 | 84 | 1.38 | 6 | 0.9 | Inv. |
| 18 | 13 | 0.7 | 1.1 | 219 | 23 | 0.61 | 5 | 0.9 | Inv. |
| 19 | 20 | 0.8 | 1.1 | 162 | 51 | 0.81 | 5 | 0.8 | Inv. |
| 20 | 31 | 0.9 | 1.0 | 72 | 96 | 1.83 | 12 | 2.1 | Inv. |
| 21 | 20 | 1.1 | 1.4 | 162 | 51 | 0.81 | 7 | 1.0 | Inv. |
| 22 | 34 | 1.3 | 1.7 | 47 | 108 | 2.80 | 17 | 3.1 | Comp. |
| 23 | 33 | 1.2 | 1.8 | 55 | 104 | 2.39 | 15 | 2.9 | Comp. |
| 24 | 37 | 1.2 | 2.1 | 23 | 121 | 5.76 | 29 | 7.0 | Comp. |

Average value H (°) of the absolute value of the angle between the direction of the average azimuth angle and each needle-shaped particle
Retardation stability ΔRth = |Rth (80% RH) − Rth (20% RH)|
Retardation variation = (Ro maximum value − Ro minimum value)/Ro average value × 100
Inv.: Inventive sample,
Comp.: Comparative sample

TABLE 4

| | Evaluation results | | | | | | | | |
|---|---|---|---|---|---|---|---|---|---|
| Cellulose | Chemical | | | Retardation | | | | | |
| ester | formula | | | values | | | | | |
| film | (3) H | | Haze | Ro | Rt | | *2 ΔRth | *3 | |
| No. | (*1) | Ds/D | (%) | (nm) | (nm) | Nz | (nm) | (%) | Remarks |
| 25 | 12 | 0.8 | 1.1 | 227 | 18 | 0.58 | 7 | 0.7 | Inv. |
| 26 | 13 | 0.7 | 1.1 | 219 | 23 | 0.61 | 6 | 0.6 | Inv. |
| 27 | 12 | 0.8 | 1.0 | 227 | 18 | 0.58 | 6 | 0.6 | Inv. |
| 28 | 14 | 0.8 | 1.3 | 211 | 27 | 0.63 | 7 | 0.7 | Inv. |
| 29 | 13 | 0.7 | 1.2 | 219 | 23 | 0.61 | 7 | 0.7 | Inv. |
| 30 | 10 | 0.7 | 1.0 | 243 | 10 | 0.54 | 5 | 0.6 | Inv. |
| 31 | 18 | 0.9 | 1.3 | 178 | 43 | 0.74 | 8 | 0.8 | Inv. |
| 32 | 32 | 1.0 | 1.6 | 64 | 100 | 2.06 | 18 | 2.9 | Comp. |
| 33 | 31 | 1.1 | 1.7 | 72 | 96 | 1.83 | 16 | 2.7 | Comp. |
| 34 | 35 | 1.0 | 2.0 | 39 | 112 | 3.37 | 30 | 6.8 | Comp. |
| 35 | 11 | 0.6 | 0.9 | 235 | 14 | 0.56 | 4 | 0.6 | Inv. |
| 36 | 5 | 0.9 | 1.4 | 266 | −4 | 0.48 | 7 | 1.0 | Inv. |
| 37 | 4 | 0.8 | 1.4 | 274 | −8 | 0.47 | 6 | 0.9 | Inv. |
| 38 | 4 | 0.9 | 1.3 | 274 | −8 | 0.47 | 6 | 0.9 | Inv. |
| 39 | 5 | 0.9 | 1.6 | 266 | −4 | 0.48 | 7 | 1.0 | Inv. |
| 40 | 4 | 0.8 | 1.5 | 274 | −8 | 0.47 | 7 | 1.0 | Inv. |
| 41 | 3 | 0.7 | 1.3 | 282 | −12 | 0.46 | 5 | 0.9 | Inv. |
| 42 | 8 | 1.1 | 1.8 | 241 | 8 | 0.53 | 7 | 1.0 | Inv. |
| 43 | 18 | 1.2 | 23.0 | 160 | 49 | 0.81 | 19 | 3.6 | Comp. |
| 44 | 21 | 1.3 | 21.0 | 135 | 61 | 0.95 | 17 | 3.4 | Comp. |
| 45 | 29 | 1.2 | 25.0 | 70 | 94 | 1.84 | 31 | 7.5 | Comp. |
| 46 | 11 | 1.2 | 2.6 | 470 | 341 | 1.23 | 9 | 1.6 | Inv. |
| 47 | 12 | 1.1 | 2.6 | 455 | 333 | 1.23 | 8 | 1.5 | Inv. |
| 48 | 11 | 1.0 | 2.4 | 470 | 341 | 1.23 | 8 | 1.5 | Inv. |
| 49 | 13 | 1.1 | 3.0 | 442 | 327 | 1.24 | 9 | 1.6 | Inv. |
| 50 | 12 | 1.0 | 2.8 | 455 | 333 | 1.23 | 9 | 1.6 | Inv. |
| 51 | 9 | 1.0 | 2.4 | 493 | 352 | 1.21 | 7 | 1.5 | Inv. |
| 52 | 17 | 1.2 | 3.0 | 391 | 301 | 1.27 | 10 | 1.7 | Inv. |
| 53 | 31 | 1.4 | 3.6 | 213 | 212 | 1.50 | 24 | 4.2 | Comp. |
| 54 | 30 | 1.3 | 3.8 | 225 | 218 | 1.47 | 22 | 4.0 | Comp. |
| 55 | 34 | 1.4 | 4.4 | 174 | 193 | 1.61 | 36 | 8.1 | Comp. |

Average value H (°) of the absolute value of the angle between the direction of the average azimuth angle and each needle-shaped particle
Phase difference stability ΔRth = |Rth (80% RH) − Rth (20% RH)|
Phase difference variation = (Ro maximum value − Ro minimum value)/Ro average value × 100
Inv.: Inventive sample,
Comp.: Comparative sample

As will be clear from the result given in Tables 3 and 4, the cellulose ester film of the present invention containing the needle-shaped particles where the needle-shape ratio is 2 through 100, and at least one of the substances selected from the Additives (polymer obtained by polymerization of the polyester, polyalcohol ester, polycarboxylic acid ester and ethylenically unsaturated monomer) of the present invention has a lower degree of haze than that of the Comparative Example, and is superior in retardation stability and smaller in retardation variation.

### Example 2

<<Preparation of Polarizing Plate A>>

A polarizer was prepared as follows: subjecting the polyvinyl alcohol film with a thickness of 50 μm to uniaxial stretching (at a temperature of 110° C. and a stretching ratio of ×5); immersing this film in the water solution containing 100 g of water made up of 0.075 g of iodine and 6 g of potassium iodide for 60 seconds, then in the water solution having been a temperature of 68° C. containing of 6 g of potassium iodide, 7.5 g of boric acid and 100 g of water; rinsing the film in water; and drying.

Then the polarizing plates A1 through 55 were prepared according to the processes 1 through 5.

(Process 1)

The cellulose ester films 1 through 55 having been prepared in Example 1 as polarizing plate protective films were immersed in the 2 mol/L sodium hydroxide solution having a temperature of 60° C. for 90 seconds, and were rinsed and dried. The side to be laminated with the polarizer was saponified.

In the similar manner, the commercially available cellulose ester film KC8UX2M (manufactured by Konica Minolta Opto Inc.) as the polarizing plate protective film on the opposite site was also saponified.

(Process 2)

The aforementioned polarizer was immersed in the polyvinyl alcohol adhesive tank containing 2% wt solids for 1 through 2 seconds.

(Process 3)

The excessive adhesive attached to the polarizer in the process 2 was gently wiped off and the polarizer was placed on the saponified surface of each cellulose ester film prepared in the Example 1 having been processed in the process 1. As the polarizing plate protective film on the opposite side, the commercially available cellulose ester film KC8UX2M having been processed in the process 1 was laminated on the polarizer so that the saponified surface of cellulose ester film would contact the polarizer.

(Process 4)

The polarizing plate with the cellulose ester film and polarizer having been laminated in the process 3 was bonded under a pressure of 20 through 30 N/cm² at a conveyance speed of about 2 m/min.

(Process 5)

The polarizing plates A1 through 55 were prepared by drying for two minutes the polarizing plate having been produced in the process 4, using a dryer having a temperature of 80° C.

As the structure of the polarizing plate A shown in the Structure-1 of FIG. 15, the polarizing plates A1 through 55 were prepared according to this procedure, wherein the commercially available cellulose ester film KC8UX2M (manufactured by Konica Minolta Opto Inc.) was used as the polarizing plate protective film 1b, and the cellulose ester film was used as the polarizing plate protective film 2b.

<<Preparation of Polarizing Plate B>>

[Preparation of Cellulose Ester Film-B]

The cellulose ester film-B used in the polarizing plate B was prepared in the following procedure:

(Preparation of Polymer)

Bulk polymerization was carried out according to the polymerization procedure described in JP-A No. 2000-344823 as follows: heating the contents to 70° C. while putting the following methylmethacrylate and ruthenocene in a flask equipped with a stirring device, nitrogen gas supply tube, temperature meter, supply port and recirculation cooling tube; adding half the following β-mercaptopropionic acid with the nitrogen gas sufficiently having been replaced into the flask while stirring; keeping the contents in the flask being stirred at 70° C. after addition of the β-mercaptopropionic acid; and subjecting the contents to 2-hour polymerization. This was followed by the steps of: further adding the remaining half of the β-mercaptopropionic acid with the nitrogen gas having been replaced; keeping the contents being stirred at 70° C.; subjecting the contents to 4-hour polymerization; returning the temperature of the reaction product to the room temperature; and adding 20 parts of tetrahydrofuran solution containing 5% by weight of benzoquinone to the reaction product; thus, discontinuing the process of polymerization. This was further followed by the steps of heating the substance having been polymerized gradually up to 80° C. while depressurizing this substance by an evaporator, and removing tetrahydrofuran, residual monomer and residual thiol compound, thereby preparing the polymer. This polymer had a weight average molecular weight of 3,400. The hydroxyl value (by the following measurement procedure) was 50.

| | | |
|---|---|---|
| Methylmethacrylate | 100 | parts |
| Ruthenocene (metallic catalyst) | 0.05 | parts |
| β-mercaptopropionic acid | 12 | parts |

<Measurement of Hydroxyl Value>

The hydroxyl value was measured according to the method of JIS K 0070(1992). The hydroxyl value can be defined as the value in terms of mg of the potassium hydroxide required to neutralize the acetic acid bonded with the hydroxyl group, when 1 g of the sample is acetylated. More specifically, it can be determined as follows: weighing X g (about 1 g) of sample accurately; putting it into a flask; adding 20 ml of acetylation reagent (pyridine added to 20 ml of acetic anhydride to get 400 ml) accurately thereto; providing the outlet of the flask with an air cooling tube; healing the solution in a glycerine bath having a temperature of 95 through 100° C.; cooling the solution after the lapse of one hour and 30 minutes; and adding 1 ml of purified water 1 ml through the air cooling tube so that the acetic anhydride was decomposed into acetic acid. This was followed by the step of titration by a potential difference titration apparatus using a 0.5 mol/L potassium hydroxide ethanol solution. The inflection point of the titration curve having been obtained was defined as a terminal point. Then titration was carried out in an idle test wherein a sample was not put therein. Thus, the inflection point of the titration curve was determined, and the hydroxyl value was calculated according to the following Equation.
Hydroxyl value={(B−C)×f×28.05/X}+D

where B denotes the amount (ml) of 0.5 mol/L potassium hydroxide ethanol solution used in the idle test, C repesents the amount (ml) of 0.5 mol/L potassium hydroxide ethanol solution used in the titration, f shows the factor of 0.5 mol/L potassium hydroxide ethanol solution, D represents an acid value, and 28.05 is equivalent to a half of 56.11 as 1 mol potassium hydroxide.

(Preparation of Cellulose Ester Film-B)

<Preparation of silicon dioxidedispersion liquid B>

| | |
|---|---|
| Aerosil R972V (manufactured by Nippon Aerosil Co., | 12 parts |
| Ltd.; primary particle with an average diameter of 16 nm and | |
| apparent specific gravity of 90 g/L) | |
| Ethanol | 88 parts |

Silicon dioxide diluted dispersion liquid B was prepared as follows: stirring and mixing the aforementioned solution for 30 minutes; dispersing the mixture with a Manthon Gaulin (wherein the turbidity of solution subsequent to dispersion was 200 ppm); adding 88 parts of methylene chloride to silicon dioxidedispersion liquid while stirring; and stirring and mixing in a dissolver for 30 minutes.

<Preparation of in-line liquid additive B>

| | |
|---|---|
| TINUVIN 109 (manufactured by Ciba Specialty Chemicals | 11 parts |
| K.K) | |
| TINUVIN 171 (manufactured by Ciba Specialty Chemicals | 5 parts |
| K.K) | |
| Methylene chloride | 100 parts |

The aforementioned substances were added in an enclosed container, dissolved completely, and filtered while heating and stirring.

In-line liquid additive B was prepared as follows: adding 36 parts of silicon dioxide diluted dispersion liquid B thereto while stirring; further stirring for 30 minutes; adding 6 parts of cellulose acetate propionate (acetyl group substitution degree: 1.9; propionyl group substitution degree: 0.8) while stirring; stirring for further 60 minutes; and filtering the solution using a polypropylene wind cartridge filter TCW-PPS-1N manufactured by Advantec Toyo Co., Ltd.

<Preparation of dope solution B>

| | |
|---|---|
| Cellulose acetate (acetyl substitution degree: 2.92; | 100 parts |
| molecular weight Mn = 148000; molecular weight | |
| Mw = 310000; Mw/Mn = 2.1) | |
| Polymer prepared above | 12 parts |
| Methylene chloride | 440 parts |
| Ethanol | 40 parts |

A dope solution was prepared by putting these compositions into an enclosed container, heating and stirring them until they were completely dissolved, and filtering the solution by the filter paper Azumi No. 24 (by AZUMI FILTERPAPER CO., LT).

The dope solution B was filtered in the film-manufacturing line using a Finemet NF (manufactured by Nippon Seisen Co., Ltd.).

The in-line liquid additive B was filtered in the in-line liquid additive line by the Finemet NF (manufactured by Nippon Seisen Co., Ltd.). Two parts of the in-line liquid additive B having been filtered were added to 100 parts of the dope solution B having been filtered, and were mixed sufficiently by an in-line mixer (Toray static in-line mixer Hi-Mixer SWJ). Then the solution was uniformly flow-cast over the stainless steel band support to a width of 1.8 m at a temperature of 35° C. by a belt casting apparatus. Solvent was evaporated on the stainless steel band support until the amount of residual solvent became 120%, and the web was separated from the stainless steel band support. Solvent was evaporated at 35° C. from the web of the cellulose ester having been separated, and the web was slit to a width of 1.65 m. Then the web was stretched using a tenter at a stretching ratio of ×1.1 in the TD direction (i.e. direction perpendicular to the film conveying direction), and was dried at 150° C. The amount of residual solvent when the stretching was started by the tenter was 30%.

Then the web was conveyed by multiple rolls through the drying zone having a temperature of 110° C. and 120° C. Upon termination of drying, the web was slit to a width of 1.5 m. A knurled portion with a width of 15 mm and an average height 10 μm was formed on each side of the film by knurling operations. The web was wound on a core having an inner diameter of 6 inches at an initial winding tension of 220 N/m and a final tension of 110 N/m, thereby producing a cellulose acetate film B to be used for the polarizing plate 3 having a film thickness of 80 μm.

The retardation value of this cellulose ester film-B was measured and found to be as follows:
Ro(b)=0.1 nm, Rth(b)=0 nm

Polarizing plate B was prepared in the same procedure as that in the production of the aforementioned polarizing plate A, except that the aforementioned cellulose ester film-B was used instead of each cellulose ester film. In the Structure-1 of FIG. 15, the cellulose ester film-B was used as the polarizing plate protective film 2a of the polarizing plate B. The aforementioned cellulose ester film KC8UX2M (manufactured by Konica Minolta Opto Inc.) was used as the polarizing plate protective film 1a.

[Evaluation of Polarizing Platen: Measurement of Transmittance]

The above prepared polarizing plates A 1 through 55 each were cut to form two polarizing plates A for each. The transmittance was measured at a wavelength of 550 nm by a spectrophotometer U-3310 (manufactured by Hitachi Limited), with the polarizing plates A arranged perpendicular to each other. As a result, the polarizing plates (1 through 7, 11 through 19, 21, 25 through 31, 35 through 42, and 46 through 52) using the cellulose ester film of the present invention had a transmittance not exceeding 0.1%; whereas the polarizing plates (8 through 10, 20, 22 through 24, 32 through 34, 43 through 45, and 53 through 55) using the cellulose ester film of the Comparative Example had a transmittance of 0.5%. Since the polarizing plate using the cellulose ester film of the present invention was characterized by excellent uniformity, there was less light leakage of the polarizing plates perpendicular to each other.

<<Preparation of Liquid Crystal Display Apparatus>>

A liquid crystal display panel for visibility evaluation was prepared according to the following procedure:

The polarizing plates on both surfaces of an IPS mode liquid crystal TV Wooo W17-LC50 (manufactured by Hitachi Limited) were removed, and each of the above prepared polarizing plates A36 through 45 and polarizing plate B were adhered onto the glass surfaces of the liquid crystal cell.

In this case, the liquid crystal display panels were prepared in such a way that the slow axis of the cellulose ester film, the absorption axis of the polarizer, the orientation of the slow axis of the liquid crystal cell and the structure of the liquid crystal display apparatus conformed the axis layouts of FIGS. 15 and 16.

The visibility of the above prepared liquid crystal display apparatus was evaluated.

[Evaluation of the Visibility of Liquid Crystal Display Apparatus]

(Evaluation of Panel Unevenness)

Using the above prepared liquid crystal panel, black and white displays were carried out, and uneven brightness and light leakage were evaluated by visual inspection. The liquid crystal panel using the polarizing plate of the present invention prepared using the cellulose ester film of the present invention exhibited a smaller percentage of uneven brightness on the white display with almost no light leakage on the black display; whereas the liquid crystal panel produced by using the polarizing plate employing the cellulose ester film of the comparative example exhibited conspicuous uneven brightness on the white display, while light leakage was also observed on the black display. Further, the liquid crystal display panels were operated continuously for 24 hour where the panel temperatures were increased, and uneven brightness and light leakage were evaluated by visual inspection to find out the following: The liquid crystal panel produced by using the polarizing plate employing the cellulose ester film of the present invention exhibited less fluctuation in uneven brightness and light leakage, and the initial satisfactory condition was maintained. The liquid crystal panel produced by using the polarizing plate employing the cellulose ester film of the comparative example exhibited further deterioration in uneven brightness and light leakage.

The aforementioned discussion demonstrated that the liquid crystal panel produced by using the polarizing plate employing the cellulose ester film of the present invention was characterized by a reduction in initial uneven brightness and light leakage due to a smaller variation in phase difference, and by the virtual freedom from deterioration in uneven brightness or light leakage due to excellent stability in phase difference.

(Evaluation of the Viewing Angle)

The contrast in the black and white display mode of the above prepared liquid crystal panel was measured using a measuring instrument, EZ Contrast manufactured by ELDIM. It can be said that the viewing angle is greater, as the contract of the liquid crystal panel in the black and white display modes is greater at a tilt angle of 80° from the direction normal to the panel face. In the liquid crystal panel produced by using the polarizing plate employing the cellulose ester film of the present invention, the contrast at 80° was 40 or more in all directions. In the liquid crystal panel produced by using the polarizing plate employing the cellulose ester film of the comparative example, however, the contrast did not exceed 20 in some directions. Thus, the liquid crystal panel produced by using the cellulose ester film of the present invention exhibited a substantial improvement in the viewing angle.

### Example 100

<Preparation of Dope 1>

(Preparation of Particle Dispersion Liquid 1)

A particle dispersion of SrCO₃ was prepared according to the following method:

81.75 g of urea (21.8% by weight to water) and 30.75 g of strontium nitrate (8.2% by weight to water) were added to 375 g of water. To carry out the reaction below the freezing point, 75 g of ethylene glycol (20% by weight to water) was added as an organic solvent to the reaction solution. This solution was charged into a reaction container, and then stirred and cooled while applying an ultrasonic wave thereto.

Three-One motor BLH 600 produced by Shintoyo Science Co., Ltd. was used as a stirring motor, the ultrasonic wave washer W-113MK-II of Honda Electronic Co., Ltd. as a water bath with a built-in ultrasonic wave irradiation function, and the enclosed tank type handy cooler TRL-C13 of Thomas Science Equipment Co., Ltd. as a cooler.

An ethylene glycol based antifreezing solution (Niveline as registered trade name by Thomas Science Equipment Co., Ltd.) was circulated in the water bath by the cooler, thereby reducing the temperature of the reaction solution down to −5° C., wherein this temperature was kept at −5° C. This was followed by the step of adding 1.50 g of digestive enzyme Urease to the reaction solution. Then segregation of a crystal started in the reaction solution subsequent to addition of the digestive enzyme, and the solution turned milky-white. Keeping the reaction solution temperature at −5° C., the reaction was carried out for 12 hours.

Then the temperature of the reaction solution was increased up to 20° C., and kept for 12 hours to permit crystal growth, then the obtained crystal was took out by filtering, and dried. Observing the dried crystal with a scanning electron microscope (SEM), found were strontium carbonate needle-shaped particles having a length not exceeding 500 nm (approximately 400 nm on average) with a width of 20 through 50 nm and having an needle-shape ratio of 4 through 20.

| | |
|---|---|
| Above prepared SrCO₃ particle dispersion | 32 g |
| Methylene chloride | 184 g |
| Ethanol | 184 g |

The aforementioned compositions were at an output dial gauge of 10 continuously for five minutes using an ultrasonic wave dispersion device UH-300 (manufactured by SMT. Co., Ltd.). Then Ultra Apex Mill UAM015 (manufactured by Kotobuki Industry Co., Ltd.) was used to perform dispersion under the following conditions:

| | |
|---|---|
| Amount of dispersion liquid | 400 g |
| Dispersion medium: 50-μm diameter zirconia | 400 g |
| beads | |

This dispersion was conducted at a peripheral speed 10 m/sec. and at a dispersion liquid recirculation flow rate of 60 ml/min. for five hours, and the mill jacket was cooled by a coolant.

(Particle Liquid 1)

(Preparation of particle dispersion liquid 1)

| | | |
|---|---|---|
| Cellulose acetate propionate | 8.7 | parts by weight |
| (acetyl substitution degree: 1.90; propionyl | | |
| substitution degree: 0.75; weight average | | |
| molecular weight: 190,000) | | |
| Triphenylphosphate | 16 | parts by weight |
| Ethylphthalyl ethylglycolate | 4 | parts by weight |
| TINUVIN 326 (manufactured by Ciba Specialty | 0.60 | parts by weight |
| Chemicals K.K) | | |
| TINUVIN 109 (manufactured by Ciba Specialty | 1.02 | parts by weight |
| Chemicals K.K) | | |
| TINUVIN 171 (manufactured by Ciba Specialty | 1.02 | parts by weight |
| Chemicals K.K) | | |
| Methylene chloride | 149.6 | parts by weight |
| Ethanol | 15.0 | parts by weight |

The aforementioned compositions were put into a container and were completely dissolved.

Then 152.2 parts by weight of the particle liquid 1 was slowly added while stirring the solution, and 350 g of this mixture was dispersed at an output gradation of 10 continuously for ten minutes, using an ultrasonic wave dispersion device UH-300 (manufactured by SMT. Co., Ltd.), while cooling around the container with a coolant.

(Preparation of dope stock solution)

| | | |
|---|---|---|
| Cellulose acetate propionate | 166 | parts by weight |
| (acetyl substitution degree: 1.90; | | |
| propionyl substitution degree: 0.75) | | |
| Methylene chloride | 449.9 | parts by weight |
| Ethanol | 42.6 | parts by weight |

The above composition was charged in a container and completely dissolved, and then 341.7 parts by weight of particle dispersion liquid 1 was further added while stirring to prepare dope 1.

<Preparation of Dope 2>

(Preparation of particle liquid 1)
Particle dispersion liquid 1 was prepared in the same
procedure as that for preparing the dope 1.
(Preparation of particle liquid 2)

| | | |
|---|---|---|
| Cellulose acetate propionate | 8.7 | parts by weight |
| (acetyl substitution degree: 1.90; propionyl | | |
| substitution degree: 0.75; weight average | | |
| molecular weight: 190,000) | | |
| Triphenylphosphate | 16.0 | parts by weight |
| Ethylphthalyl ethylglycolate | 4.0 | parts by weight |
| TINUVIN 326 (manufactured by Ciba Specialty | 0.60 | parts by weight |
| Chemicals K.K) | | |
| TINUVIN 109 (manufactured by Ciba Specialty | 1.02 | parts by weight |
| Chemicals K.K) | | |
| TINUVIN 171 (manufactured by Ciba Specialty | 1.02 | parts by weight |
| Chemicals K.K) | | |
| Methylene chloride | 149.6 | parts by weight |
| Ethanol | 15.0 | parts by weight |

The aforementioned composition was put into a container and was completely dissolved.

Then particle dispersion liquid 2 was prepared by adding and mixing 152.2 parts by weight of particle liquid 1 while stirring this solution slowly.

(Preparation of Dope Stock Solution)

The dope stock solution was prepared according to the same procedure as that for preparing the dope 1.

Then dope 2 was prepared by adding the dope stock solution into a container, and mixing 341.7 parts by weight of particle dispersion liquid 2 while stirring.

<Preparation of Dope 3>

(Preparation of particle liquid 2)

| | | |
|---|---|---|
| Strontium carbonate particles used in preparation of | 32 | g |
| dope 1 | | |
| Ethanol | 184 | g |
| Methylene chloride | 184 | g |

Then the aforementioned compositions was dispersed at an output dial gauge of 10 continuously for ten minutes, using an ultrasonic wave dispersion device UH-300 (manufactured by SMT. Co., Ltd.). After that, these compositions were again dispersed by a sand grinder of such a structure that the mill part had an inner diameter of 120 mm and a height of 180 mm, three stirring disks each having a diameter of 80 mm were mounted on the shaft at an interval of 20 mm, and 400 g of 0.5 mm-diameter zirconia beads were used as dispersion media, wherein dispersion was carried out at a disk speed of 1200 rpm in a batch mode for five hours using 400 g of dispersion liquid. The mill part was designed in an enclosed structure, and the mill jacket was cooled by a coolant.

(Preparation of particle dispersion liquid 3)

| | | |
|---|---|---|
| Cellulose acetate propionate | 24.9 | parts by weight |
| (acetyl substitution degree: 1.90; propionyl | | |
| substitution degree: 0.75; weight average | | |
| molecular weight: 190,000) | | |
| Triphenylphosphate | 16.0 | parts by weight |
| Ethylphthalyl ethylglycolate | 4.0 | parts by weight |
| TINUVIN 326 (manufactured by Ciba Specialty | 0.60 | parts by weight |
| Chemicals K.K) | | |
| TINUVIN 109 (manufactured by Ciba Specialty | 1.02 | parts by weight |
| Chemicals K.K) | | |
| TINUVIN 171 (manufactured by Ciba Specialty | 1.02 | parts by weight |
| Chemicals K.K) | | |
| Methylene chloride | 599.5 | parts by weight |
| Ethanol | 57.5 | parts by weight |

The aforementioned compositions were put into a container and were completely dissolved.

Then 152.2 parts by weight of the particle liquid 2 was added slowly while stirring this solution, and 350 g of this mixture was dispersed at an output dial gauge of 10 continuously for ten minutes, using an ultrasonic wave dispersion device UH-300 (manufactured by SMT. Co., Ltd.), while the container was cooled with cold water.

(Preparation of Dope)

Dope 3 was prepared by adding the following cellulose acetate propionate slowly while sufficiently stirring the particle dispersion liquid 3 until the mixture was dissolved completely.

| | | |
|---|---|---|
| Particle dispersed resin solution 3 | 852.9 | parts by weight |
| Cellulose acetate propionate | 149.6 | parts by weight |
| (acetyl substitution degree: 1.90; | | |
| propionyl substitution degree: 0.75) | | |

<<Preparation of Film>>

### Example 101

### Stretching in the Lateral Direction (TD)

The aforementioned dope 1 was flow-cast uniformly over a stainless steel belt kept at 40° C. The die used for flow casting had slips each having a length of 20 mm arranged at an interval of 500 μm. After the web was dried until the amount of residual solvent was 80%, the web was removed from the stainless steel belt, and was stretched at a stretching ratio of ×1.4 in the lateral direction by a tenter. The web was further conveyed by multiple rolls and was dried at 120° C. to get a film having a thickness of 80 μm and a width of 1.3 m.

### Example 102

### Stretching in the Longitudinal Direction (MD)

The aforementioned dope 1 was kept at 40° C., and was flow-cast uniformly over a stainless steel belt kept at 40° C. The die used for flow casting had slips each having a length of 20 mm arranged at an interval of 500 μm.

After the web was dried until the amount of residual solvent was 80%, the web was removed from the stainless steel belt, and was then stretched at a stretching ratio of ×1.05 in the lateral direction by a tenter. The web was further conveyed by multiple rolls and was dried at 120° C. to get a film having a thickness of 80 μm and a width of 1.3 m. The winding speed was increased over the web separation speed, whereby the web was stretched at a stretching ratio of ×1.5 in the longitudinal stretching ratio (MD) during the process of conveyance.

### Comparative Example 101

In Example 101, the stretching ratio was ×1.05 in the TD direction.

### Example 103

### Casting in the Lateral Direction (TD)

The aforementioned dope 1 was flow-cast uniformly over a stainless steel belt kept at 40° C. For casting, the nozzles each having an inner diameter of 1 mm at an interval of 10 mm were arranged in the direction perpendicular to the stainless steel belt as a casting support and were made into a block (FIG. 6). This nozzle block was exposed to two vibrations per second at an amplitude of 10 mm, and casting was carried out over the stainless steel belt. After the web was dried until the amount of residual solvent was 80%, the web was removed from the stainless steel belt, and was then stretched at a stretching ratio of ×1.05 in the lateral direction (TD) by a tenter clip. The web was further conveyed by multiple rolls and was dried at 120° C. for ten minutes to get a film having a thickness of 80 μm and a width of 1.3 m.

### Example 104

### Casting and Orienting in the Lateral Direction (TD)

In Example 104, the same procedure as that in Example 103 was applied except that the stretching ratio in the lateral direction (TD) by the tenter was ×1.4.

### Example 105

### Casting and Orienting in the Lateral Direction (TD)

The aforementioned dope 1 was flow-cast uniformly to a width of 1200 mm over a stainless steel belt kept at 40° C.

For casting, the nozzles each having an inner diameter of 1 mm at an interval of 10 mm were arranged in the direction perpendicular to the stainless steel belt as a casting support and were made into a block. This nozzle block was exposed to two vibrations per second at an amplitude of 10 mm, and casting was carried out over the stainless steel belt. Further, the dope 1 was laminated over the dope previously flow-cast using the conventional die (20 nm-long slits arranged at an interval of 500 μm), and casting was carried out sequentially. The dope flow ratio of the 1st layer to the 2nd layer was 4 to 1.

After the web was dried until the amount of residual solvent was 80%, the web was removed from the stainless steel belt, and was stretched at a stretching ratio of ×1.4 in the lateral direction by a tenter. The web was further conveyed by multiple rolls and was dried at 120° C. to get a film having a thickness of 80 μm and a width of 1.3 m.

### Example 106

The aforementioned dope 1 was kept at 40° C., and was flow-cast uniformly over a stainless steel belt kept at 40° C.

The die used for flow casting had slips each having a length of 40 mm arranged at an interval of 350 μm. The needle-shaped particles were oriented by feeding the dope.

After the web was dried until the amount of residual solvent was 80%, the web was removed from the stainless steel belt, and was stretched by a tenter clip at a stretching ratio of ×1.05 in the lateral direction. The web was further conveyed by multiple rolls and was dried at 120° C. to get a film having a thickness of 80 μm and a width of 1.3 m.

### Example 107

In Example 107, a film was prepared according to the same procedure as that in Example 106, except that the length of the die slit in Example 106 was 35 mm.

### Example 108

The aforementioned dope 1 was kept at 40° C., and was flow-cast uniformly over a stainless steel belt kept at 40° C. The die used for flow casting had slips each having a length of 40 mm arranged at an interval of 350 μm. The needle-shaped particles were oriented by feeding the dope.

After the web was dried until the amount of residual solvent decreased to 80%, the web was removed from the stainless steel belt, and was stretched by a tenter at a stretching ratio of ×1.05 in the lateral direction. The web was further conveyed by multiple rolls and was dried at 120° C. to get a film having a thickness of 80 μm and a width of 1.3 m. In this case, the roll winding speed was increased over the web separation speed, whereby the web was stretched at a stretching ratio of ×1.5 in the longitudinal stretching ratio (MD).

### Example 109

In Example 109, a film was prepared according to the same procedure as that in Example 101, except that the dope 2 was used.

### Example 110

The aforementioned dope 1 was flow-cast uniformly over a stainless steel belt kept at 40° C. The die used for flow casting, as shown in FIG. 8, had slips each having a length of 30 mm arranged at an interval of 0.8 mm. The dope was supplied from one side. The grooves each having a depth of 0.5 mm at an interval of 1 mm were provided in the slip in the direction opposite to the supply side at an angle of 45° across the slit width. The die was passed through the slit, whereby particles were oriented in the lateral direction (TD) at the outlet of the die slit.

After the web was dried until the amount of residual solvent was 80%, the web was removed from the stainless steel belt, and was stretched at a stretching ratio of ×1.4 in the lateral direction by a tenter. The web was further conveyed by multiple rolls and was dried at 120° C. to get a film having a thickness of 80 μm and a width of 1.3 m.

### Example 111

The aforementioned dope 1 was flow-cast uniformly over a stainless steel belt kept at 40° C. One meter downstream from the cast position, particle orientation was carried out in the lateral direction (TD) using the following gravure roll:

(Gravure roll)

Diameter: 50 mm

Number of slant lines: 80

Angle: 45°

Engraved depth: 100 μm

While rotating, a gravure roll was put in contract with the dope, and the roll speed was adjusted so that the gravure cells moved toward the direction perpendicular to the converying direction, whereby the particles were made oriented in the lateral direction (TD). The excess dope attached to the gravure was scraped off by a blade and was returned to the dope receiver.

After the web was dried until the amount of residual solvent was 80%, the web was removed from the stainless steel belt, and was stretched at a stretching ratio of ×1.4 in the lateral direction by a tenter. The web was further conveyed by multiple rolls and was dried at 120° C. to get a film having a thickness of 80 μm and a width of 1.3 m.

### Comparative Example 102

In Example 102, the film was prepared according to the same procedure as that in Example 101, except that the dope 3 was used.

The results of evaluation of the cellulose ester films of Examples 101 through 111 of the present invention and the optical films in Comparative Examples 101 and 102 will be given below:

(Evaluation of Cutting Performance (Slitting Performance))

Evaluation of the slitting performance (ease of film breakage) in the actual film manufacturing process requires use of a long web and long-time test in the process, and this takes an enormous amount of cost and time. However, evaluation in a shorter time can be achieved by a test conducted under the following forcibly severe conditions. 1000 m of the film having a width of 300 mm was slit by a slitter.

The film was slit by upper and lower blades to a width of 50 mm, at a slitting speed of 10 m/min. with a tension of 5 kg.

The frequency of film breakdown was measured when tested under these conditions.

The present inventors have accumulated a stock of empirical data available on the breakdown frequency when evaluated under the aforementioned conditions and that in the actual process. According to these data:

the frequency of the aforementioned breakdown does not exceed 10: almost no breakage occurs in the actual process;

the frequency of the aforementioned breakdown is 10 through 20: breakage rarely occurs in the actual process;

the frequency of the aforementioned breakdown is 21 through 30: breakage sometimes occurs in the actual process but on the practical level; and

the frequency of the aforementioned breakdown is 30 or more: breakage frequently occurs in the actual process, therefore the film is not acceptable on the practical level.

These were used as criteria in the evaluation.

(Measurement of Retardation Values Ro and Rth)

The average refractive index of the optical film was determined using the Abbe refractormeter 1T (manufactured by Atago Co., Ltd.) and a light source apparatus. The film thickness was measured with a commercially available micrometer.

The retardation value at a wavelength of 590 nm was measured using the film left to stand in an environment of 23° C. and 55% RH for 24 hours by an automatic birefringence meter KOBRA-21ADH (by Oji Scientific Instruments). The in-plane retardation value Ro, retardation value in the thickness direction Rth and Nz were calculated by substituting the aforementioned average refractive index and film thickness into the following Equation.
Ro=(nx−ny)×d
Rth={(nx+ny)/2−nz}×d
Nz=(nx−nz)/(nx−ny)

wherein, nx represents an in-plane refractive index in a slow axis direction, ny represents an in-plane refractive index in a direction perpendicular to the slow axis direction, nz represents a refractive index in the film thickness direction, and d is a thickness (nm) of the film.

(Evaluation of Retardation Stability)

A film was moisture conditioned for five hours in an environment of 23° C. and 55% RH, and Rth (80% RH) was measured in the same environment. In the same way, a film was moisture conditioned for five hours in an environment of 20% RH, and Rth (20% RH) was measured in the same environment. The absolute value of the difference between the Rth (80% RH) and Rth (20% RH) was assumed as representing the stability of retardation.
Retardation stability=|Rth(80% RH)−Rth(20% RH)|

(Evaluation of Retardation Variation)

The Ro values at a total of 60 points were measured as follows: 20 points in a portion close to the core of the roll of produced cellulose ester film, namely, 5 points equally spaced in the TD direction of the cellulose ester film in each of four lines having an interval of 1 m in the MD direction; 20 points similarly distributed in the same manner as above in a portion close to the center of the roll of the produced cellulose ester film; and 20 points similarly distributed in the same manner as above in a portion close to the outside of the roll of the produced cellulose ester film. Variation of Ro of the Ro values measured as above was calculated in the following equation:
Variation of Ro(%)=(maximum value of Ro−minimum value of Ro)/average value of Ro×100

(Evaluation of Particle Azimuth Angle and Degree of Dispersion)

Evaluation of needle-shape ratio of the particle, azimuth angle, average azimuth angle, and average intergrain distance D, and standard deviation Ds of intergrain distance

The film having been prepared was captured by a transmission electron microscope at a magnification of ×20,000, and the image was then scanned by the scanner CanoScan FB 636U manufactured by Canon Inc. at 300 dpi with a 256-step gradations in the monochromatic mode.

The image having been was captured into the image processing software WinROOF ver 3.60 (manufactured by Mitani Trading Co., Ltd.) installed on the Endeavor Pro720L (CPU: Athlon-1 GHz, with a memory size of 512 MB), a personal computer manufactured by Epson Direction Co., Ltd.

This image processing software is capable of calculating the needle-shape ratio, absolute maximum length, azimuth angle and the position of gravity center of the particles to be described later.

In an image pre-treatment process of the image having been captured, particle image extraction was performed, wherein the captured image was extracted in the field of view of 2×2 μm (where the image was automatically binarized). It was confirmed on the screen subsequent to particle image extraction that 90% or more of the particles were extracted. If the extraction was insufficient, the detection level was manually adjusted to ensure that 90% or more of the particles were detected and extracted.

If the number of needle-shaped particles in the range to be observed was less than 1,000, the same procedure was taken in a further 2×2 μm field of view, until the total number of the particles reached 1,000.

The azimuth angle and needle-shape ratio of the needle-shaped particles of each image data having been extracted were measured according to the aforementioned procedure. The needle-shape ratio can be calculated according to the following Equation. The absolute maximum length is equivalent to the length of the long axis of the needle-shaped particle.
Needle-shape ratio=absolute maximum length/diagonal width

The diagonal width is defined as the shortest distance between two straight lines when sandwiching the particle image projected by the aforementioned two straight lines parallel to the absolute maximum length.

The particles wherein the needle-shape ratio of the foreign substance or broken particle was less than 2 were excluded from the calculation of the average azimuth angle and average inter-particle distance, since they produced noise. This calculation was made only for each of the particles having a needle-shape ratio of 2 or more.

When the absolute maximum length of the needle-shaped particle was taken, the angle with respect to the reference axis is assumed as the azimuth angle. The reference axis can be set, for example, across the film although it can also be set to a desired value. The azimuth angle of each needle-shaped particle was calculated, and the average value thereof is the average azimuth angle.

Assuming that the direction of the average azimuth angle was a new reference axis, the angular difference between the azimuth angle of each needle-shaped particle and the direction of the average azimuth angle was calculated to find out the average of the absolute values. This is “the average value H of the absolute value of the angles formed by the direction of the average azimuth angle and the azimuth angle of each needle-shaped particle”.

To get the average inter-particle distance D, the coordinate of the position of the gravity center of each needle-shaped particle from the aforementioned image data was obtained.

In this case, the direction of the average azimuth angle found in the aforementioned procedure was assumed as the coordinate X axis. The X-axis coordinate data items of the position of gravity center of the needle-shaped particle were arranged in the ascending order to find out the difference of the adjacent data items. This was assumed as the inter-particle distance in the X-axis direction. The same procedure was taken for the Y-axis direction. Namely, the y-axis coordinate data items of the position of gravity center of the needle-shaped particle were arranged in the ascending order to find out the difference of the adjacent data items. This was assumed as the inter-particle distance in the y-axis direction. For the inter-particle distances in the X-axis direction and Y-axis direction, the data the number of particles minus 1 were obtained. These data items of inter-particle distances in the X-axis direction and Y-axis direction were put together to find out the average value. The result was assumed as the average inter-particle distance D and the standard deviation was assumed as Ds, thereby the Ds/D value was calculated. This value indicates the state of dispersion in the film of needle-shaped particles. The smaller the standard deviation is, the more constant the inter-particle distance is and the more uniform the dispersion is.

The aforementioned evaluation was carried out using the films of Examples 101 through 111, and Comparative Examples 101 and 102. The evaluation result will be given below:

The aforementioned evaluation result is listed in Table 5.

TABLE 5

| | | Evaluation | | | | | | | | | | | |
|---|---|---|---|---|---|---|---|---|---|---|---|---|---|
| | | | | | | | | | Retardation | Variation | | | |
| | | Reference | *1 | H | | Ro | Rth | | stability | of Ro | Cutting | | |
| | Dope | axis | (°) | (°) | Ds/D | (nm) | (nm) | Nz | (nm) | (%) | performance | *2 | |
| Example 101 | 1 | TD | 0.5 | 30 | 1.3 | 75 | 100 | 1.83 | 12 | 2.1 | 22 | 8 | Inv. |
| Example 102 | 1 | MD | 0.3 | 26 | 1.0 | 100 | 85 | 1.35 | 14 | 2.5 | 12 | 4 | Inv. |
| Comparative | 1 | TD | 1.6 | 34 | 0.8 | 49 | 111 | 2.77 | 25 | 5.2 | 43 | 15 | Comp. |
| example 101 | | | | | | | | | | | | | |
| Example 103 | 1 | TD | 0.9 | 19 | 0.8 | 146 | 62 | 0.92 | 12 | 2.2 | 11 | 5 | Inv. |
| Example 104 | 1 | TD | 0.0 | 11 | 0.7 | 200 | 36 | 0.68 | 14 | 2.4 | 10 | 4 | Inv. |
| Example 105 | 1 | TD | 0.9 | 13 | 0.7 | 184 | 43 | 0.73 | 14 | 2.3 | 10 | 3 | Inv. |
| Example 106 | 1 | MD | 0.4 | 5 | 0.8 | 237 | 17 | 0.57 | 15 | 3.1 | 9 | 0 | Inv. |
| Example 107 | 1 | MD | 0.3 | 12 | 0.8 | 190 | 40 | 0.71 | 14 | 2.8 | 11 | 4 | Inv. |
| Example 108 | 1 | MD | 0.0 | 1 | 0.7 | 270 | 0 | 0.5 | 16 | 3.2 | 7 | 1 | Inv. |
| Example 109 | 2 | TD | 0.6 | 23 | 1.4 | 116 | 77 | 1.16 | 23 | 2.5 | 28 | 7 | Inv. |
| Example 110 | 1 | TD | 1.3 | 15 | 0.7 | 173 | 49 | 0.78 | 15 | 2.6 | 9 | 4 | Inv. |
| Example 111 | 1 | TD | 1.5 | 12 | 0.7 | 180 | 44 | 0.74 | 13 | 2.5 | 9 | 5 | Inv. |
| Comparative | 3 | TD | 1.8 | 29 | 2.1 | 78 | 96 | 1.73 | 28 | 7.1 | 50 | 13 | Comp. |
| example 102 | | | | | | | | | | | | | |

Inv.: Inventive sample,
Comp.: Comparative sample
*1 Angle formed by the average azimuth angle of needle-shaped particle and reference axis
*2 Frequency of the occurrence of troubles in polarizing plate
H: Average value (deg.) of the absolute values of the angles between the direction of the average azimuth angle and azimuth angles of each needle-shaped particles
Ds/D: Average value of standard deviation of inter-particle distance/average value of intergrain distance

The polarizing plate prepared according to the following method using the films of Examples 101 through 111 and Comparative Examples 101 and 102 have been evaluated according to the following criteria. The result of this evaluation is given below:

(Evaluation of the Frequency of the Occurrence of Troubles in Polarizing Plate)

The polarizing plate prepared using the films of the Examples 101 through 111, Comparative Examples 101 and 102 were evaluated as follows:

The above prepared polarizing plates were placed on a light table in a dark room wherein the absorption axes of the polarizing plates were arranged perpendicular to each other, and counted the bright spots per square meter (faulty portions subjected to light leakage). Evaluation was based on the following criteria:

2 counts or less: Preferable for use in the actual liquid crystal panel

3 through 5 counts: Without problem when used in actual liquid crystal panel

6 through 10 counts: Tolerable for use in actual liquid crystal panel although the yield rate is reduced

11 counts or more: Not acceptable, very poor panel yield rate

The result of the evaluation demonstrates the superiority of the cellulose ester film of the present invention for the purpose of achieving the object of the present invention.

<Preparation of Polarizing Plate>

A polarizer was prepared as follows: uniaxially stretching a polyvinyl alcohol film having a thickness of 50 μm (at a temperature of 110° C. and at a stretching ratio of ×5); immersing this film in a water solution containing 0.075 g of iodine, 6 g of potassium iodide, and 100 g of water for 60 seconds, then in a water solution containing 6 g of potassium iodide, 7.5 g of boric acid and 100 g of water at 68° C.; rinsing this film by water; and drying. After that, the polarizing plates 101 through 111, i and ii were prepared according to the processes 1 through 5:

Process 1

The cellulose ester film of the present invention prepared in Example 101 as a polarizing plate protective film was immersed in 2 mol/L of sodium hydroxide solution for 90 seconds at 60° C., and the film was rinsed in water, followed by drying. Then the surface to be adhered with the polarizer was saponified.

In the same way, a commercially available cellulose ester film KC8UX2M (manufactured by Konica Minolta Opto Inc.) was saponified as a polarizing plate protective film to be provided on the opposite surface of the polarizer.

Process 2

The aforementioned polarizer was immersed in a tank of polyvinyl alcohol adhesive having a solid content of 2% by weight for 1 through 2 seconds.

Process 3

Polarizing plate 1 was prepared as follows: gently wiping off the excess adhesive having deposited on the polarizer in the process 2; putting the polarizer on the saponified side of the cellulose ester film of the present invention prepared in the Example 101 having been treated in the process 1; and laminating the commercially available cellulose ester film KC8UX2M on the polarizer as a polarizing plate protective film on the opposite side, so that the saponified side of the commercially available cellulose ester film KC8UX2M having been treated in the process 1 would contract the polarizer.

Process 4

Then the polarizing plate formed by laminating the cellulose ester film on the polarizer in the process 3 was bonded at a pressure of 20 through 30 N/cm² at a conveyance speed of about 2 m/min.

Process 5

The polarizing plate produced in the process 4 was dried for two minutes in a drying machine having a temperature of 80° C.

In the same way, the polarizing plates i and ii were prepared according to the Comparative Examples 101 and 102 using the cellulose ester film of the present invention in Examples 102 through 111.

Based on the aforementioned procedure, the polarizing plates 101 through 111 and polarizing plates i and ii were prepared according to the arrangement of the polarizing plate A given in the Structure-1 of FIG. 15, wherein the commercially available cellulose ester film KC8UX2M (manufactured by Konica Minolta Opto Inc.) was used as a polarizing plate protective film 1b, and g the cellulose ester film of the present invention prepared in Examples 101 through 111 and Comparative Examples 101 and 102 was employed as a polarizing plate protective film 2b.

<Preparation of Polarizing Plate B>

The the cellulose ester film-B to be used in the polarizing plate B was prepared according to the following procedure:

<(Preparation of Polymer>

Bulk polymerization was carried out according to the polymerization procedure disclosed in the JP-A No. 2000-344823. While putting the following methylmethacrylate and Ruthenocene into a flask provided with a stirring device, nitrogen gas supply tube, temperature meter, inlet and recirculation cooling tube, the contents was heated up to 70° C. Then half the following β-mercaptopropionic acid having undergone sufficient nitrogen gas replacement was put into the flask while being stirred. Subsequent to addition of the β-mercaptopropionic acid, the contents in the flask being stirred were kept at 70° C., and polymerization was carried out for two hours. Further, the remaining fifty percent of the following β-mercaptopropionic acid having undergone sufficient nitrogen gas replacement was added. In the same way, the contents in the flask being stirred were kept at 70° C., and polymerization was carried out for four hours. The reaction product temperature was set back to the room temperature. After 20 parts by weight of a tetrahydrofuran solution containing 5% by weight of benzoquinone was added to the reaction product, polymerization was discontinued. The temperature of the polymerization product was gradually reduced down to 80° C. under the pressure reduced by an evaporator while tetrahydrofuran, residual monomer and residual thiol compound were removed. Following these steps, polymer 7 was prepared. The weight average molecular weight was 3,400, and hydroxyl value (the method for measurement given below) was 50.

| | | |
|---|---|---|
| Methylmethacrylate | 100 | parts by weight |
| Ruthenocene (metallic catalyst) | 0.05 | parts by weight |
| β-mercaptopropionic acid | 12 | parts by weight |
| (Hydroxyl value measurement | | |
| procedure) | | |

The hydroxyl value was measured according to JIS K 0070(1992). Here the hydroxyl value can be defined as the amount of potassium hydroxide (mg) required to neutralize the acetic acid having bonded with the hydroxyl group when 1 g of sample was acetylated. To put it more specifically, X g of sample (about 1 g) was accurately weighed and put into a flask. Just 20 ml of acetylation reagent (400 ml of solution obtained by adding pyridine to 20 ml of acetic anhydride 20 ml was added to the contents. The outlet of the flask was provided with an air cooling tube, and the solution was heated in a glycerine bath having a temperature of 95 through 100° C. Subsequent to cooling for one hour and a half, 1 ml of purified water was added from the air cooling tube so that the acetic anhydride was decomposed into acetic acid. Then the step of titration was taken by a potential difference titration apparatus, using 0.5 mol/L of potassium hydroxide ethanol solution. The inflection point of the titration curve obtained therefrom was assumed as the terminal point. In an idle test, titration was performed without using a sample to get the inflection point of the titration curve. The hydroxyl value is calculated by the following Equation.
Hydroxyl value={(B−C)×f×28.05/X}+D

where B represents the amount (ml) of 0.5 mol/L of potassium hydroxide ethanol solution used in the idle test, C denotes the amount (ml) of 0.5 mol/L potassium hydroxide ethanol solution used in titration, f shows the factor for 0.5 mol/L of potassium hydroxide ethanol solution, D represents the acid number, and 28.05 is equivalent to half of 56.11 as one molar quantity of potassium hydroxide.

<Preparation of cellulose ester film B used for
polarizing plate B>

| | | |
|---|---|---|
| (Silicon dioxide dispersion liquid B) Aerosil R972V | 12 | parts by weight |
| (manufactured by Nippon Aerosil Co., Ltd.) | | |
| (Primary particle average diameter: 16 nm; apparent | | |
| specific gravity: 90 g/L) | | |
| Ethanol | 88 | parts by weight |

Silicon dioxide diluted dispersion liquid B was prepared as follows: stirring and mixing these compositions in a dissolver for 30 minutes; dispersing them by a Manthon Gaulin wherein the turbidity subsequent to dispersion was 200 ppm; putting 88 parts by weight of methylene chloride to the silicon dioxide dispersion liquid while stirring; and again stirring and mixing the mixture in a dissolver for 30 minutes.

(Preparation of in-line liquid additive B)

| | | |
|---|---|---|
| TINUVIN 109 (manufactured by Ciba Specialty | 11 | parts by weight |
| Chemicals K.K) | | |
| TINUVIN 171 (manufactured by Ciba Specialty | 5 | parts by weight |
| Chemicals K.K) | | |
| Methylene chloride | 100 | parts by weight |

These compositions were put into an enclosed container, and were heated and stirred until they were completely dissolved. Then the mixture was filtered.

In-line liquid additive B was prepared as follows: adding 36 parts by weight of silicon dioxide diluted dispersion liquid B while stirring; further stirring for 30 minutes; adding 6 parts by weight of cellulose acetate propionate (acetyl group substitution degree: 1.9; propionyl group substitution degree: 0.8); stirring for 60 minutes; and filtering the solution by a polypropylene wind cartridge filter TCW-PPS-1N manufactured by Advantec Toyo Co., Ltd.

(Preparation of dope solution B)

| | | |
|---|---|---|
| Cellulose acetate (acetyl substitution degree: 2.92; | 100 | parts by weight |
| molecular weight Mn = 148000; | | |
| molecular weight Mw = 310000; | | |
| Mw/Mn = 2.1) | | |
| Above prepared polymer | 12 | parts by weight |
| Methylene chloride | 440 | parts by weight |
| Ethanol | 40 | parts by weight |

Dope solution B was prepared by putting these compositions into an enclosed container, heating and stirring them until they were completely dissolved, and filtering the solution by the filter paper Azumi No. 24 (by AZUMI FILTERPAPER CO., LT).

The dope solution B was filtered in the film-manufacturing line using a Finemet NF (manufactured by Nippon Seisen Co., Ltd.). The in-line liquid additive B was filtered in the in-line liquid additive line by the Finemet NF (manufactured by Nippon Seisen Co., Ltd.). Two parts of the in-line liquid additive B having been filtered were added to 100 parts of the dope solution B having been filtered, and were mixed sufficiently by an in-line mixer (Toray static in-line mixer Hi-Mixer SWJ. Then the solution was uniformly flow-cast over the stainless steel band support to a width of 1.8 m at a temperature of 35° C. by a belt casting apparatus. Solvent was evaporated on the stainless steel band support until the amount of residual solvent became 120%, and the web was separated from the stainless steel band support. Solvent was evaporated at 35° C. from the web of the cellulose ester having been separated, and the web was slit to a width of 1.65 m. Then the web was stretched in a tenter at a stretching ratio of ×1.1 in the TD direction (i.e. direction perpendicular to the film conveying direction), and was dried at 150° C. The amount of residual solvent when the stretching was started by the tenter was 30%.

Then the web was conveyed by multiple rolls through the drying zone having a temperature of 110° C. and 120° C. Upon termination of drying, the web was slit to a width of 1.5 m. A knurled portion with a width of 15 mm and an average height 10 μm was formed on each side of the film by knurling operations. The web was wound on a core having an inner diameter of 6 inches at an initial winding tension of 220 N/m and a final tension of 110 N/m, thereby producing a cellulose acetate film B to be used for the polarizing plate 3 having a film thickness of 80 μm.

The retardation value of this cellulose ester film-B was measured, and the following results were obtained:
Ro(b)=0.1 nm, Rth(b)=0 nm

Ro(b) and Rth(b) were measured according to the aforementioned measurement procedure for Ro and Rth

The polarizing plate B was prepared in the same procedure as that in the production of the aforementioned polarizing plate A, except that the aforementioned cellulose ester film-B was used instead of the cellulose ester film in Example 101 of the present invention. In the Structure-1 of FIG. 15, the cellulose ester film-B was used as the polarizing plate protective film 2a of the polarizing plate B. The aforementioned cellulose ester film KC8UX2M (manufactured by Konica Minolta Opto Inc.) was used as the polarizing plate protective film 1a.

(Evaluation of Polarizing Platen)

Each of the above prepared polarizing plates 1 through 11, i and ii were cut to form two polarizing plates A for each. The transmittance was measured at a wavelength of 550 nm by a spectrophotometer U-3310 (manufactured by Hitachi Limited), with the polarizing plates arranged perpendicular to each other. The polarizing plates 1 through 11 using the cellulose ester film of the present invention manufactured in 101 through 111 had a transmittance not exceeding 0.1%; whereas the polarizing plates i and ii using the cellulose ester film of the Comparative Examples 101 and 102 had a transmittance of 0.5%. Since the polarizing plate of the present invention was characterized by excellent uniformity, there was less light leakage of the polarizing plates perpendicular to each other.

<Preparation of Liquid Crystal Display Apparatus>

A liquid crystal panel for visibility evaluation was prepared according to the following procedure:

The polarizing plates on both surfaces an IPS mode liquid crystal TV set Wooo W17-LC50 (manufactured by Hitachi Limited) were removed, and the above prepared polarizing plates were adhered onto the glass surfaces of the liquid crystal cell. In this case, the liquid crystal panels were bonded in such a way that the slow axis of the cellulose ester film, the absorption axis of the polarizer, the orientation of the slow axis of the liquid crystal cell and the structure of the liquid crystal display apparatus would conform to the axis layouts of FIGS. 15 and 16.

(Evaluation of the Visibility of Liquid Crystal Display Apparatus)

Using the above prepared liquid crystal panel, black display and white display were carried out, and uneven brightness and light leakage were evaluated by visual inspection. The liquid crystal panel prepared by using the polarizing plates 1 through 11 employing the cellulose ester film of the present invention prepared in Examples 101 through 111 was characterized by a smaller percentage of uneven brightness on the white display with almost no light leakage on the black display; whereas the liquid crystal panel produced by using the polarizing plates i and ii employing the cellulose ester film produced in Comparative Examples 101 and 102 was characterized by conspicuous uneven brightness on the white display, wherein light leakage was also observed on the black display. Further, the liquid crystal panel was continuously operated for 24 hours and uneven brightness and light leakage subsequent to rise of the panel temperature were evaluated by visual inspection to find out the following: The liquid crystal panel prepared by using the polarizing plates 101 through 111 employing the cellulose ester film of the present invention prepared in Examples 101 through 111 was characterized by less fluctuation in uneven brightness and light leakage, and the initial satisfactory conditions were maintained. The liquid crystal panel produced by using the polarizing plates i and ii employing the cellulose ester film produced in Comparative Examples 101 and 102 was characterized by further deterioration in uneven brightness and light leakage.

The polarizing plate in the Examples of the present invention was characterized by smaller initial uneven brightness or light leakage because of smaller variations in phase difference, and by virtual freedom from deterioration in uneven brightness or light leakage because of excellent stability in phase difference.

What is claimed is:

1. An optical film manufactured by stretching a cellulose ester comprising needle-shaped particles and an additive selected from the group consisting of a polyester, a polyalcohol ester, a polycarboxylic acid ester and a polymer obtained by polymerizing an ethylenically unsaturated monomer,
wherein the needle-shaped particles exhibit negative birefringency in a stretching direction of the optical film.

2. The optical film of claim 1 having the following optical values:
nx(a)>nz(a)>ny(a)
105 nm≦Ro(a)≦350 nm
0.2<Nz<0.7
wherein, Ro(a) and Nz are defined as follows:
Ro(a)=(nx(a)−ny(a))×d Equation (i)
Nz=(nx(a)−nz(a))/(nx(a)−ny(a)) Equation (ii)
wherein, y represents a stretching direction of the optical film, ny(a) represents a refractive index in the stretching direction, nx(a) represents an in-plane refractive index in a direction perpendicular to y, nz(a) represents a refractive index in a thickness direction of the optical film and d represents a thickness (nm) of the optical film.

3. The optical film of claim 1, wherein a mean particle diameter of the needle-shaped particles is 10-500 nm and a needle-shape ratio represented by the following equation is 2-200:
(needle-shape ratio)=(absolute maximum length)/(diagonal width) Equation (1)
wherein, the absolute maximum length is a maximum length of the needle-shaped particle, and the diagonal width is a minimum distance between two straight lines parallel to a direction of the absolute maximum length, the parallel lines sandwiching an image of the particle when the image of the particle is projected on an image forming material.

4. The optical film of claim 1, wherein a surface of the needle-shaped particle is subjected to a hydrophobic treatment.

5. The optical film of claim 1, wherein the polymer obtained by polymerizing the ethylenically unsaturated monomer has an ester bond in a monomer unit.

6. The optical film of claim 1,
wherein
a direction of a mean azimuth angle of the needle-shaped particles is perpendicular or parallel to a casting direction of the optical film;
H is not more than 300, H being a mean value of absolute values of angles between the direction of the mean azimuth angle and directions of needle-shaped particles; and
Ds/D is not more than 1.5,
wherein D represents an inter-particle distance and Ds represents a standard deviation of the inter-particle distances.

7. A polarizing plate having the optical film of claim 1 on one surface of the polarizing plate.

8. An in-plane switching mode liquid crystal display having two polarizing plates sandwiching an in-plane switching mode liquid crystal cell, wherein one of the polarizing plates is the polarizing plate of claim 7.

9. An in-plane switching mode liquid crystal display comprising an in-plane switching mode liquid crystal cell and two polarizing plates sandwiching the liquid crystal cell, wherein one of polarizing plate protective films of the polarizing plates provided adjacent to the liquid crystal cell is the optical film of claim 1.

10. The in-plane switching mode liquid crystal display of claim 9, wherein a polarizing plate protective film provided adjacent to the liquid crystal cell other than the polarizing plate protective film provided adjacent to the liquid crystal cell of claim 9 meets the following conditions:
−15 nm≦Ro(b)≦15 nm
−15 nm≦Rth(b)≦15 nm
wherein, Ro(b) and Rth(b) are defined as follows:
Ro(b)=(nx(b)−ny(b))×d Equation (iv)
Rth(b)={(nx(b)+ny(b))/2−nz(b)}×d Equation (v)
wherein, nx(b) represents an in-plane refractive index in a slow axis direction of optical film B, ny(b) represents an in-plane refractive index in a direction perpendicular to the slow axis direction, nz(b) represents a refractive index in a thickness direction of the film, and d (nm) represents a thickness of the film.

11. An optical film comprising a cellulose ester film manufactured as a roll film,
wherein
the optical film comprises needle-shaped particles;
a mean particle diameter of the needle-shaped particles is 10-500 nm;
a content of the needle-shaped particles is 1-30% by weight;
a mean azimuth angle of the needle-shaped particles is perpendicular or parallel to a film forming direction of the roll film;
H is not more than 30°, H being a mean value of absolute values of angles between the direction of the mean azimuth angle and directions of needle-shaped particles;
Ds/D is not more than 1.5, wherein D represents an inter-particle distance and Ds represents a standard deviation of the inter-particle distances; and
a needle-shape ratio represented by the following equation is 2-200:
(needle-shape ratio)=(absolute maximum length)/(diagonal width) Equation (1)
wherein, the absolute maximum length is a maximum length of the needle-shaped particle, and the diagonal width is a minimum distance between two straight lines parallel to a direction of the absolute maximum length, the parallel lines sandwiching an image of the particle when the image of the particle is projected on an image forming material.

12. The optical film of claim 11,
wherein
a retardation value Ro represented by the following Equation (i) meets 105 nm≦Ro(a)≦350 nm; and
Nz represented by the following Equation (ii) is 0.2-0.7:
Ro(a)=(nx(a)−ny(a))×d Equation (i)
Nz=(nx(a)−nz(a))/(nx(a)−ny(a)) Equation (ii)
wherein, nx(a) represents an in-plane refractive index in a slow axis direction, ny(a) represents an in-plane refractive index in a direction perpendicular to the slow axis direction, nz (a) represents a refractive index in a film thickness direction, and d is a thickness (nm) of the optical film.

13. A polarizing plate having the optical film of claim 11 on one surface of the polarizing plate.

14. A liquid crystal display having the polarizing plate of claim 13 on one surface of a liquid crystal cell.
